(19) United States
(12) Patent Application Publication
(10) Pub. No.: US 2024/0417229 A1
(43) Pub. Date: Dec. 19, 2024

(54) FORKLIFT PART FLIPPER ATTACHMENT

(71) Applicants: Craig Richard Hokanson, Ogden, UT (US); Stan D. Hartung, Prineville, OR (US)

(72) Inventors: Craig Richard Hokanson, Ogden, UT (US); Stan D. Hartung, Prineville, OR (US)

(21) Appl. No.: 18/744,666

(22) Filed: Jun. 16, 2024

Related U.S. Application Data
(60) Provisional application No. 63/508,878, filed on Jun. 17, 2023.

(51) Int. Cl. B66F 9/18

(52) U.S. Cl. CPC B66F 9/18

(57) ABSTRACT

The present invention relates to forklift attachments or part turning devices, and can attach to a large spectrum of existing forklifts, can efficiently rotate parts and items while suspended, can accommodate asymmetrical and unconventionally shaped parts, can operate mobily, thereby quickly and efficiently transporting parts within an operating assembly system and/or processing area. Can operate within indoor facilities such as warehouses, assembly plants, foundries, laboratories, hospitals, animal hospitals, zoos, aquariums, aircraft hangers, military arsenal, or outdoor areas such as shipping yards, docks, remote areas, hard-to-access areas, containment yards, and parks. Can gently suspend and rotate fragile parts, can provide time and cost savings for manufacturing, painting, and assembly processes. Can access and operate within low-clearance and narrow working environments, and can operate on high-reach forklifts. Particularly, the present invention relates to a the forklift part flipper attachment.

### FIELD OF THE INVENTION

The present invention relates to forklift attachments or part turning devices, and can attach to a large spectrum of existing forklifts, can efficiently rotate parts and items while suspended, can accommodate asymmetrical and unconventionally shaped parts, can operate mobily, thereby quickly and efficiently transporting parts within an operating assembly system and/or processing area. Can operate within indoor facilities such as warehouses, assembly plants, foundries, laboratories, hospitals, animal hospitals, zoos, aquariums, aircraft hangers, military arsenal, or outdoor areas such as shipping yards, docks, remote areas, hard-to-access areas, containment yards, and parks. Can gently suspend and rotate fragile parts, can provide time and cost savings for manufacturing, painting, and assembly processes. Can access and operate within low-clearance and narrow working environments, and can operate on high-reach forklifts. Particularly, the present invention relates to a the forklift part flipper attachment.

### DESCRIPTION OF THE PRIOR ART

A number of forklift attachments have been introduced.

U.S. Pat. No. 3,096,896, patented 1961 May 4, to Norton, Desmond H and Castleberry Jeff D, demonstrates an invention relating to forklift trucks and more particularly to an attachment for such trucks whereby the conventional truck may be readily but temporarily modified so as to operate within the relatively narrow aisles of rack storage warehouses, as well as for longitudinal or bulk storage.

U.S. Pat. No. 3,166,209, patented 1961 Jul. 27, to Haddock Jr, Louis A, demonstrates a universal loader mechanism for use with industrial lift trucks and the like and more particularly to improved positional control means for a universal “loader mechanism.

U.S. Pat. No. 3,231,303 patented 1963 Apr. 1, to Letourneau, Robert G, demonstrates a grapple comprising: support means; a bull gear having a hub journaled to said support means for rotation about the central axis; a pin extending axially through said hub and having an enlarged upper end portion frictionally engaging and supported on said hub; a grapple mechanism rotatably mounted on said pin adjacent the lower end thereof; means for driving said driven plate about said axis to orient said grapple mechanism.

U.S. Pat. No. 3,561,620, patented 1969 Dec. 15, to Willis, Willfred Ernest, demonstrates a side loading attachment for forklift trucks for loading and unloading the forklift truck along an axis perpendicular to the fore-and-aft axis of the truck, the forklift truck being provided with an attachment which moves out to the side to pick up loads or to deposit them. Thus, the aisles can be narrow and a good deal of space saved.

U.S. Pat. No. 3,587,893, patented 1969 Jun. 13, to Laken, Vincent, demonstrates an invention relating to material handling equipment and more particularly to material handling attachments for lift trucks. It is proposed to provide a material handling attachment for a lift truck which is capable of increasing the utility thereof to perform different functions by the provision of a material handling attachment assembly constructed to permit the attachment of different types and kinds of material handling equipment.

U.S. Pat. No. 3,659,733, patented 1970 Dec. 11, to Stuart, Sinclair W and Monroe, J Dennis, demonstrates an invention relating to an attachment for industrial lift trucks, and more particularly a narrow-aisle attachment and method which enables the truck to manipulate loads or pallets in front of and at both sides of the truck without requiring the truck to turn in the aisle.

U.S. Pat. No. 3,672,526, patented 1970 Aug. 6, to Hansen, Howard C, demonstrates an invention relating to an attachment for industrial lift trucks, and more particularly a narrow-aisle attachment and method which enables the truck to manipulate loads or pallets in front of and at both sides of the truck without requiring the truck to turn in the aisle.

U.S. Pat. No. 3,762,588, patented 1970 Oct. 5, to Hansen, H. and Messner, J. demonstrates an invention relating to a fork lift truck attachment which can be mounted on a conventional lift truck with little or no substantial change in the structure or operating mechanism of the truck, and which is relatively simple in construction and design and capable of effectively utilizing standard, shelf-type rack structures.

U.S. Pat. No. 3,836,031, patented 1970 Mar. 25, to Weisker, A. and Smith, R., demonstrates a narrow aisle stacker attachment for a material handling truck has a mast and carriage and laterally extensible carrier for picking up and depositing loads in a storage rack. Horizontally extensible supports near the vertically movable carriage balance side moments.

U.S. Pat. No. 3,966,070 patented 1980 Mar. 18, to Benson, Samuel L., Jensen, Louis T., demonstrates a mechanism on a material handling vehicle having means for interchangeably connecting an attachment to operate as a front end loader or a forklift with an extendable mast for loading and handling of material. The mechanism includes a quadrilateral linkage having means in the linkages adapting the linkage for attaching a front end loader bucket or the mast of a forklift.

U.S. Pat. No. 3,998,345, patented 1974 Apr. 5, to Fiehler, Raymond H., Quick, Thomas E. and Frees, Kenneth A., demonstrates a side loading mechanism for use with fork lift trucks to provide a side loader for mounted disposition upon conventional fork lift trucks whereby the use of the same will only require that aisles within storage spaces be of adequate width for accommodating the transverse extent of such conventional trucks.

U.S. Pat. No. 4,101,040 patented 1977 May 13, to Stolley, Ronald M., demonstrates vehicle which is particularly adaptable for transporting palletized loads from one location to another and which includes a chassis, a steering and traction unit mounted on the rear portion of the chassis, and a pair of laterally spaced, generally horizontal side frame members which extend from the front end of the chassis and have a free end. The side frame members are sufficiently spaced apart to straddle the load to be transported and each is supported by a ground-engaging front wheel located near the free end thereof. A load-lifting frame, including a pair of laterally spaced forks which can be inserted into a pallet, is disposed between the side frame members and is pivotally connected to the front end of the chassis by a linkage arrangement which is arranged so that the load-lifting frame is automatically tilted rearwardly as the load-lifting frame is moved from a lowered position to a raised or transporting position by a lift mechanism connected between the chassis and the load-lifting frame.

U.S. Pat. No. 4,065,013, patented 1976 Sep. 30, to Orthman, Henry K., demonstrates the use of a commonly available forklift vehicle in the moving of three-point mounted equipment. Simply stated, the attachment or device of this invention merely connects the three-point mounted implement to the forklift and then the forklift is free to move the implement from one location to another and if desired, onto a trailer for transport purposes.

U.S. Pat. No. 4,307,792, patented 1980 Mar. 18, to Benson, Samuel L., Jensen, Louis T., demonstrates a lock holds together two masts of a multi-stage forklift truck. A spring-loaded bolt carried by the inner mast is forced into an opening in the outer mast when the carriage is lowered to a position lower than the lowest edge of the inner mast. With the lock engaged the carriage may be raised from its lowest position without forcing the inner mast to rise from its lowest position. Once the carriage has been raised to clear the lower edge of the adjacent mast, the two masts are then unlatched. The latching mechanism allows the amount of travel of a carriage relative to the adjacent mast to be extended without movement of the adjacent mast.

U.S. Pat. No. 4,385,860, patented 1981 Jan. 12, to Corbin, Richard W., demonstrates an improved device for handling transporting and emptying receptacles, providing an improved receptacle handling and emptying device for attachment to a fork lift truck.

U.S. Pat. No. 4,632,630, patented 1984 Apr. 20, to Maki, Clyde M. and Hormann, Herbert, demonstrates an attachment for a forklift and more particularly to a fork extension for a telescoping boom-type forklift for use in loading and unloading a fragile cargo from commercial containers of the type that ride piggy-back on trucks, ships and railroad cars.

U.S. Pat. No. 4,688,981 patented 1985 Sep. 3, to Ravnsborg, Jerry K. and Troy, John C., demonstrates a low load lift adapter designed for use with a forklift truck comprising an upper frame adapted to be secured to the teeth of the forklift and having a vertically disposed frame section extending downwardly from the forward end thereof. A pair of spaced-apart pocket members are secured to the lower end of the vertically disposed frame and are adapted to removably receive a pair of fork teeth therein.

U.S. Pat. No. 4,706,801 patented 1993 Jun. 7, to Martin, Grether., demonstrates the chassis of a forklift truck, including a front assembly and a rear assembly which, in certain embodiments, are movable toward and away from each other between an extended stable normal working condition and a contracted compact condition for storage or transport of the forklift truck. The front assembly includes driven front wheels, standard upright mast and double-acting lift jack for the fork carriage movable along the mast. The rear assembly includes the operator compartment, rear axle assembly for the rear wheels and mechanism mounting the rear axle assembly for vertical movement relative to the operator compartment between a raised normal working position and a downward-projected position. The rear assembly also includes a landing wheel or wheels mounted in front of the rear axle assembly at a location above the rear wheels when the rear axle assembly is raised. The rear assembly also includes a stabilizing system which corrects tipping of the rear assembly when the rear axle assembly is in the downward-projected position. Projection and retraction of the rear axle assembly in cooperation with movement of the front and rear assemblies toward and away from each other and movement of the fork carriage along the mast permits self-loading and unloading of the forklift truck from one horizontal surface to another, with or without a load, such as onto and off of the bed of a transport vehicle.

U.S. Pat. No. 4,810,019 patented 1989 Mar. 7, to Marbert, James B, demonstrates a mechanically operated collet chuck for gripping round objects. Especially in automatic, program-controlled installations for the successive machining of round workpieces, a centered gripping of the round objects, which are changing in diameter, is important. The centering error occurring in case of a collet-carrying machine which remains stationary is compensated for by means of link quadri-laterals which latter cause collet jaws pivotably mounted to the front ends of the collet arms and forming four contact points to pivot with respect to the collet arms in such a way that the contact points or contact lines come into contact with the round object simultaneously, without a change in position of the machine or of the round object. The special structure of the collet chuck simplifies program control of the machining unit since the change in diameter undergone by the round object is taken into account in a rugged and purely mechanical fashion by the collet which occupies only a small amount of space.

U.S. Pat. No. 4,929,145, patented 1988 Sep. 12, to Thompson, George O., demonstrates a forklift adapter, and more specifically to an improved forklift attachment for handling long slender workpieces and bundles of such workpieces stored in vertical stock storage racks.

U.S. Pat. No. 5,281,076, patented 1988 Sep. 12, to Thompson, George O., demonstrates a forklift adapter, and more specifically to an improved forklift attachment for handling long slender workpieces and bundles of such workpieces stored in vertical stock storage racks.

U.S. Pat. No. 5,409,346 patented 1985 Oct. 31, to Vessey, John R., demonstrates a roller having a torque overload release mechanism for use with an accumulating roller conveyor system. A shaft is rotatably mounted to a frame for the conveyor system while a drive sprocket is rotatably mounted to one end of the shaft. A first friction pad is secured to the shaft and abuts against one end of the drive sprocket while a second friction pad is axially slidably mounted to the shaft and abuts against the other axial end of the drive sprocket. A nut variable compresses one or more belleville washers against the second friction pad to thereby drivingly connect the drive sprocket and shaft together and yet permit torque overload release when the torque between the shaft and the sprocket exceeds a predetermined but adjustable amount.

U.S. Pat. No. 5,820,330 patented 1985 Oct. 31, to Focke, Heinz, Koster, Johann and Mutschall, Hugo demonstrates a transport appliance to be actuated manually serves for handling large-volume reels of packaging material. This transport appliance is equipped with a lifting mechanism which in each case grasps a reel with vertical positioning, specifically by means of carrier rods on the cylindrical circumferential surface. The lifting mechanism is operated hydraulically by means of a vertical hydraulic cylinder which is supplied with oil via a hydraulic pump to be operated by hand, in order to raise the carrier rods together with the reel.

U.S. Pat. No. 5,938,399 patented 1997 Jun. 26, to Knutson, Ken, demonstrates a rotatable attachment is provided for rotatably mounting a variety of work attachments to a skid steer loader. The inventive device includes a base assembly removably mountable to the lift arms of a skid steer loader and a rotational assembly rotatably coupled to the base assembly, wherein the rotational assembly is rotatable relative to the base assembly by means of a rotation system and is adapted for removable mounting of a work attachment thereto. As such, the rotational assembly and the work attachment are conjointly rotatable through 360 degrees in a plane which is transverse to a longitudinal axis of the lift arms of the skid steer loader.

U.S. Pat. No. 6,033,177A patented 1998 Jul. 10, to Kooima, Roger D., demonstrates a forklift attachment for attachment to a fifth-wheel hitch assembly of a vehicle for permitting the lifting of loads. The forklift attachment includes a ground engaging support carriage having an towing tongue designed for attachment to a fifth-wheel hitch assembly of a vehicle. A pair of lifting arms are pivotally mounted to the support carriage. A pair of lifting devices are provided for raising and lowering the lifting arms with respect to the support carriage and a pair of tilting devices are provided for tilting the lifting arms with respect to the support carriage. U.S. Pat. No. 6,206,181 patented 1997 Sep. 16, to Syverson, Charles D., demonstrates the drive roller of this invention utilizes a brushless D.C. motor which has a stator or armature mounted on a fixed shaft which directly drives a permanent magnet rotor mounted inside a roller tube. A variable frequency drive supplies three-phase power to a Y-connected three phase winding which is composed of three groups of two coils. Thus twelve electromagnets are formed which drive the permanent magnet rotor which has sixteen poles. The brushless D.C. motor is of a modular design and can be easily built in one inch length increments to supply one lb-in of torque for each one-inch increment. The variable frequency controller operates at a relatively low frequency of 15-75 Hz. Hall effect sensors are used to provide feedback on motor speed and position. The armature laminations making up the brushless D.C. motor core are also relatively thick because of the relatively low power necessary to drive the motor and the resultant relatively low eddy currents present in the motor core. For a motor with a 4.0 lb-in design torque and a rotor and stator length of four inches, the current draw will be approximately 0.8 amps consuming about 15 Watts of power.

U.S. Pat. No. 6,547,054 patented 2001 Jul. 31, to Gamache, Brian L., demonstrates a conveyor roller having a spring loaded telescoping tubular axle with tapered hexagonal shaped ends allowing quick replacement in the side frame openings of a conveyor when the openings are worn to an oversize. The tapered hex ends also provide for a tight fit between hex ends and hex holes in the frame to lessen relative motion (rattling) between the two surfaces that causes wear and noise. The roller can be installed from either side of the conveyor because the axle is collapsible from either end.

U.S. Pat. No. 6,702,091 patented 1998 Sep. 15, to Nimmo, Frank D., Merz, William R., Newton, W. Howard, demonstrates an elongated cylindrical roller tube is rotatably supported between frame members by a pair of bearing units secured to opposite end portions of the tube. Each bearing unit includes a tubular shaft supporting a hexagonal stub axle for axial movement between an outwardly projecting position engaging a frame member and an inwardly retracted position against the bias of a spring member. An anti-friction bearing is mounted on the tubular shaft and is retained within the roller tube by an annular adapter. An annular dust cover projects radially outwardly from the tubular shaft to protect the bearing. Some parts are molded of an electrically conductive plastics material, and each hexagonal stub axle has a slightly resilient outer surface and a tapered and twisted outer tip portion. The stub axles are reinforced by axially extending core pins or by opposite end portions of a cylindrical connecting rod.

U.S. Pat. No. 6,758,649, patented 2003 May 21, to Scordilid, Frank P., demonstrates a fork lift truck attachment having forks which can be shifted laterally relative to a supporting carriage, can be pivoted 90 degrees to either side of a forward position and which can also be adjusted for side tilt and fore and aft tilt.

U.S. Pat. No. 6,766,900 patented 2000 Jun. 7, to Kanaris, Alexander D., demonstrates an internally powered conveyor roller, of the type used for driving a conveyor one direction, and for preventing movement in opposite direction and having a drive roller for driving the conveyor medium, an internal drive motor for driving the roller, a one-way rotation device permitting rotation of the roller in one direction, and for preventing rotation in the opposite direction, and the one way rotation means being moveable between engaged and disengaged positions, and when in the disengaged position, being inoperative to prevent reverse rotation of the roller.

U.S. Pat. No. 6,802,410 patented 2000 Apr. 19, to Kingsley Bruce Dyson, Derek Alfred Sealey, demonstrates a polyurethane conveyor roller end cap internally houses rolling bearing and externally is interference-fitted into an end of a roller tube. The outside surface of the body of an end cap, although arranged in large part to engage the tube, has provided therein a circumferential line of blind recesses designed to minimize the amount of polyurethane used for the end cap while still allowing for the provision of load bearing column of polyurethane.

U.S. Pat. No. 7,021,456 patented 2003 Dec. 5, to Haan, Ted W., Kooistra, Kenneth J., demonstrates a conveyor roller or pulley includes an axle portion mountable to opposite sidewalls of a conveyor and a roller portion rotatable relative to said axle portion. The roller includes a braking device positioned at least partially within said roller portion and selectively operable to restrict rotation of said roller portion relative to said axle portion. The braking device may be biased to restrict rotation, such that the braking device restricts rotation when an actuator of the braking device is deactivated, and allows substantially unrestricted rotation when the actuator is activated. The actuator may be activated when a drive motor of the conveyor is activated to drive one of the rollers of the conveyor, and may be deactivated when the drive motor is deactivated. The conveyor may comprise a roller conveyor or a belted conveyor.

U.S. Pat. No. 7,028,825 patented 2004 Apr. 2, to Winfield, Scott C., demonstrates a roller insert for a conveyor roller tube including a cartridge having inner and outer ends and configured to be inserted into an end of a conveyor roller tube; a stub axle positioned within the cartridge, the stub axle including an elongate body portion, a cylindrical tip portion extending away from the body portion, and an end cap having distal and proximal ends and a hardness less than that of the tip portion, the end cap threadingly secured on the cylindrical tip portion; and at least one bearing mounted within the cartridge and supporting the axle such that the cartridge is rotatable with respect to the axle and the axle is slidable with respect to the bearing; wherein the axle is biased outwardly from the cartridge such that the end cap projects outwardly from the cartridge outer end. A conveyor roller and an axle for a conveyor roller are also provided.

U.S. Pat. No. 7,101,139 patented 2003 May 6, to Benedict, Charles E., demonstrates a material handling system for use in storing and moving goods within multi-level storage warehouses, ocean going vessels and the like wherein storage areas are provided on at least one of the levels and wherein goods are automatically transferred to and from the storage areas and between the various levels by self-propelled load transfer vehicles. The load transfer vehicles move across the surface of the various levels and deliver are also movable within open vertical trunks between the levels to thereby move goods to any desired area.

U.S. Pat. No. 7,143,971, patented 2003 Feb. 7, to Yoder, Sylvan and Herr, John, demonstrates an invention relating to rolling and distribution of flexible elongated materials such as fencing, wire, and cable, and more particularly, to apparatus and methods for rolling and distributing fencing for easy use, re-use, recycling, and/or disposal.

U.S. Pat. No. 7,435,047 patented 2001 Jun. 11, to Meijer, Sjoerd, demonstrates the invention relates to a loading platform (2,3) for displacing goods, comprising a support frame for goods (8) and at least one double roller device (7,9) arranged in longitudinal direction, wherein the double roller device comprises a number of first roller elements (9) situated at regular mutual distances and having a rolling surface (15), and a number of second roller elements (7) situated above the first roller elements and having a rolling surface (15), and wherein the rolling surface of the first roller elements lies against the rolling surface of the second roller elements, characterised in that the roller elements engage movably on the frame in vertical direction.

U.S. Pat. No. 7,766,596, patented 2004 Mar. 30, to Smith, Daniel Allen, Kobel, Korry D., Puszkiwwicz, Ignacy, Haught, Christopher A., Wyant and Todd Bradley, demonstrates a telescopic telehandler (e.g., forklift) attachment that is to be used to pick, manipulate, transport and aid in the installation of both vertical and horizontal building panels (cladding) and other construction materials such as pipes and the like. These tasks will be achieved through wireless control over five degrees of freedom and the interaction of an additional operator in an aerial work platform (AWP).

U.S. Pat. No. 7,930,775 patented 2009 Apr. 6, to Kluckhuhn, Gary R., demonstrates a rotating gantry system consisting of a welded tubular track tube which establishes a circular overhead track under which the rotating gantry rotates. There is a longitudinal elongated beam or support bar which extends beyond the periphery of the rotating gantry at both ends. The longitudinal elongated beam is rotating beneath the gantry by a four wheel cluster of rollers which surround the circular overhead track and run thereon. The elongated longitudinal beam has a moving trolley running there along and the moving trolley has attached thereto a vertical post which at a bottom thereof has a patient pick-up or transfer device. The rotating gantry can be suspended from a ceiling, be self-supporting or be attached to walls of a room be way of extendable extensions attached to the rotating gantry.

U.S. Pat. No. 8,306,703, patented 2008 Sep. 13, to Selah, Mohamad, demonstrates a conventional forklift truck to be converted quickly to a narrow aisles truck. An attachment where a guide frame is secured to the front of the forklift truck, a sliding bracket is slidably mounted to the guide frame, a support arm is mounted to the sliding bracket, a rotatable carriage is pivotally mounted to the support arm, and a pair of load forks is mounted to the rotatable carriage, the load forks can be shifted to the side of the truck to pickup or release a load in a narrow aisle.

U.S. Pat. No. 8,381,901 patented 2008 May 16, to Yamamoto, Shinya, demonstrates a motorized conveyor roller prevents slip between a power transmission mechanism in a roller tube and the roller tube due to aging. The power transmission mechanism includes a first closed-bottom cylindrical member fit over a second closed-bottom cylindrical member and a bolt for axially pressing the members against one another. The first member receives torque from a motor and a double-sided tape is laid on an outer surface of the first member. Facing surfaces of the first and second members are tapered, and the circumferential wall with the double-sided tape is expandable diametrically. The bolt diametrically expands the circumferential wall pressed by the tapered surface. Thus, an adhesive force of the double-sided tape sandwiched between the circumferential wall and the roller tube is exerted to adhere the outer surface of the first member to an inner surface of a roller tube.

U.S. Pat. No. 8,800,695 patented 2008 Oct. 6, to Couture, Adam P., Page, Richard, O'Brien, John P., Filippov, Mikhail, Shein, Andrew, demonstrates a robotic vehicle including a chassis having front and rear ends and supported on right and left driven tracks. Right and left elongated flippers are disposed on corresponding sides of the chassis and operable to pivot. A linkage connects a payload deck assembly, configured to support a removable functional payload, to the chassis. The linkage has a first end rotatably connected to the chassis at a first pivot, and a second end rotatably connected to the deck at a second pivot. Both of the first and second pivots include independently controllable pivot drivers operable to rotatably position their corresponding pivots to control both fore-aft position and pitch orientation of the payload deck with respect to the chassis.

U.S. Pat. No. 9,085,944 patented 2015 Jul. 21, to Jason La Valley, Roger La Valley, Marvin Larson, Lawrence D. Kilpo, Michael Burgess, demonstrates a gripping assembly with gripping members, as part of a grapple attachment, used to grasp and manipulate elongated objects, for example pipe, is described. Due to the gripping action of the gripping members and tilt control capabilities of the grapple attachment, total positive control of the pipe is maintained, even if the gripping assembly picks up pipe off center. The grapple attachment is able to be used on all pipe surface types, including pipe surfaces that are dirty, snow or ice covered. The gripping members are configured to prevent damage to the pipe and to adjacent pipes, and will not crush the pipe.

U.S. Pat. No. 9,238,569 patented 2010 Jan. 19, to Sorensen, Bjarne Norgaard and Larsen, Hans Rico, demonstrates controlling the orientation of a load suspended from a bearing wire employs one master winch, one slave winch and a winch control. Each of the winches has a motor and a bi-directional rotational spool with a tagline. The winches are on the ground, the crane or the load. Each tagline is attached to the load for applying a controlled torque to the load about the bearing wire. The control system comprises tagline tension sensors and spool rotation sensors.

The control system is connected to each winch motor for simultaneously rotating the winch spools, until preset tagline tensions are sensed during horizontal and/or vertical movement of the load. If necessary, the spools are rotated with rotation speeds for maintaining a desired orientation of the load, based on the determined tagline tensions. After relieving tagline tensions, the taglines are disconnected from the load.

U.S. Pat. No. 9,821,990 patented 2013 Feb. 15, to Zanichelli, Giannino, demonstrates an electric lifter, comprising a fixed mast structure, a movable mast structure that is movable relative to the fixed mast structure at feast one transmission means (chain or cog drive belt or rack or similar), and a load carrier, in particular a fork load carrier, being connected to the at least one transmission means and configured to carry a load, wherein the at least one transmission means is movably connected to the movable mast structure while being configured to move along a closed loop path, the closed loop path being stationary relative to the movable mast structure.

U.S. Pat. No. 10,221,050 patented 2012 Aug. 6, to Weterings, Hendrikus Jacobus and Roodenburg, Joop demonstrates a crane vessel and a method of lowering an object from such a crane vessel into the sea. The crane comprises a stationary pedestal, a crane housing that is adapted to slew relative to the pedestal about a vertical rotation axis and a boom, comprising an inner end which is connected pivotably about a horizontal pivot axis to the crane housing. A luffing device extends between the boom and the crane housing, adapted to position the boom and actuate the up-and-down movement of the boom. Furthermore an object suspension device is provided to which an object is connectable, and a hoist assembly which comprises a winch and an associated hoisting cable, the hoisting cable extending from the winch, via a departing sheave on the boom, to the object suspension device, such that upon actuation of the winch the object suspension device can be raised and lowered, wherein the one or more portions of the hoist cable between the boom and the object suspension device form one or more suspension cable parts. According to an aspect of the invention, a hoist cable guide is provided which, at an operational position thereof, is adapted to guide at least one of the suspension cable parts between the boom and the object suspension device. According to another aspect of the invention, the hoisting cable is provided as a multiple fall cable and a hoist cable retention device is provided on the boom. The hoisting cable comprises one or more first suspension cable parts extending between the object suspension device and a radially outward location of the boom, and one or more second suspension cable parts extending between the objection suspension device and a radially inward location, such that the first and second suspension cable parts extend at V-shape with respect to each other, at an angle of preferably between 2° and 60°.

U.S. Pat. No. 10,807,848, patented 2015 Dec. 3, to Brunckhorst, Christian A. and Brimlow, Nicholas J., demonstrates an apparatus and method of moving a load includes attaching a mover platform to a powered mover. The method also includes selecting a load support tool from among a plurality of load support tools. Each load support tool includes an adaptor configured to be interchangeably inserted in a receiver of the mover platform. Each of the plurality of load support tools includes a different end effector for engaging different loads. The selected load support tool includes an end effector for engaging a target load. The method also includes engaging the selected load support tool in the receiver of the mover platform. The method also includes positioning the powered mover and mover platform such that the end effector of the selected load support tool is aligned for engagement with the target load. The method also includes raising the mover platform, using the powered mover, to engage the end effector with the target load. The method also includes moving the powered mover and mover platform to move the target load.

U.S. Pat. No. 11,014,793, patented 2018 Oct. 2, to Selah, Mohamad A., demonstrates a conventional forklift truck having a pair of forwardly extending forks to be converted quickly to a narrow aisle truck. An attachment where a support frame is secured to the forklift forks by a pair of hollow sleeves welded to the support frame, a sliding bracket is slidably mounted to the support frame, a rotatable shaft is rotatably mounted to the sliding bracket, a tiltable frame is pivotally mounted to the rotatable shaft, an elevating carriage is slidably mounted to the tiltable frame, and a pair of load forks are secured to the elevating carriage. The attachment is controlled by a wireless remote control transmitter and receiver so the load forks can be shifted and rotated to either side of the forklift truck and can be elevated and tilted to level a palletized load during side loading operation.

U.S. Pat. No. 11,261,064 patented 2009 Aug. 6, to Pech, David J. and Rucinksi, Joseph R., demonstrates a lift crane including a car body; a rotating bed comprising a counterweight support frame; a boom; a counterweight unit supported on the counterweight support frame in a moveable relationship with respect to the counterweight support frame; and a counterweight unit movement device connected between the rotating bed and the counterweight unit to move the counterweight unit toward and away from the boom. The crane is configured such that during crane operation, the moment generated by the counterweight unit acts on the rotating bed predominantly through the counterweight support frame. Alternatively, the crane can include a mast. In some embodiments the same basic crane is configured to be set-up with two different counterweight options, i) a counterweight unit directly supported on the counterweight support frame and ii) a counterweight support beam moveably connected to the remainder of the rotating bed and a counterweight unit supported on the counterweight support beam.

P20030021667A1, published 2003 Jan. 30, to Harrell Olen, demonstrates a forklift attachment for carrying and dumping a barrel includes a first and a second hollow tube, each for insertion of forklift tines. In addition, first and second curved barrel-holding devices are attached by a hinge to the hollow tubes. The first and second barrel holding devices are each able to swing up and down and pivotally swivel about a point in the hinge. A latch has a first position to keep the barrel holding devices fixed and a second position allowing the barrel holding devices to pivotally swivel. In this manner, a barrel may be held between the forklift tines, easily moved, and its contents dumped out.

P20040102870A1, published 2002 Nov. 26, to Andersen, Scott, Kirkham, Richard, demonstrates a fork lift, and especially a fork lift for a truck, may have structure on a forklift carriage for selectively receiving any of a variety of attachment tools. Alternatively, an assembly may be secured to the carriage and the assembly may provide the structure for selectively receiving the attachment tools. The structure may include a bolt and lever mechanism for selectively securing and releasing the attachment tools. A method may include selectively securing any of a variety of attachment tools including, but not limited to, a trencher, an auger, a backhoe, and a hydraulic breaker. These attachment tools may be connected to a hydraulic system for control of the attachment tools. The method may include the preliminary steps of locking the forklift against movement along a mast and insertion of fork tips in pocket(s) supported in the truck.

P20040115035A1, published 2004-16-17, to Tygard, Edward, demonstrates a clamping apparatus includes a frame and a pair of opposing clamping arms mounted on the frame for movement towards and away from each other to grasp or release a load. In one embodiment, each clamping arm is guided for movement with respect to the frame by an adjustable bushing which can be rotated to adjust the position of the bushing with respect to the clamping arm. In another embodiment, each clamping arm defines a four-bar linkage which controls the angle with respect to the vertical of a contact portion of the clamping arm. The clamping apparatus may be mounted on a lift truck or other support member by a connector which permits the angle of the clamping apparatus with respect to the horizontal to be adjusted and which enables the clamping apparatus to pivot about an axis between a position in which it is disposed outboard of the axis and a position in which is it disposed forward of the axis.

P20060263182A1, published 2004 Mar. 15, to Mizner, Richar, demonstrates an RFID enabled paper roll includes a tubular core, a paper stock wound around the core, and a radio frequency integrated circuit electrically coupled to an antenna and positioned on the core. A system for reading a radio frequency integrated circuit positioned on an item of inventory in a warehouse comprises a material handling device and an RFID reader coupled to the material handling device. The material handling device has at least member for use in transporting an item of inventory. The reader is configured to read the radio frequency integrated circuit associated with the item of inventory when the item is in proximity to the material handling device.

P20130277151A1, published 2013 Oct. 24, to Giannetti, Mirco, demonstrates an invention within the technical field of the machines used for the support and/or lift of loads, such as the fork lift trucks. In particular, the invention refers to an innovative anti-scratch and anti-slip device, magnetically applicable and therefore in a removable manner, to load lifting surfaces, preferably the forks of a lift, thus impeding the formation of scratches on the moved material and, at the same time, limiting drastically the risk of slipping thereof outside the load plane.

P20140166405A1, published 2014 Jun. 19, to Bow, Ronald and Bow, D. Keith, demonstrates a material handling system for supporting a cylindrical or curved-surface object while transported on forks, and more particularly a device(s) for reducing the propensity of a cylindrical object to move while in transport, said device comprising a deformable curvilinear material to provide both protection of the object as well as chocking of the object.

P20160340154A1 published 2016 Aug. 5, to Samples, Donald Glenn II, demonstrates a material handling system for supporting a cylindrical or curved-surface object while transported on forks, and more particularly a device(s) for reducing the propensity of a cylindrical object to move while in transport, said device comprising a deformable curvilinear material to provide both protection of the object as well as chocking of the object.

### BRIEF DESCRIPTION OF THE DRAWINGS

FIG. 1, FIG. 2, FIG. 3, and FIG. 4 illustrate perspective views of the forklift part flipper attachment, in conjunction with a forklift 92, roller-straps or sling 93, demonstrating strap rotation 96, portable controlled rotation 95, of a suspended part 94, and a jet engine 97 during assembly, and the efficient handling of a large unconscious dolphin 98 preparing for surgery at an aquatic facility, respectively.

FIG. 5 and FIG. 6 illustrate perspective views of the forklift part flipper attachment being coupled (arrows 100) with a set of forklift forks 99.

FIG. 7, FIG. 8, FIG. 9, and FIG. 10 illustrate perspective, front, top, and left-side views of the forklift part flipper attachment, respectively.

FIG. 11 illustrates a sectional-front view (section A-A) of the roller drum 101a, roller-drum axle 101b, roller-drum bearing assemblies 101c, roller-drum-bearing seats 101d, and roller-drum strap stops 107, respectively.

FIG. 12 illustrates an exploded perspective view of the components of the forklift part flipper attachment.

FIG. 13 illustrates a perspective view of roller drum 101a demonstrating a portable and rotatable function being applied to a suspended part 94, suspended by a set of straps 93, attached to a mobile forklift 92, respectively.

FIG. 14A, FIG. 14B, FIG. 14C, and FIG. 14D illustrate front views of roller drum 101a demonstrating a portable and controllably rotatable function being applied to a jet engine 97, suspended by a set of roller-straps or sling 93, attached to a mobile forklift 92, creating flexibility and efficiencies during different progressions of the assembly process, represented at an aircraft manufacturer or aircraft mechanic shop, respectively.

FIG. 15A illustrates a front view of roller drum 101a demonstrating a portable and controllably rotatable function, being applied to a large unconscious dolphin 98 during a surgical preparation process, suspended by a set of roller-straps or sling 93, attached to a mobile forklift 92, represented in at an aquatic facility, respectively.

FIG. 15B illustrates a front view of roller drum 101a demonstrating a portable and controllably rotatable function, being applied to a large unconscious obese human medical patient 110 during a surgical preparation process, suspended by a set of roller-straps or sling 93, attached to a mobile forklift 92, represented in at a medical facility, respectively.

FIG. 16A and FIG. 16B illustrate top and side views of roller drum 101a demonstrating a portable, efficient, and controllably rotatable function, being applied to a large suspended part 94 being suspended by a set of roller-straps or sling 93 attached to a mobile forklift 92, represented in a manufacturing or assembly facility.

FIG. 16C, FIG. 16D, FIG. 16E, and FIG. 16F illustrate perspective, front, top, and side views of roller drum 101a demonstrating a portable, efficient, and controllably rotatable function, being applied to a large suspended part 94 being suspended by a set of roller-straps or sling 93 attached to a specialty mobile rough-terrain, extended-reach forklift 92, represented at a construction or remote-operations site.

FIG. 16G and FIG. 16H illustrate front and perspective views of roller drum 101a demonstrating a portable, efficient, and controllably rotatable function, being applied to a large suspended part 94 being suspended by a set of roller-straps or sling 93 attached to a specialty high-reach mobile forklift 92, represented in a manufacturing or assembly facility.

FIG. 17A and FIG. 17B illustrate perspective views of forklift-attachable load-distributing frames 102, being coupled (arrows 100) with a set of forklift forks 99 on a forklift 92.

FIG. 18A, FIG. 18B, FIG. 18C, FIG. 18D, and FIG. 18E illustrate side, top, and perspective views, respectively, of the forklift part flipper attachment demonstrating a centrally-mounted, horizontally-rotational roller-drum support beam 103.

FIG. 19A and FIG. 19B illustrate a perspective and a left-side view of an equivalent variation of the forklift part flipper attachment, demonstrating roller-drum support beam 103 mounted parallel to the forklift-attachable load-distributing frames 102.

FIG. 19C, FIG. 19D, and FIG. 19E illustrate a perspective, front, and top view of an equivalent variation of the forklift part flipper attachment, demonstrating roller-drum support beam 103 mounted parallel to the forklift-attachable load-distributing frames 102 suspending an asymmetrically shaped manufactured part.

FIG. 20A, FIG. 20B, and FIG. 20C illustrate a perspective, front, and left-side view of an equivalent variation of the forklift part flipper attachment, demonstrating double roller drums 101a, powered by a single-drive-shaft electric motor, with a centrally positioned chain drive, with forklift-attachable load-distributing frames 102 supporting the roller-drum support beam 103 from below.

FIG. 20D illustrates a perspective view of an equivalent variation of the forklift part flipper attachment, demonstrating double roller drums 101a, powered by a single-drive-shaft electric motor, with a centrally positioned chain or belt drive, with forklift-attachable load-distributing frames 102 attached to the roller-drum support beam 103 from the top.

FIG. 21 illustrates a perspective view of an equivalent variation of the forklift part flipper attachment, demonstrating double roller drums 101a, powered by a single-drive-shaft electric motor, with a centrally positioned, shared chain drive, with forklift-attachable load-distributing frames 102 attached to the vertically central portion of the roller-drum support beam 103.

FIG. 22 illustrates a perspective view of an equivalent variation of the forklift part flipper attachment, demonstrating quadruple roller drums 101a, two of them being powered by a single-drive-shaft electric motor, with a centrally positioned, shared chain or belt drive, with forklift-attachable load-distributing frames 102 supporting the roller-drum support beam 103 from below.

FIG. 23 illustrates a perspective view of an equivalent variation of the forklift part flipper attachment, demonstrating quadruple roller drums 101a, two of them being powered by a single-drive-shaft electric motor, with a centrally positioned, shared chain or belt drive, with forklift-attachable load-distributing frames 102 attached to the vertically central portion of the roller-drum support beam 103.

FIG. 24 illustrates a perspective view of an equivalent variation of the forklift part flipper attachment, demonstrating quadruple roller drums 101a powered by an electric motor, with centrally positioned chain or belt drives, with forklift-attachable load-distributing frames 102 attached to the vertically central portion of the roller-drum support beam 103.

FIG. 25 illustrates a perspective view of an equivalent variation of the forklift part flipper attachment, demonstrating double roller drums 101a driven by independent electric gearboxes, with forklift-attachable load-distributing frames 102 attached to the vertically central portion of the roller-drum support beam 103.

FIG. 26 illustrates a perspective view of an equivalent variation of the forklift part flipper attachment, demonstrating quadruple roller drums 101a, each driven by independent electric gearboxes, with forklift-attachable load-distributing frames 102 attached to the vertically central portion of the roller-drum support beam 103.

FIG. 27A and FIG. 27B illustrate a perspective and front view of an equivalent variation of the forklift part flipper attachment, demonstrating a single roller drum 101a powered by an electric single-shaft motor, connected by chain or belt drive, with forklift-attachable load-distributing frames 102 supporting the roller-drum support beam 103 from below.

FIG. 28 illustrates a perspective view of an equivalent variation of the forklift part flipper attachment, demonstrating a single roller drum 101a powered by an electric single-shaft motor, connected by chain or belt drive, with forklift-attachable load-distributing frames 102 attached to the roller-drum support beam 103 from the top.

FIG. 29 illustrates a perspective view of an equivalent variation of the forklift part flipper attachment, demonstrating a single roller drum 101a powered by an electric single-shaft motor, connected by chain or belt drive, with forklift-attachable load-distributing frames 102 attached to the vertically central portion of the roller-drum support beam 103.

FIG. 30 illustrates a perspective view of an equivalent variation of the forklift part flipper attachment, demonstrating double roller drums 101a, with one of them powered by an electric single-shaft motor, connected by chain or belt drive, with forklift-attachable load-distributing frames 102 attached to the vertically central portion of the roller-drum support beam 103.

FIG. 31 illustrates a perspective view of an equivalent variation of the forklift part flipper attachment, demonstrating a single roller drum 101a, a single electric motor with shaft extending through the center, connected directly to the roller-drum axle 101b, with, with forklift-attachable load-distributing frames 102 attached to the vertically central portion of the roller-drum support beam 103.

FIG. 32 illustrates a perspective view of an equivalent variation of the forklift part flipper attachment, demonstrating a single roller drum 101a powered by an electric single-shaft motor, connected by chain or belt drive, with forklift-attachable load-distributing frames 102 attached to the vertically central portion of the roller-drum support beam 103.

FIG. 33 illustrates a perspective view of an equivalent variation of the forklift part flipper attachment, demonstrating a single roller drum 101a powered by an electric single-shaft motor, connected by chain or belt drive, with forklift-attachable load-distributing frames 102 attached to the vertically central portion of the roller-drum support beam 103.

FIG. 34 illustrates a perspective view of an equivalent variation of the forklift part flipper attachment, demonstrating a single roller drum 101a to be powered by a manually operated hand-crank or foot-pedals 112, to be connected by chain or belt drive, with forklift-attachable load-distributing frames 102 attached to the vertically central portion of the roller-drum support beam 103.

FIG. 35a illustrates a perspective view of an equivalent variation of the forklift part flipper attachment, demonstrating double roller drums 101a, powered by a single-drive-shaft electric motor, with a centrally positioned, shared chain drive, with forklift-attachable load-distributing frames 102 attached to the vertically central portion of the roller-drum support beam 103. The roller-drum support beam 103 is configured from a beam with a C-shaped cross-section, with rectangular plates being formed on the opposite ends thereof.

FIG. 35b illustrates a perspective and front view of an equivalent variation of the forklift part flipper attachment, demonstrating a single roller drum 101a powered by an electric single-shaft motor, connected by chain or belt drive, with forklift-attachable load-distributing frames 102 supporting the roller-drum support beam 103 from below. The roller-drum support beam 103 is configured from a beam with a I-beam cross-section, with rectangular plates being formed on the opposite ends thereof.

FIG. 35c illustrates a perspective view of an equivalent variation of the forklift part flipper attachment, demonstrating double roller drums 101a, powered by a single-drive-shaft electric motor, with a centrally positioned, shared chain drive, with forklift-attachable load-distributing frames 102 attached to the vertically central portion of the roller-drum support beam 103. The roller-drum support beam 103 is configured from beam with a C-shaped cross-sections, with C-shaped-cross-section beams being formed on the opposite ends thereof. One of two forklift-attachable load-distributing frame cross-members 108 are configured from beam with a C-shaped cross-section and has a stabilizer leg.

FIG. 35d illustrates a perspective and front view of an equivalent variation of the forklift part flipper attachment, demonstrating a single roller drum 101a powered by an electric single-shaft motor, connected by chain or belt drive, with forklift-attachable load-distributing frames 102 supporting the roller-drum support beam 103 from below. The roller-drum support beam 103 is configured from beam with a C-shaped cross-sections, with C-shaped-cross-section beams being formed on the opposite ends thereof. One of two forklift-attachable load-distributing frame cross-members 108 are configured from beam with a C-shaped cross-section and has a stabilizer leg.

FIG. 36a illustrates a perspective view of an equivalent variation of the forklift part flipper attachment, demonstrating double roller drums 101a, powered by a single-drive-shaft electric motor, with a centrally positioned, shared chain drive, with forklift-attachable load-distributing frames 102 attached to the vertically central portion of the roller-drum support beam 103. The roller-drum support beam 103 is configured from beam with a C-shaped cross-sections, with C-shaped-cross-section beams being formed on the opposite ends thereof. One of two forklift-attachable load-distributing frame cross-members 108 has a stabilizer leg.

FIG. 36b illustrates a perspective and front view of an equivalent variation of the forklift part flipper attachment, demonstrating a single roller drum 101a powered by an electric single-shaft motor, connected by chain or belt drive, with forklift-attachable load-distributing frames 102 supporting the roller-drum support beam 103 from below. The roller-drum support beam 103 is configured from beam with a C-shaped cross-sections, with C-shaped-cross-section beams being formed on the opposite ends thereof. One of two forklift-attachable load-distributing frame cross-members 108 has a stabilizer leg.

FIG. 37, FIG. 38a, FIG. 38b, FIG. 39a, FIG. 39b, FIG. 40a, FIG. 40b, and FIG. 41 illustrate perspective front views of equivalent variations of the forklift part flipper attachment, demonstrating variable configurations of the use one or more roller-drum turning devices 104, respectively, with the hydraulic or electric power source being demonstrated as an integrated component of the forklift part flipper attachment and/or being provided by an external source (see FIG. 41).

FIG. 42a, FIG. 42b, and FIG. 42c illustrate a perspective, top, and side view of equivalent variations of the roller-drum turning device 104, operating as a differential for distributing power to multiple drums at differing speeds as the load rotating part changes dimensions, configured between multiple roller drums 101a.

FIG. 43a, FIG. 43b, and FIG. 43c illustrate a perspective, top, and side view of an equivalent variation of the forklift-attachable load-distributing frames 102, demonstrating the means to attach to a forklift carriage.

FIG. 44a and FIG. 44b illustrate a perspective and side view of an equivalent variations of the forklift-attachable load-distributing frames 102, demonstrating the means to attach to a forklift carriage.

### DISADVANTAGES OF THE PRIOR ART

The prior art have failed to solve many problems associated with such forklift attachments or part turning devices as follows:

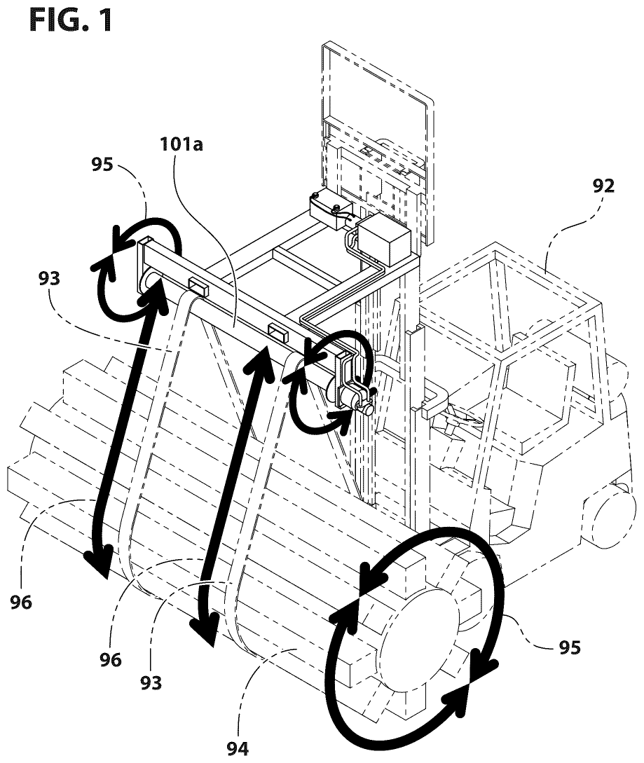

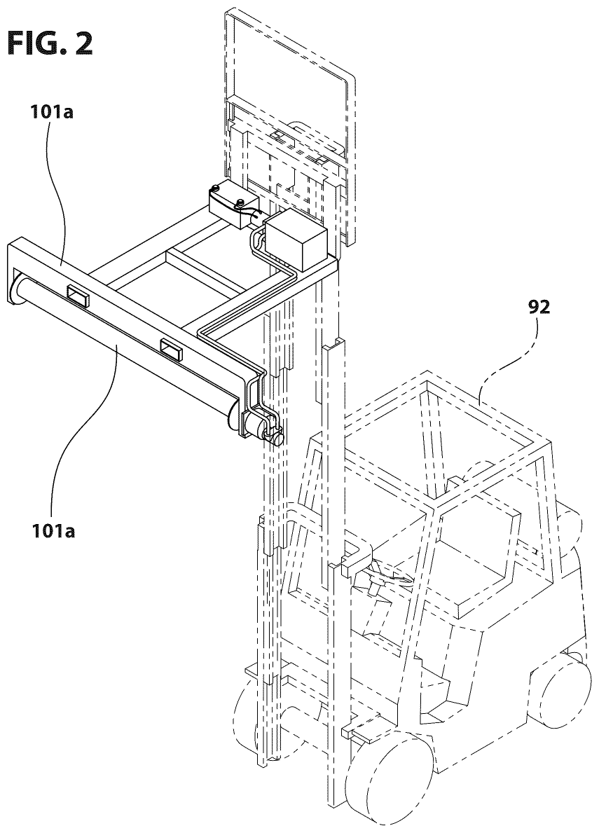

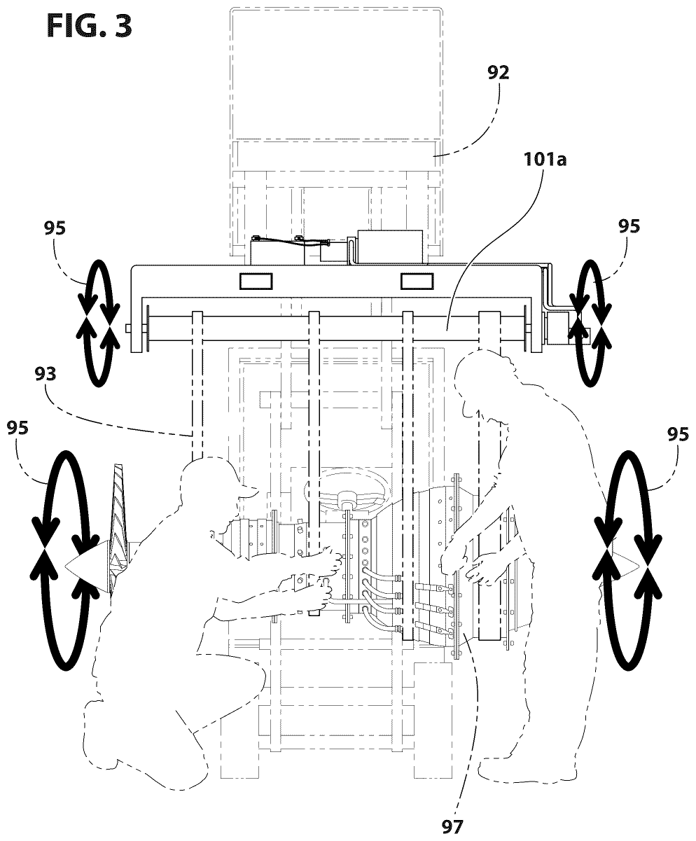

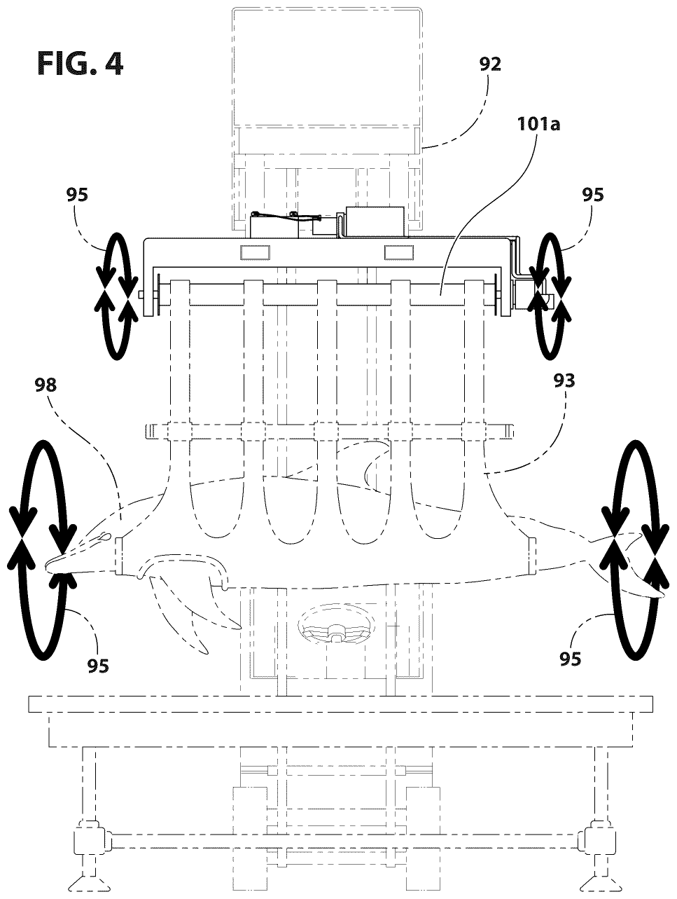

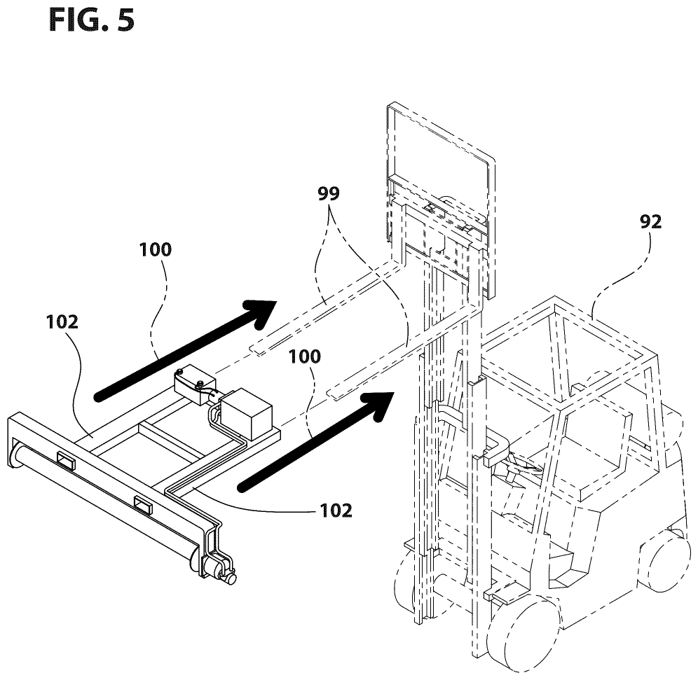

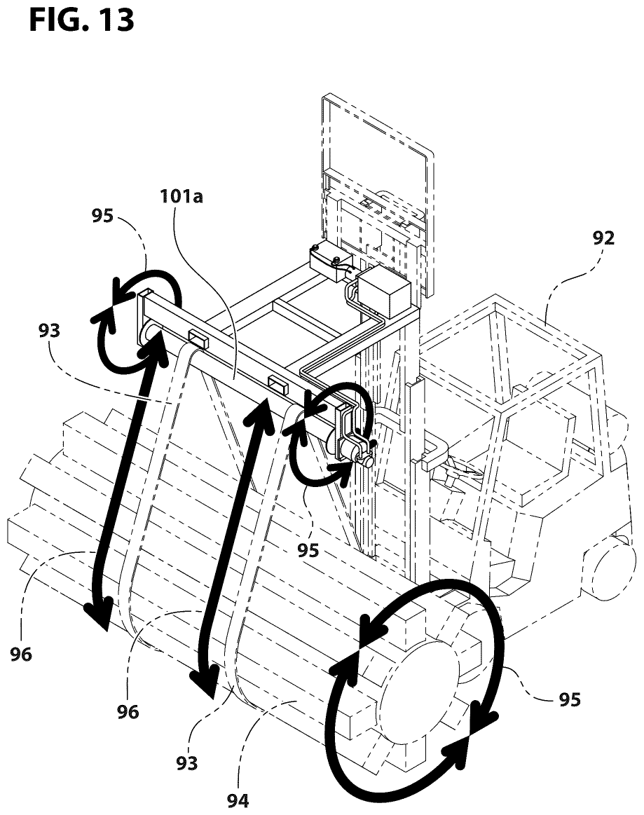

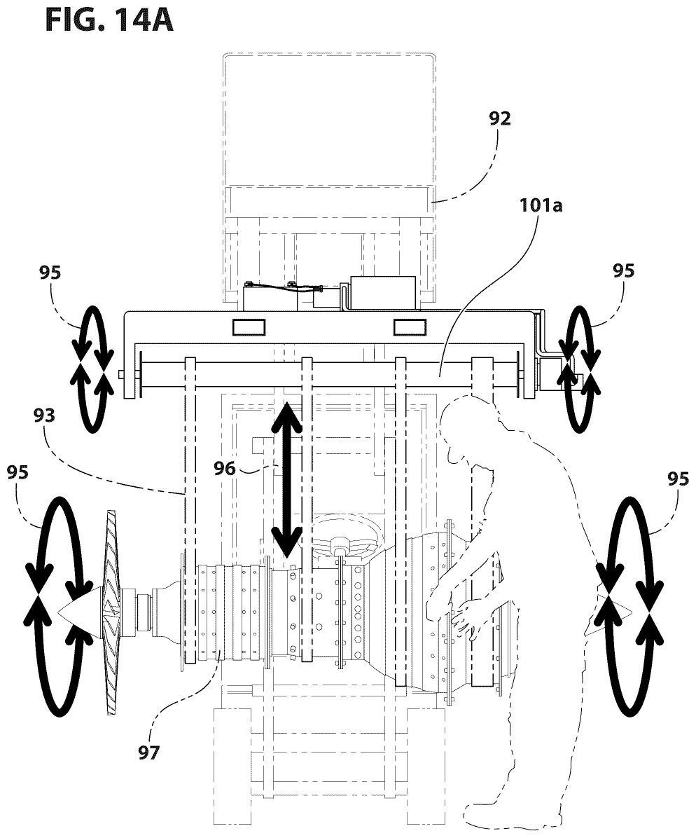

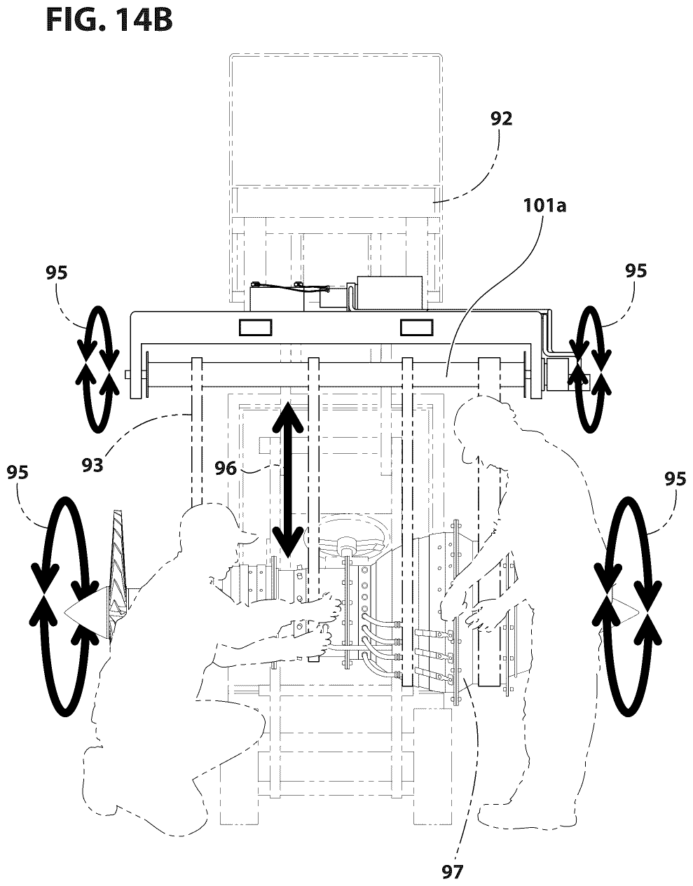

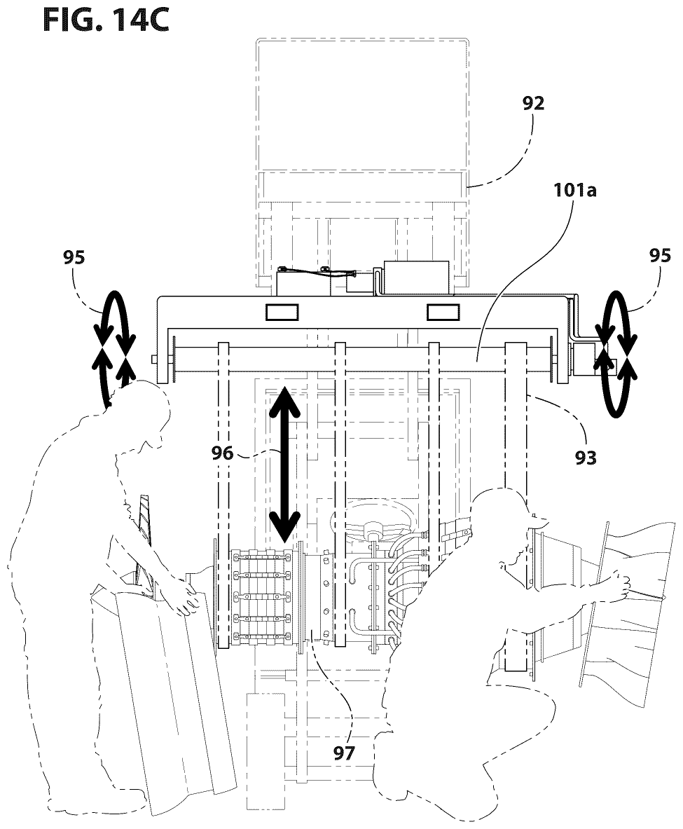

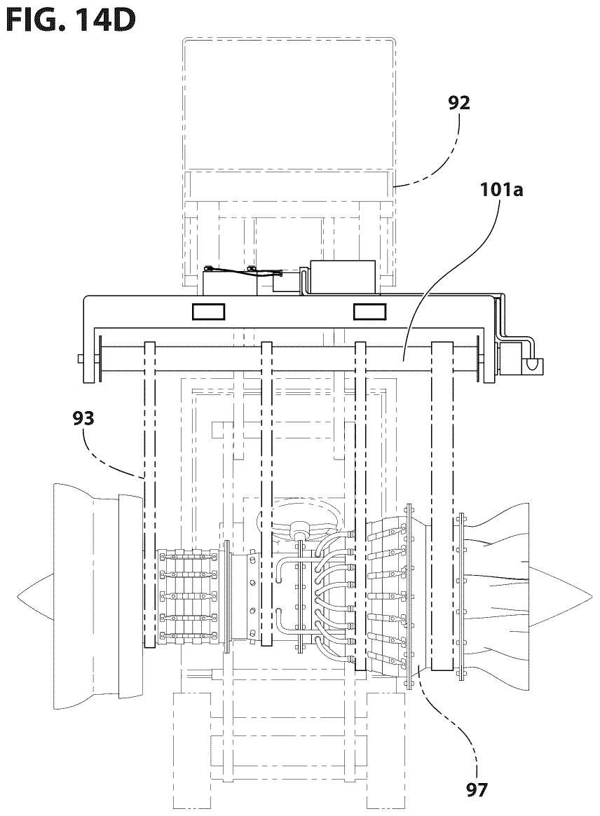

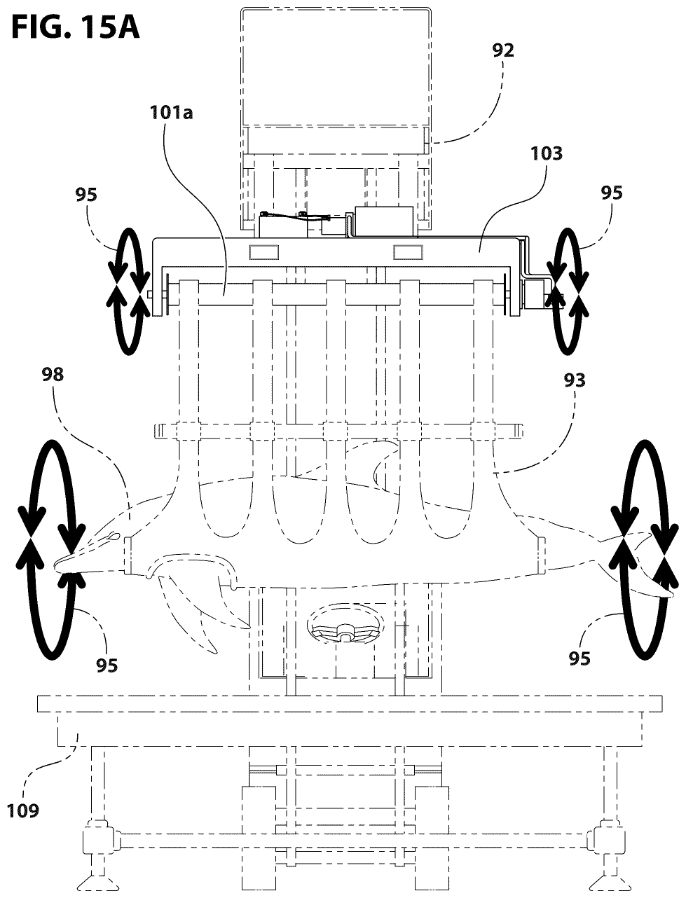

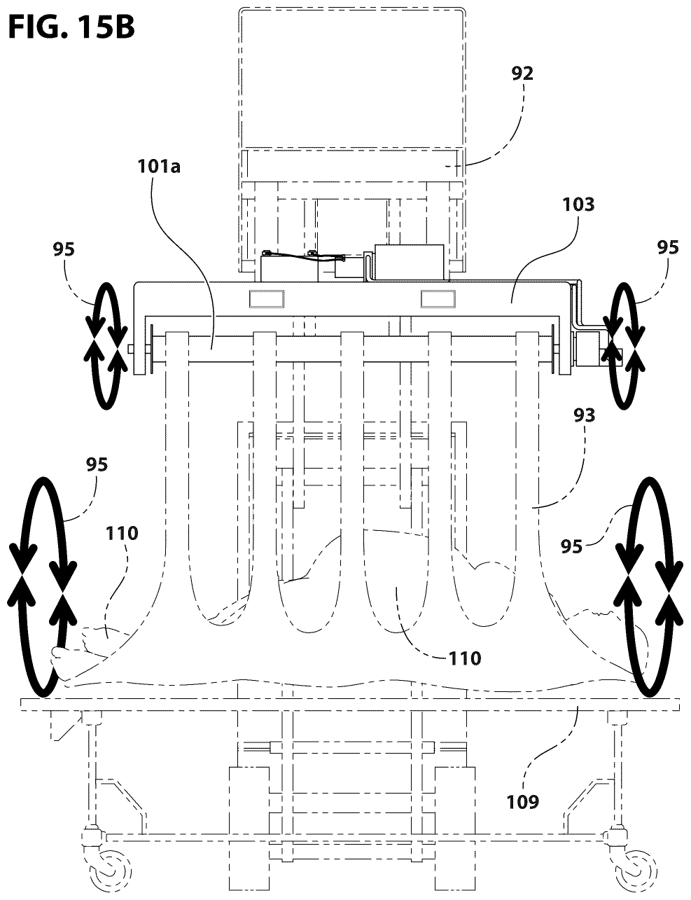

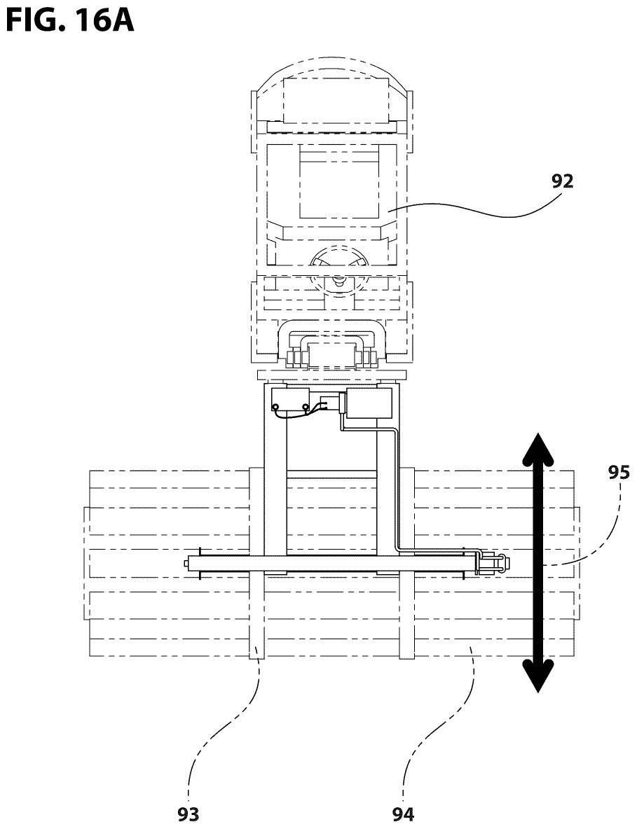

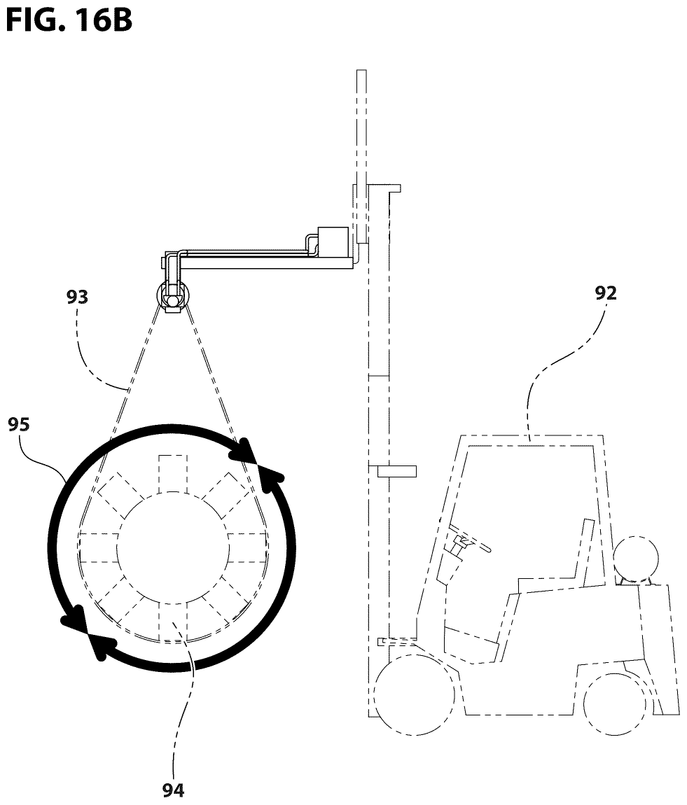

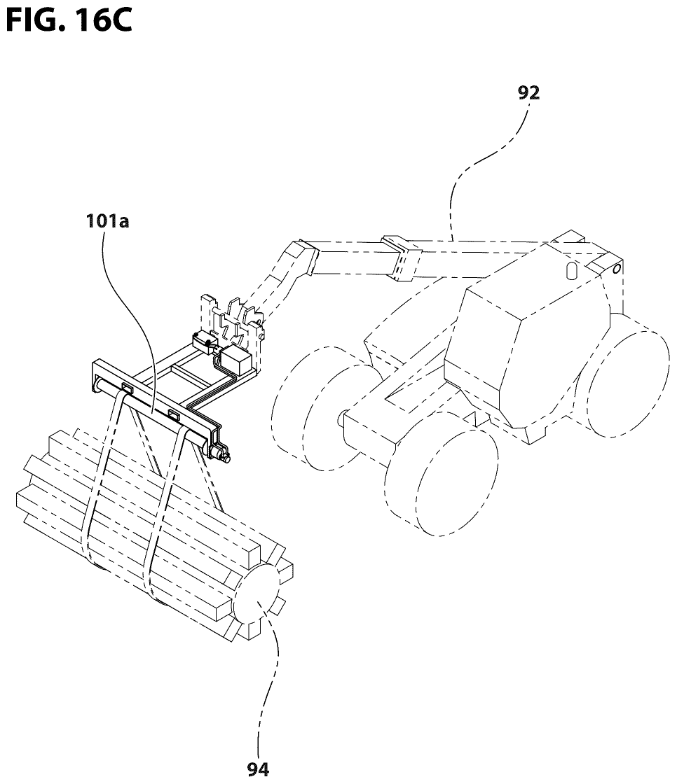

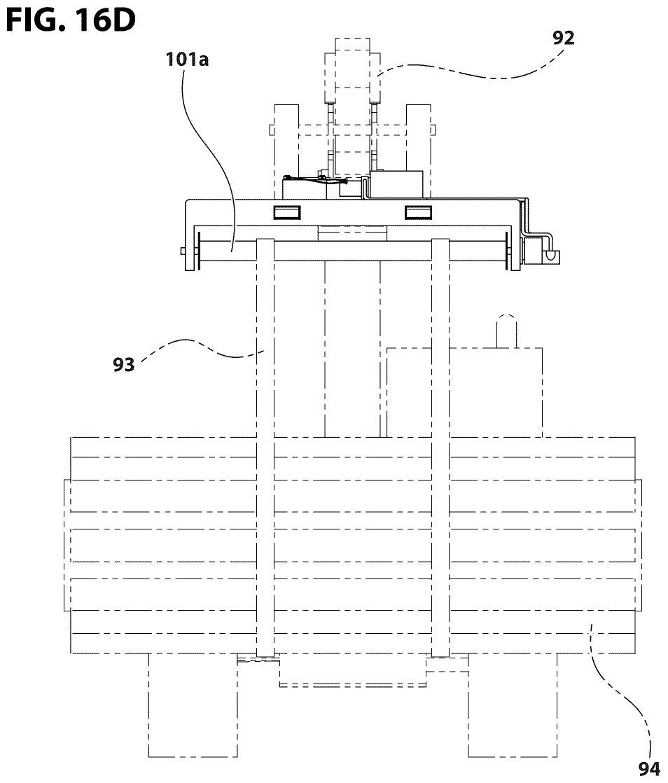

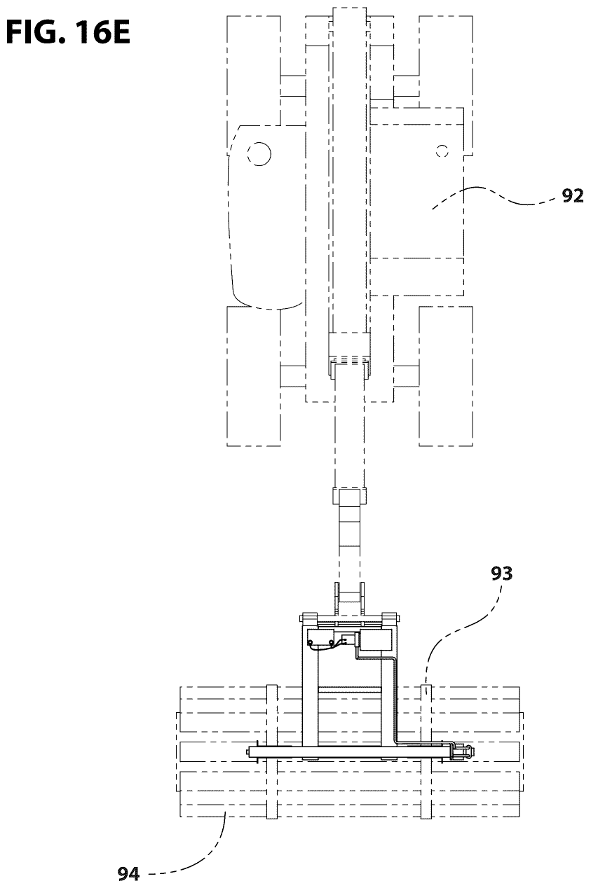

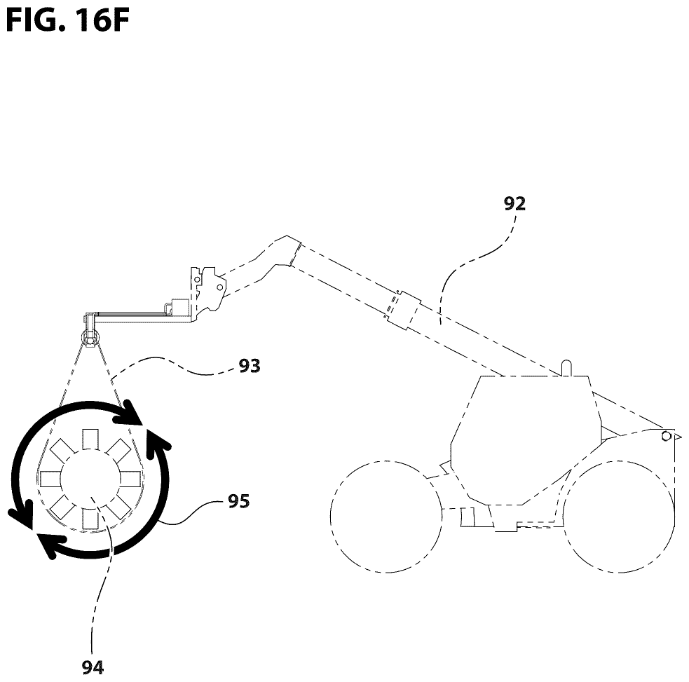

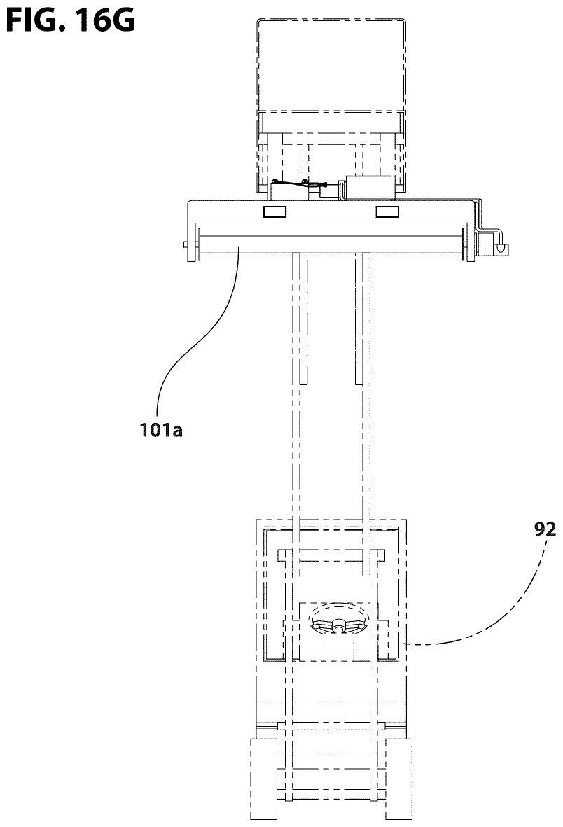

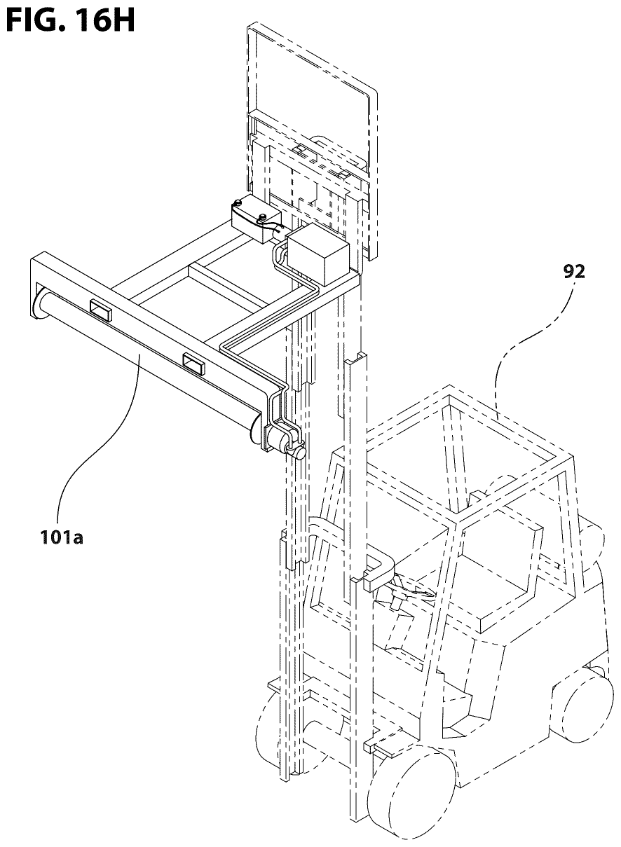

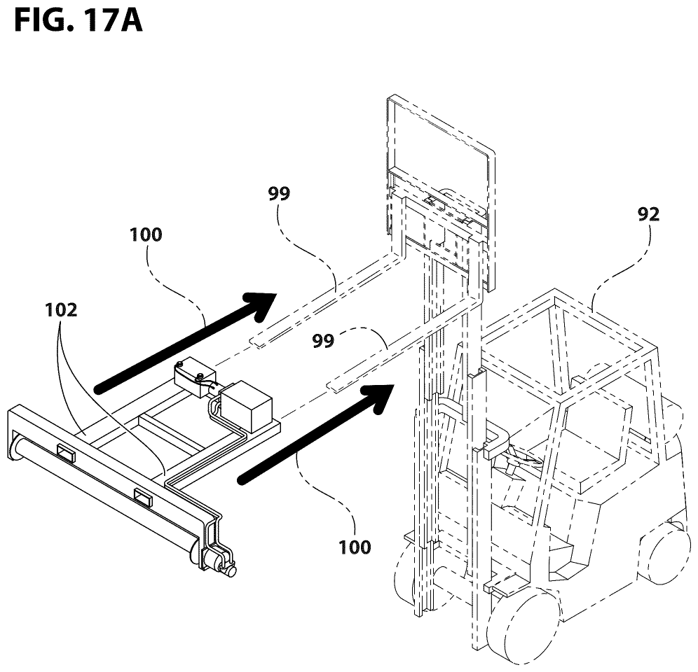

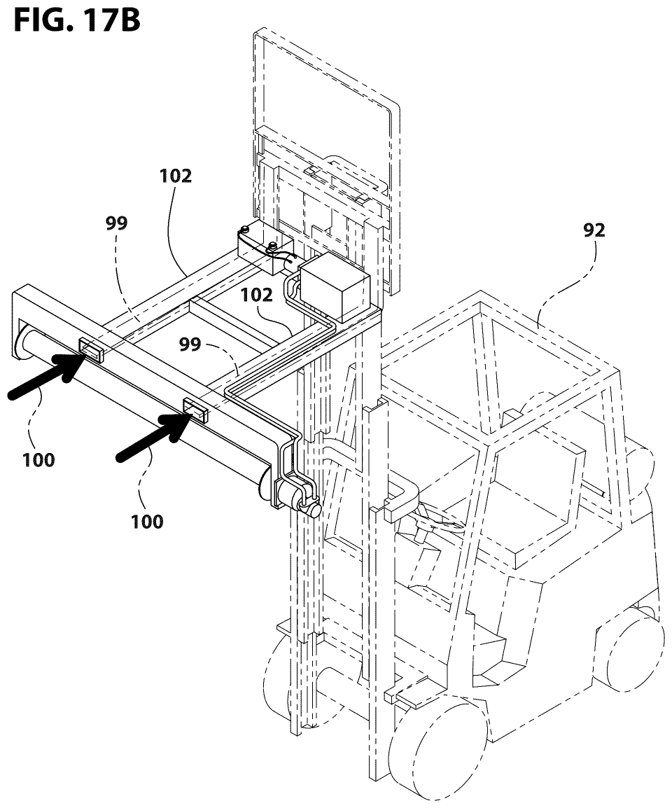

1) No prior art mention or disclose any
forklift attachments or part turning devices,
having
Roller drum 101a.
Therefore, the prior art of
remote rescue cranes:
   a) Cannot provide a rotatable cylinder on a variation of forklifts 92
      in the directions of arrows 100
      (see FIG. 5, FIG. 17A and FIG. 17B);
   b) Cannot provide structural support for roller-straps or a sling 93
      (see FIG. 1, FIG. 3, FIG. 13, FIG. 14A, FIG. 14B, FIG. 14C, FIG. 14D, FIG. 15A, FIG. 15B, and FIG. 16B);
   c) Cannot provide a rotatable cylinder on which roller-straps or a sling 93 can rotate a suspended part 94 in the directions of arrows 95
      (see FIG. 1, FIG. 3, FIG. 13, FIG. 14A, FIG. 14B, FIG. 14C, FIG. 15A, FIG. 15B, FIG. 16A, FIG. 16B, and FIG. 16F); and
   d) Cannot provide a reversibly rotatable cylinder on which roller-straps or a sling 93 can rotate in opposite directions of rotation
      in the directions of arrows 96
      (see FIG. 13, FIG. 14A, FIG. 14B, and FIG. 14C).

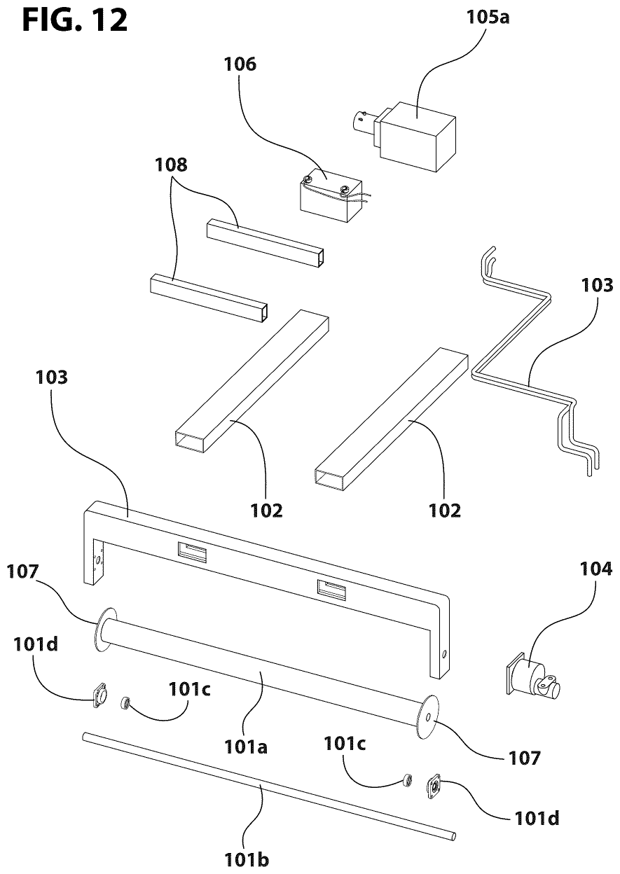

2) No prior art mention or disclose any
forklift attachments or part turning devices,
having
Roller drum 101a.
Therefore, the prior art of
forklift attachments or part turning devices:
   a) Cannot provide a cylinder with precision, controllable rotation for items being rotated within roller-straps or a sling 93, such as is demonstrated with a jet engine 97,
      to rotatably support various mechanical parts, thereby increasing part-handling efficiency during many types of assembly processes
      in the directions of arrows 95
      (see FIG. 14A, FIG. 14B, and FIG. 14C);
   b) Cannot provide a reversibly rotatable roller drum 101a which can be any diameter
      (see FIG. 12);
   c) Cannot provide a reversibly rotatable cylinder which can be any length; and
   d) Cannot provide a reversibly rotatable cylinder which can accommodate roller-straps or a sling 93 of any length
      (see FIG. 14B, FIG. 15A, FIG. 15B, and FIG. 16C).

3) No prior art mention or disclose any
forklift attachments or part turning devices,
having
Roller drum 101a.
Therefore, the prior art of
forklift attachments or part turning devices:
   a) Cannot provide a reversibly rotatable cylinder which can accommodate roller-straps or a sling 93 of any width
      (see FIG. 14A, FIG. 14B, and FIG. 14C);
   b) Cannot provide a reversibly rotatable cylinder which can accommodate any number of roller-straps or a sling 93
      (see FIG. 14A, FIG. 14B, and FIG. 14C);
   c) Cannot provide a reversibly rotatable cylinder which can accommodate roller-straps or a sling 93
   to rotatably support various mechanical parts, thereby increasing part-handling efficiency during many types of assembly processes
   in the directions of arrows 95 and 96
      (see FIG. 13, FIG. 14D, FIG. 15A, and FIG. 15B); and
   d) Cannot provide a cylinder for rotating items hanging within roller-straps or a sling 93
   to perform operations in both indoor and outdoor environments
      (see FIG. 13, FIG. 16C, FIG. 16E, FIG. 16G, and FIG. 16H).

4) No prior art mention or disclose any
forklift attachments or part turning devices,
having
Roller drum 101a.
Therefore, the prior art of
forklift attachments or part turning devices:
   a) Cannot provide a reversibly rotatable cylinder which can accommodate roller-straps or a sling 93 of any width
      (see FIG. 14A, FIG. 14B, and FIG. 14C);
   b) Cannot provide a reversibly rotatable cylinder which can accommodate any number of roller-straps or a sling 93
      (see FIG. 14A, FIG. 14B, and FIG. 14C);
   c) Cannot provide a reversibly rotatable cylinder which can accommodate roller-straps or a sling 93
   to rotatably support various mechanical parts, thereby increasing part-handling efficiency during many types of assembly processes
   in the directions of arrows 95 and 96
      (see FIG. 13, FIG. 14D, FIG. 15A, and FIG. 15B); and
   d) Cannot provide a cylinder for rotating items hanging within roller-straps or a sling 93
   to perform operations in both indoor and outdoor environments
      (see FIG. 13, FIG. 16C, FIG. 16E, FIG. 16G, and FIG. 16H).

5) No prior art mention or disclose any
forklift attachments or part turning devices,
having
Roller drum 101a.
Therefore, the prior art of
forklift attachments or part turning devices:
   a) Cannot provide a reversibly rotatable cylinder which can accommodate roller-straps or a sling 93
      to support various mechanical parts, providing quick and efficient mobility and transport to required workstations
      (see FIG. 13, FIG. 14D, FIG. 16B, FIG. 16C, FIG. 16G, and FIG. 16H);
   b) Cannot provide a reversibly rotatable cylinder which can accommodate roller-straps or a sling 93
      to efficiently, portably, and controllably rotate, and/or transport various objects such as:
         mechanical parts,
         items being painted,
         items being assembled,
         items being inspected,
         items being tested,
         items being powder coated,
         items being crated,
         items being prepared for shipping,
         large parts,
         heavy parts,
         large and/or sick animals, whether conscience or unconscious (such as a dolphin 98, see FIG. 4, and FIG. 15A),
         large, human patients, whether conscience or unconscious (such as an obese human medical patient 110, see FIG. 15B),
         large fragile parts,
         heavy fragile parts,
         engine blocks and automotive parts,
         aeronautic parts (such as a jet engine 97, see FIG. 3, FIG. 14A, FIG. 14B, FIG. 14C, and FIG. 14D),
         air conditioners and HVAC units,
         furniture,
         items required to being moved to multiple locations or workstations during an assembly process,
         items required to being moved to multiple locations or during an inspection process, and
         items required to being moved from different heights during a process
      (see FIG. 13, 14A, FIG. 14B, FIG. 14C, FIG. 14D, FIG. 15A, FIG. 15B, FIG. 16A, and FIG. 16HC); and
   c) Cannot provide a reversibly rotatable cylinder which quickly and efficiently attaches to many types of common forklifts 92
      to provide a unique method which is accessible to any locality such as a:
         warehouse,
         factory,
         assembly plant,
         manufacturer,
         yard,
         marine dock,
         loading dock,
         field,
         farm,
         laboratory,
         convention center,
         air base or airport,
         aircraft assembly plants,
         casting or molding facility,
         storage facility,
         painting facility,
         machining facility,
         lumber mill,
         refractory,
         museum,
         3-D printing facility,
         zoo,
         stage or performing arts facility,
         veterinarian, and
         construction zone
      (see FIG. 13, 14A, FIG. 14B, FIG. 14C, FIG. 14D, FIG. 15A, FIG. 15B, FIG. 16A, and FIG. 16HC).

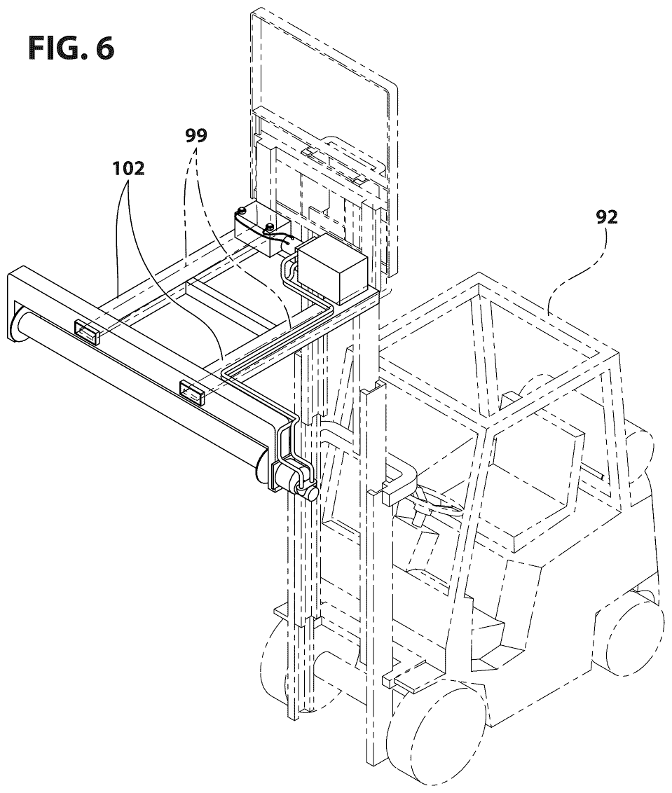

6) No prior art mention or disclose any
forklift attachments or part turning devices,
having
Roller-drum axle 101b.
Therefore, the prior art of
forklift attachments or part turning devices:
   a) Cannot provide means to attach the part flipper to a variety of types of forklift forks
      (see FIG. 5, FIG. 6, FIG. 17A, and FIG. 17B);
   b) Cannot provide means to attach the part flipper to a variety of types of forklift systems such as, but not limited to:
      three-wheeled,
      stand-up rider,
      outdoor pneumatic,
      high capacity,
      electric narrow aisle,
      order pickers,
      reach trucks,
      articulated,
      pivoting mast,
      electric motor hand,
      hand rider trucks,
      walkie stackers,
      walkie reach trucks,
      counter-balanced stackers,
      yard trucks,
      marina forklifts,
      telehandlers,
      off-road forklifts,
      wheel loaders,
      skid steers,
      swing-reach order pickers,
      multi-directional,
      side-loaders, and
      autonomous,
      (see FIG. 5, FIG. 6, FIG. 17A, and FIG. 17B); and
   c) Cannot provide structural support for roller-drum support beam 103
      (see FIG. 5, FIG. 6, FIG. 17A, and FIG. 17B).

6) No prior art mention or disclose any
forklift attachments or part turning devices,
having
Forklift-attachable load-distributing frames 102.
Therefore, the prior art of
forklift attachments or part turning devices:
   a) Cannot provide means to attach the part flipper to a variety of types of forklift forks
      (see FIG. 5, FIG. 6, FIG. 17A, and FIG. 17B);
   b) Cannot provide means to attach the part flipper to a variety of types of forklift systems such as, but not limited to:
      three-wheeled,
      stand-up rider,
      outdoor pneumatic,
      high capacity,
      electric narrow aisle,
      order pickers,
      reach trucks,
      articulated,
      pivoting mast,
      electric motor hand,
      hand rider trucks,
      walkie stackers,
      walkie reach trucks,
      counter-balanced stackers,
      yard trucks,
      marina forklifts,
      telehandlers,
      off-road forklifts,
      wheel loaders,
      skid steers,
      swing-reach order pickers,
      multi-directional,
      side-loaders, and
      autonomous,
      (see FIG. 5, FIG. 6, FIG. 17A, and FIG. 17B); and
   c) Cannot provide structural support for roller-drum support beam 103
      (see FIG. 5, FIG. 6, FIG. 17A, and FIG. 17B).

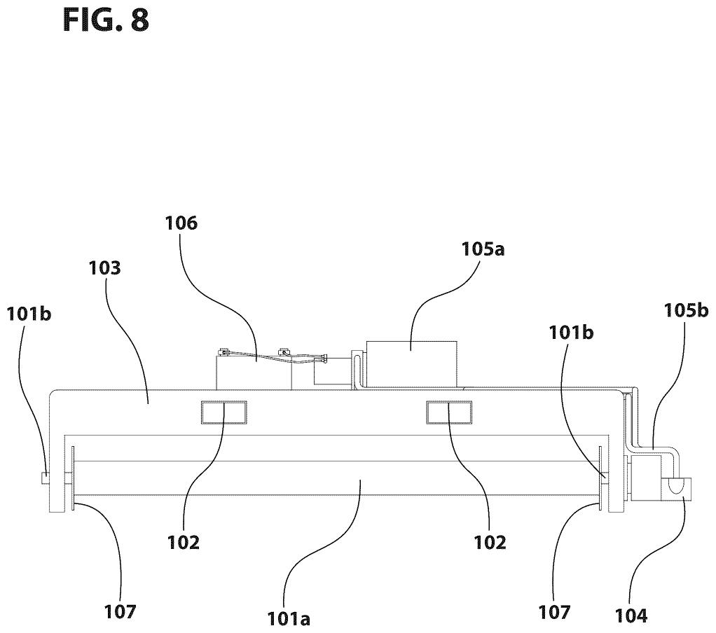

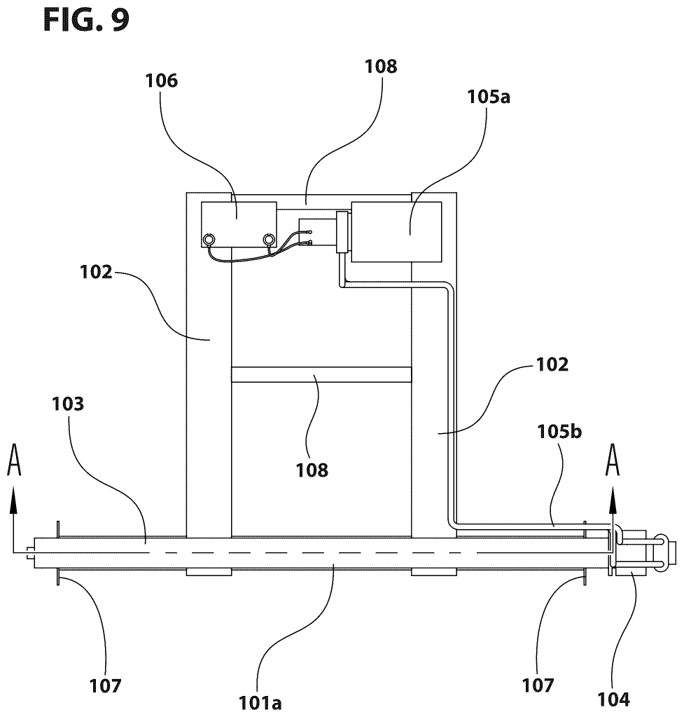

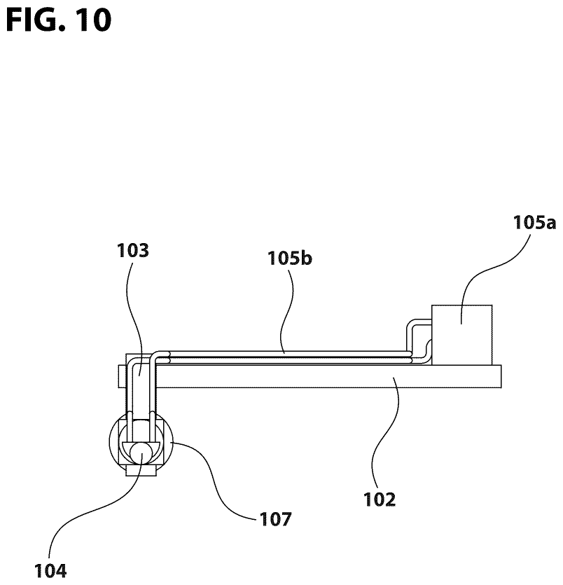

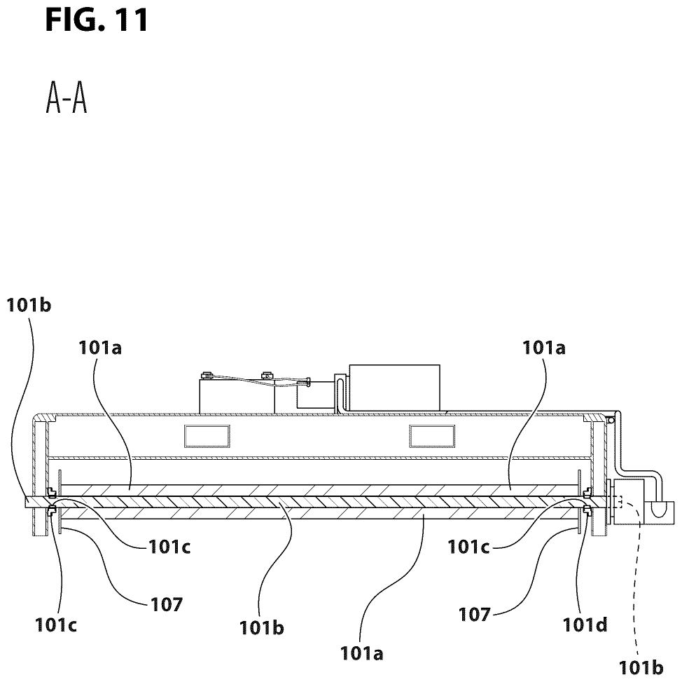

7) No prior art mention or disclose any
forklift attachments or part turning devices,
having
Roller-drum support beam 103.
Therefore, the prior art of
forklift attachments or part turning devices:
   a) Cannot provide means to rigidly and cantileverly support roller drum 101a in conjunction with roller-drum bearing assemblies 101c and roller-drum-bearing seats 101d
      (see FIG. 8, FIG. 9, FIG. 11, FIG. 12, and FIG. 15A); and
   b) Cannot provide means for a free-span of space for accommodating operations of roller-straps or a sling 93
      (see FIG. 8, FIG. 9, FIG. 12, and FIG. 15A).

8) No prior art mention or disclose any
forklift attachments or part turning devices,
having
Roller-drum turning device 104.
Therefore, the prior art of
forklift attachments or part turning devices:
   a) Cannot provide means to bi-directionally rotate roller drum 101a in conjunction with roller-drum bearing assemblies 101c and roller-drum-bearing seats 101d
      (see FIG. 8, FIG. 9, FIG. 10, and FIG. 12); and
   b) Cannot provide means to precisely and controllably rotate roller drum 101a in conjunction with roller-drum bearing assemblies 101c and roller-drum-bearing seats 101d
      (see FIG. 8, FIG. 9, FIG. 10, and FIG. 12).

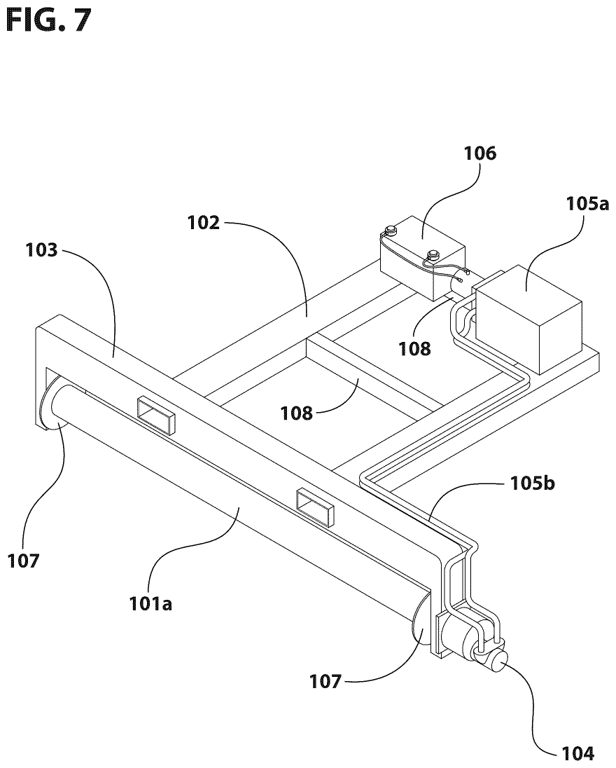

9) No prior art mention or disclose any
forklift attachments or part turning devices,
having
Control box 105a.
Therefore, the prior art of
forklift attachments or part turning devices:
   a) Cannot provide means to power, or provide a driving force, for roller-drum turning device 104 and other associated devices or implements
      (see FIG. 7, FIG. 8, FIG. 9, FIG. 10, and FIG. 12); and
   b) Cannot provide mechanical, fluid, or electrical means to pump hydraulic fluid through control lines 105b
      (see FIG. 8, FIG. 9, FIG. 10, and FIG. 12).

10) No prior art mention or disclose any
forklift attachments or part turning devices,
having
Roller-drum strap stops 107.
Therefore, the prior art of
forklift attachments or part turning devices:
   Cannot prevent roller-straps or a sling 93 from rolling beyond the ends of the full width of roller drum 101a during active operation.
      (see FIG. 8, FIG. 9, FIG. 10, and FIG. 12).

11) No prior art mention or disclose any
forklift attachments or part turning devices,
having
Forklift-attachable load-distributing frame cross-members 108.
Therefore, the prior art of
forklift attachments or part turning devices:
   Cannot attach to and structurally stabilizing forklift-attachable load-distributing frames 102, providing structural support for battery 106 and control box 105a
      (see FIG. 7, FIG. 9, FIG. 10, and FIG. 12).

### OBJECTS AND ADVANTAGES OF THE INVENTION

The present invention substantially departs from the conventional concepts and designs of the prior art. In doing so, the present invention provides a forklift part flipper attachment having: a) Roller drum, b) Roller-drum axle, c) Forklift-attachable load-distributing frames, d) Roller-drum support beam, e) Roller-drum turning device, f) Control box, g) Roller-drum strap stops, h) Forklift-attachable load-distributing frame cross-members, having many new and significant features, functions, and advantages, which overcome all the disadvantages of the prior art, as follows:

1) It is an object of the new invention to provide a
forklift part flipper attachment having
Roller drum 101a.
Therefore, the
forklift part flipper attachment:
   a) Can provide a rotatable cylinder on a variation of forklifts 92
      in the directions of arrows 100
      (see FIG. 5, FIG. 17A and FIG. 17B);
   b) Can provide structural support for roller-straps or a sling 93
      (see FIG. 1, FIG. 3, FIG. 13, FIG. 14A, FIG. 14B, FIG. 14C, FIG. 14D, FIG. 15A, FIG. 15B, and FIG. 16B);
   c) Can provide a rotatable cylinder on which roller-straps or a sling 93 can rotate a suspended part 94 in the directions of arrows 95
      (see FIG. 1, FIG. 3, FIG. 13, FIG. 14A, FIG. 14B, FIG. 14C, FIG. 15A, FIG. 15B, FIG. 16A, FIG. 16B, and FIG. 16F); and
   d) Can provide a reversibly rotatable cylinder on which roller-straps or a sling 93 can rotate in opposite directions of rotation
      in the directions of arrows 96
      (see FIG. 13, FIG. 14A, FIG. 14B, and FIG. 14C).

2) It is an object of the new invention to provide a
forklift part flipper attachment having
Roller drum 101a.
Therefore, the
forklift part flipper attachment:
   a) Can provide a cylinder with precision, controllable rotation for items being rotated within roller-straps or a sling 93, such as is demonstrated with a jet engine 97,
      to rotatably support various mechanical parts, thereby increasing part-handling efficiency during many types of assembly processes
      in the directions of arrows 95
      (see FIG. 14A, FIG. 14B, and FIG. 14C);
   b) Can provide a reversibly rotatable roller drum 101a which can be any diameter
      (see FIG. 12);
   c) Can provide a reversibly rotatable cylinder which can be any length; and
   d) Can provide a reversibly rotatable cylinder which can accommodate roller-straps or a sling 93 of any length
      (see FIG. 14B, FIG. 15A, FIG. 15B, and FIG. 16C).

3) It is another object of the new invention to provide a
forklift part flipper attachment having
Roller drum 101a.
Therefore, the
forklift part flipper attachment:
   a) Can provide a reversibly rotatable cylinder which can accommodate roller-straps or a sling 93 of any width
      (see FIG. 14A, FIG. 14B, and FIG. 14C);
   b) Can provide a reversibly rotatable cylinder which can accommodate any number of roller-straps or a sling 93
      (see FIG. 14A, FIG. 14B, and FIG. 14C);
   c) Can provide a reversibly rotatable cylinder which can accommodate roller-straps or a sling 93
   to rotatably support various mechanical parts, thereby increasing part-handling efficiency during many types of assembly processes
   in the directions of arrows 95 and 96
      (see FIG. 13, FIG. 14D, FIG. 15A, and FIG. 15B); and
   d) Can provide a cylinder for rotating items hanging within roller-straps or a sling 93
   to perform operations in both indoor and outdoor environments
      (see FIG. 13, FIG. 16C, FIG. 16E, FIG. 16G, and FIG. 16H).

4) It is another object of the new invention to provide a
forklift part flipper attachment having
Roller drum 101a.
Therefore, the
forklift part flipper attachment:
   a) Can provide a reversibly rotatable cylinder which can accommodate roller-straps or a sling 93 of any width
      (see FIG. 14A, FIG. 14B, and FIG. 14C);
   b) Can provide a reversibly rotatable cylinder which can accommodate any number of roller-straps or a sling 93
      (see FIG. 14A, FIG. 14B, and FIG. 14C);
   c) Can provide a reversibly rotatable cylinder which can accommodate roller-straps or a sling 93
   to rotatably support various mechanical parts, thereby increasing part-handling efficiency during many types of assembly processes
   in the directions of arrows 95 and 96
      (see FIG. 13, FIG. 14D, FIG. 15A, and FIG. 15B); and
   d) Can provide a cylinder for rotating items hanging within roller-straps or a sling 93
   to perform operations in both indoor and outdoor environments
      (see FIG. 13, FIG. 16C, FIG. 16E, FIG. 16G, and FIG. 16H).

5) It is still another object of the new invention to provide a
forklift part flipper attachment having
Roller drum 101a.
Therefore, the
forklift part flipper attachment:
   a) Can provide a reversibly rotatable cylinder which can accommodate roller-straps or a sling 93
      to support various mechanical parts, providing quick and efficient mobility and transport to required workstations
      (see FIG. 13, FIG. 14D, FIG. 16B, FIG. 16C, FIG. 16G, and FIG. 16H);
   b) Can provide a reversibly rotatable cylinder which can accommodate roller-straps or a sling 93
      to efficiently, portably, and controllably rotate, and/or transport various objects such as:
         mechanical parts,
         items being painted,
         items being assembled,
         items being inspected,
         items being tested,
         items being powder coated,
         items being crated,
         items being prepared for shipping,
         large parts,
         heavy parts,
         large and/or sick animals, whether conscience or unconscious (such as a dolphin 98, see FIG. 4, and human medical patient 110, see FIG. 15B),
         large fragile parts,
         heavy fragile parts,
         engine blocks and automotive parts,
         aeronautic parts (such as a jet engine 97, see FIG. 3, FIG. 14A, FIG. 14B, FIG. 14C, and FIG. 14D),
         air conditioners and HVAC units,
         furniture,
         items required to being moved to multiple locations or workstations during an assembly process,
         items required to being moved to multiple locations or during an inspection process, and
         items required to being moved from different heights during a process
      (see FIG. 13, 14A, FIG. 14B, FIG. 14C, FIG. 14D, FIG. 15A, FIG. 15B, FIG. 16A, and FIG. 16HC); and
   c) Can provide a reversibly rotatable cylinder which quickly and efficiently attaches to many types of common forklifts 92
      to provide a unique method which is accessible to any locality such as a:
         warehouse,
         factory,
         assembly plant,
         manufacturer,
         yard,
         marine dock,
         loading dock,
         field,
         farm,
         laboratory,
         convention center,
         air base or airport,
         aircraft assembly plants,
         casting or molding facility,
         storage facility,
         painting facility,
         machining facility,
         lumber mill,
         refractory,
         museum,
         3-D printing facility,
         zoo,
         stage or performing arts facility,
         veterinarian, and
         construction zone
      (see FIG. 13, 14A, FIG. 14B, FIG. 14C, FIG. 14D, FIG. 15A, FIG. 15B, FIG. 16A, and FIG. 16HC).

6) It is still yet another object of the new invention to provide a
forklift part flipper attachment having
Roller-drum axle 101b.
Therefore, the
forklift part flipper attachment:
   a) Can provide means to attach the part flipper to a variety of types of forklift forks
      (see FIG. 5, FIG. 6, FIG. 17A, and FIG. 17B);
   b) Can provide means to attach the part flipper to a variety of types of forklift systems such as, but not limited to:
      three-wheeled,
      stand-up rider,
      outdoor pneumatic,
      high capacity,
      electric narrow aisle,
      order pickers,
      reach trucks,
      articulated,
      pivoting mast,
      electric motor hand,
      hand rider trucks,
      walkie stackers,
      walkie reach trucks,
      counter-balanced stackers,
      yard trucks,
      marina forklifts,
      telehandlers,
      off-road forklifts,
      wheel loaders,
      skid steers,
      swing-reach order pickers,
      multi-directional,
      side-loaders, and
      autonomous,
      (see FIG. 5, FIG. 6, FIG. 17A, and FIG. 17B); and
   c) Can provide structural support for roller-drum support beam 103
      (see FIG. 5, FIG. 6, FIG. 17A, and FIG. 17B).

6) It is still yet another object of the new invention to provide a
forklift part flipper attachment having
Forklift-attachable load-distributing frames 102.
Therefore, the
forklift part flipper attachment:
   a) Can provide means to attach the part flipper to a variety of types of forklift forks
      (see FIG. 5, FIG. 6, FIG. 17A, and FIG. 17B);
   b) Can provide means to attach the part flipper to a variety of types of forklift systems such as, but not limited to:
      three-wheeled,
      stand-up rider,
      outdoor pneumatic,
      high capacity,
      electric narrow aisle,
      order pickers,
      reach trucks,
      articulated,
      pivoting mast,
      electric motor hand,
      hand rider trucks,
      walkie stackers,
      walkie reach trucks,
      counter-balanced stackers,
      yard trucks,
      marina forklifts,
      telehandlers,
      off-road forklifts,
      wheel loaders,
      skid steers,
      swing-reach order pickers,
      multi-directional,
      side-loaders, and
      autonomous,
      (see FIG. 5, FIG. 6, FIG. 17A, and FIG. 17B); and
   c) Can provide structural support for roller-drum support beam 103
      (see FIG. 5, FIG. 6, FIG. 17A, and FIG. 17B).

7) It is a further object of the new invention to provide a
forklift part flipper attachment having
Roller-drum support beam 103.
Therefore, the
forklift part flipper attachment:
   a) Can provide means to rigidly and cantileverly support roller drum 101a in conjunction with roller-drum bearing assemblies 101c and roller-drum-bearing seats 101d
      (see FIG. 8, FIG. 9, FIG. 11, FIG. 12, and FIG. 15A); and
   b) Can provide means for a free-span of space for accommodating operations of roller-straps or a sling 93
      (see FIG. 8, FIG. 9, FIG. 12, and FIG. 15A).

8) It is an even further object of the new invention to provide a
forklift part flipper attachment having
Roller-drum turning device 104.
Therefore, the
forklift part flipper attachment:
   a) Can provide means to bi-directionally rotate roller drum 101a in conjunction with roller-drum bearing assemblies 101c and roller-drum-bearing seats 101d
      (see FIG. 8, FIG. 9, FIG. 10, and FIG. 12); and
   b) Can provide means to precisely and controllably rotate roller drum 101a in conjunction with roller-drum bearing assemblies 101c and roller-drum-bearing seats 101d
      (see FIG. 8, FIG. 9, FIG. 10, and FIG. 12).

9) It is an even further object of the new invention to provide a
forklift part flipper attachment having
Control box 105a.
Therefore, the
forklift part flipper attachment:
   a) Can provide means to power, or provide a driving force, for roller-drum turning device 104 and other associated devices or implements
      (see FIG. 7, FIG. 8, FIG. 9, FIG. 10, and FIG. 12); and
   b) Can provide mechanical, fluid, or electrical means to pump hydraulic fluid through control lines 105b
      (see FIG. 8, FIG. 9, FIG. 10, and FIG. 12).

10) It is still an even further object of the new invention to provide a
forklift part flipper attachment having
Roller-drum strap stops 107.
Therefore, the
forklift part flipper attachment:
   Can prevent roller-straps or a sling 93 from rolling beyond the ends of the full width of roller drum 101a during active operation.
      (see FIG. 8, FIG. 9, FIG. 10, and FIG. 12).

11) It is still an even further object of the new invention to provide a
forklift part flipper attachment having
Forklift-attachable load-distributing frame cross-members 108.
Therefore, the
forklift part flipper attachment:
   Attaching to and structurally stabilizing forklift-attachable load-distributing frames 102, providing structural support for battery 106 and control box 105a
      (see FIG. 7, FIG. 9, FIG. 10, and FIG. 12).

Other objects and advantages of the present invention will become apparent from a consideration of the accompanying drawings and ensuing description.

### Component

Referring to FIG. 1, FIG. 2, FIG. 3, FIG. 4, FIG. 5, FIG. 6, FIG. 7, FIG. 8, FIG. 9, FIG. 10, and FIG. 11:
1) Roller drum 101a,
   Roller-drum axle 101b,
   Roller-drum bearing assemblies 101c,
   Roller-drum-bearing seats 101d,
2) Forklift-attachable load-distributing frames 102,
3) Roller-drum support beam 103,
4) Roller-drum turning device 104,
5) Control box 105a,
   Control lines 105b,
6) Battery 106,
7) Roller-drum strap stops 107, and
8) Forklift-attachable load-distributing frame cross-members 108.

### Material

Referring to FIG. 1, FIG. 2, FIG. 3, FIG. 4, FIG. 5, FIG. 6, FIG. 7, FIG. 8, FIG. 9, FIG. 10, FIG. 11, and FIG. 12:
1) Roller drum 101a
   is (or are each) made of metallic material.
Roller-drum axle 101b
   is (or are each) made of metallic material.
Roller-drum bearing assemblies 101c
   is (or are each) made of metallic material.
Roller-drum-bearing seats 101d
   is (or are each) made of empty space.
2) Forklift-attachable load-distributing frames 102
   is (or are each) made of metallic material.
3) Roller-drum support beam 103
   is (or are each) made of metallic material.
4) Roller-drum turning device 104
   is (or are each) made of metallic material.
5) Control box 105a
   is (or are each) made of metallic material.
Control lines 105b
   is (or are each) made of the material of metallic material.
6) Battery 106
   is (or are each) made of plastic and metallic material.
7) Roller-drum strap stops 107
   is (or are each) made of metallic material.
8) Forklift-attachable load-distributing frame cross-members 108
   is (or are each) made of metallic material.

### Shape

Referring to FIG. 1, FIG. 2, FIG. 3, FIG. 4, FIG. 5, FIG. 6, FIG. 7, FIG. 8, FIG. 9, FIG. 10, FIG. 11, and FIG. 12:
1) Roller drum 101a
   is (or are each) formed into the shape of (a or an) cylinder.
Roller-drum axle 101b
   is (or are each) formed into the shape of (a or an) rod with a circular cross-section.
Roller-drum bearing assemblies 101c
   is (or are each) formed into ring shapes encompassing multiple spherical shapes.
Roller-drum-bearing seats 101d
   is (or are each) formed into recessed circular shapes.
2) Forklift-attachable load-distributing frames 102
   is (or are each) formed into rectangle tubes.
3) Roller-drum support beam 103
   is (or are each) formed into rectangle tubes.
4) Roller-drum turning device 104
   is (or are each) formed into the shape of (a or an) cylinder.
5) Control box 105a
   is (or are each) formed into the shape of (a or an) rectangle prism.
Control lines 105b
   is (or are each) formed into the shape of elongated tubes with a circular cross-section.
6) Battery 106
   is (or are each) formed into the shape of (a or an) rectangle prism.
7) Roller-drum strap stops 107
   is (or are each) formed into circular plate shapes.
8) Forklift-attachable load-distributing frame cross-members 108
   is (or are each) formed into the shape of rectangle tubes.

### Connection

Referring to FIG. 1, FIG. 2, FIG. 3, FIG. 4, FIG. 5, FIG. 6, FIG. 7, FIG. 8, FIG. 9, FIG. 10, FIG. 11, and FIG. 12:
1) Roller drum 101a
   is (or are respectively)
   molded securely to roller-drum axle 101b.
Roller-drum axle 101b
   is (or are respectively)
   rotatably attached to roller-drum bearing assemblies 101c.
Roller-drum bearing assemblies 101c
   is (or are respectively)
   inserted within attached to roller-drum-bearing seats 101d.
Roller-drum-bearing seats 101d
   is (or are respectively)
   inserted within attached to roller-drum support beam 103.
2) Forklift-attachable load-distributing frames 102
   is (or are respectively)
   molded securely to roller-drum support beam 103.
3) Roller-drum support beam 103
   is (or are respectively)
   inserted within attached to forklift-attachable load-distributing frames 102.
4) Roller-drum turning device 104
   is (or are respectively)
   attached to roller-drum support beam 103.
5) Control box 105a
   is (or are respectively)
   removeably attached to forklift-attachable load-distributing frames 102.
Control lines 105b
   is (or are respectively)
   connected to roller-drum turning device 104 and control box 105a
6) Battery 106
   is (or are respectively)
   removeably attached to forklift-attachable load-distributing frames 102.
7) Roller-drum strap stops 107
   is (or are respectively)
   attached to roller drum 101a and/or roller-drum axle 101b.
8) Forklift-attachable load-distributing frame cross-members 108
   is (or are respectively)
   attached to forklift-attachable load-distributing frames 102.

### Function

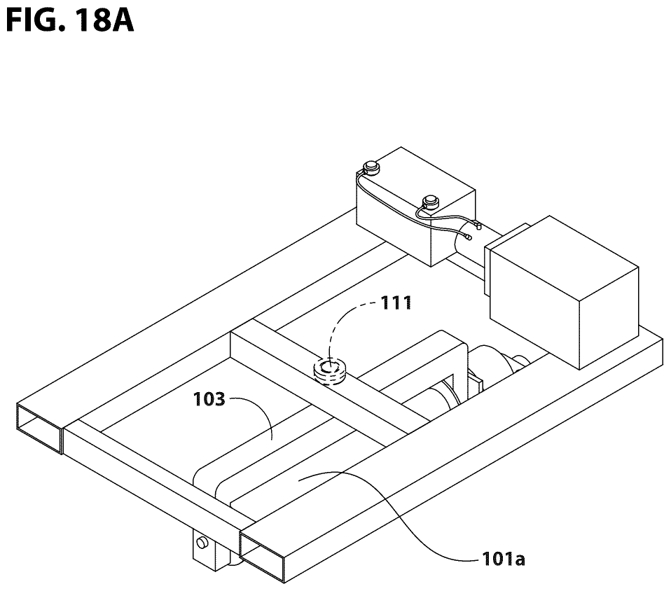

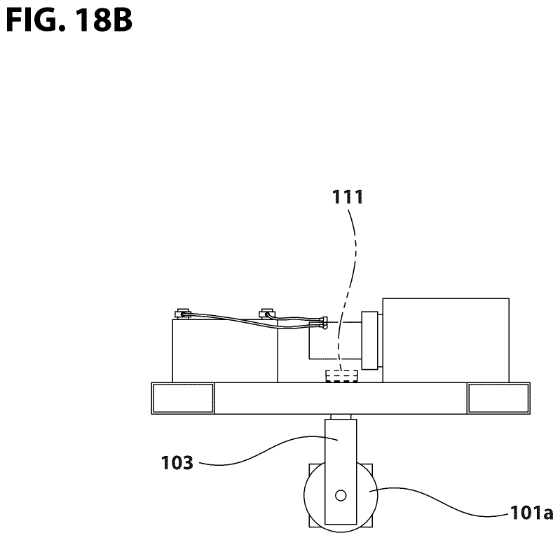

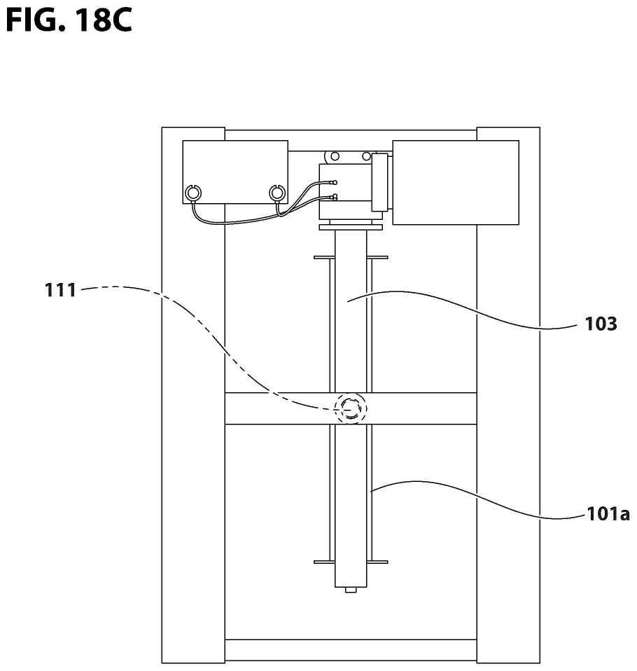

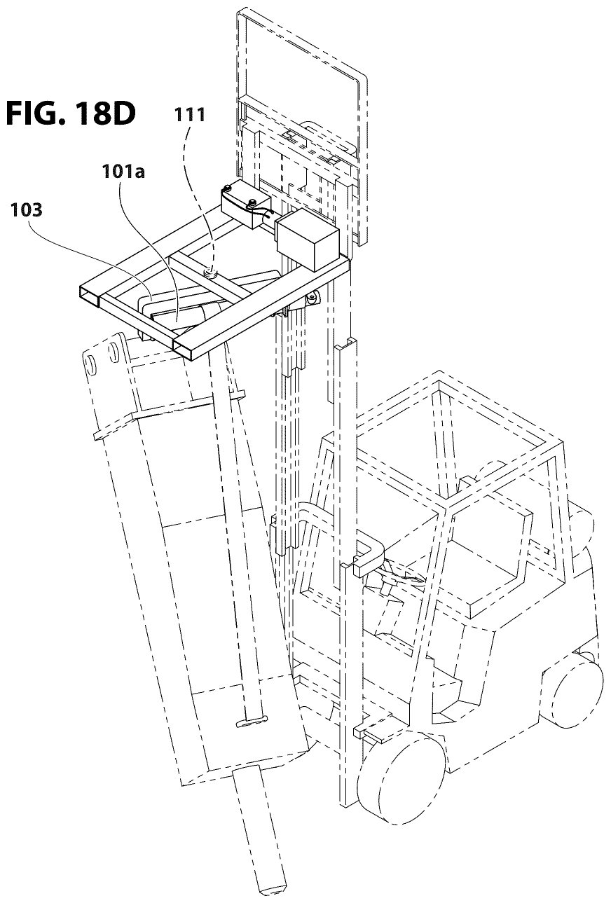

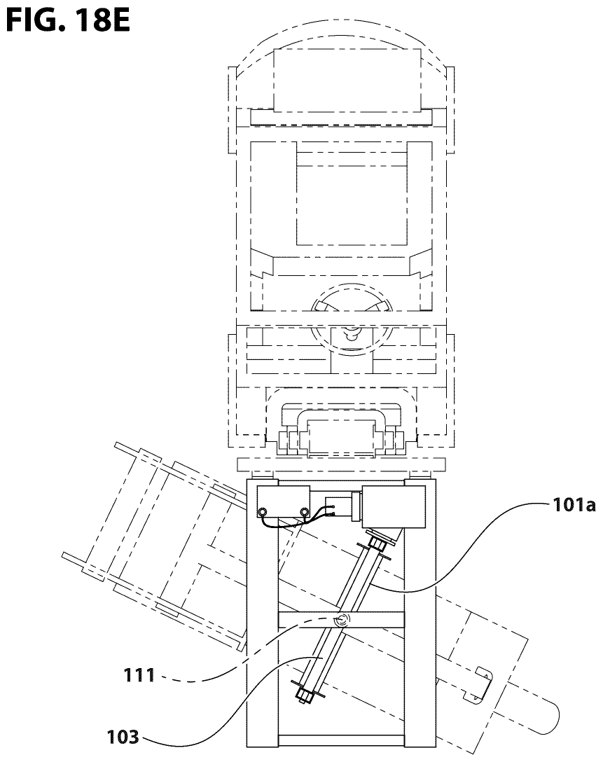

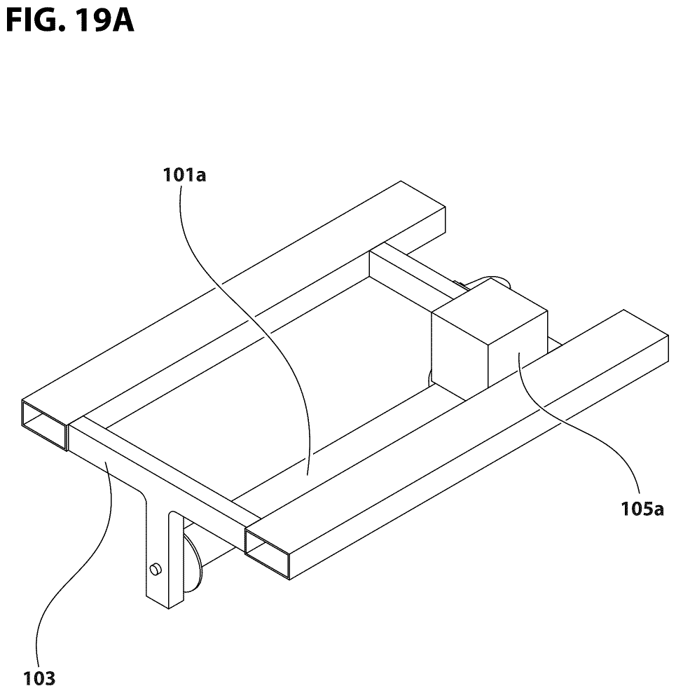

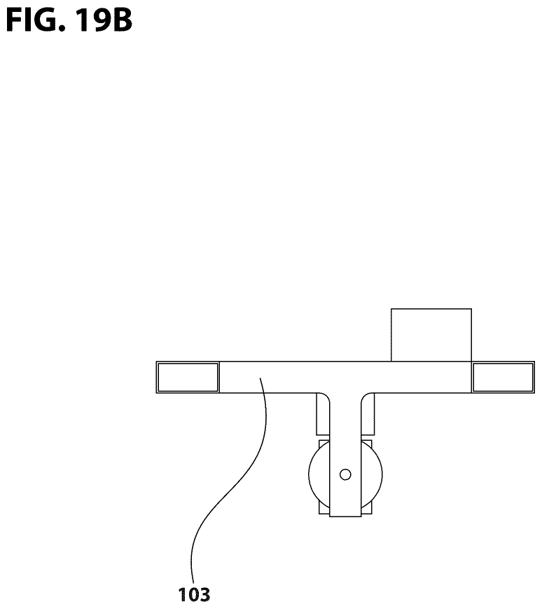

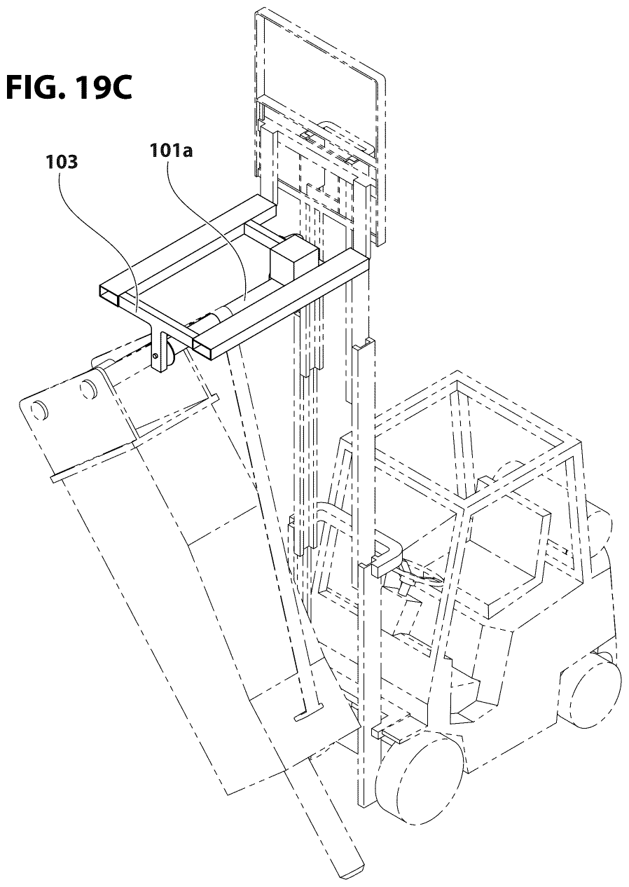

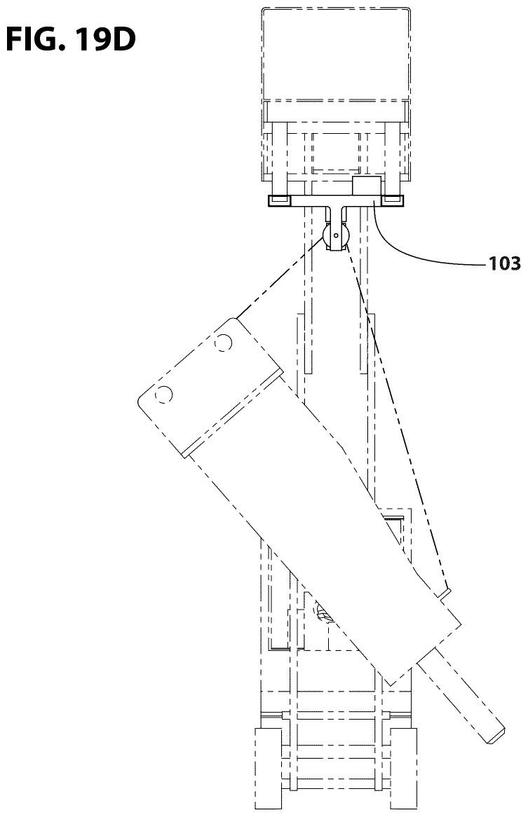

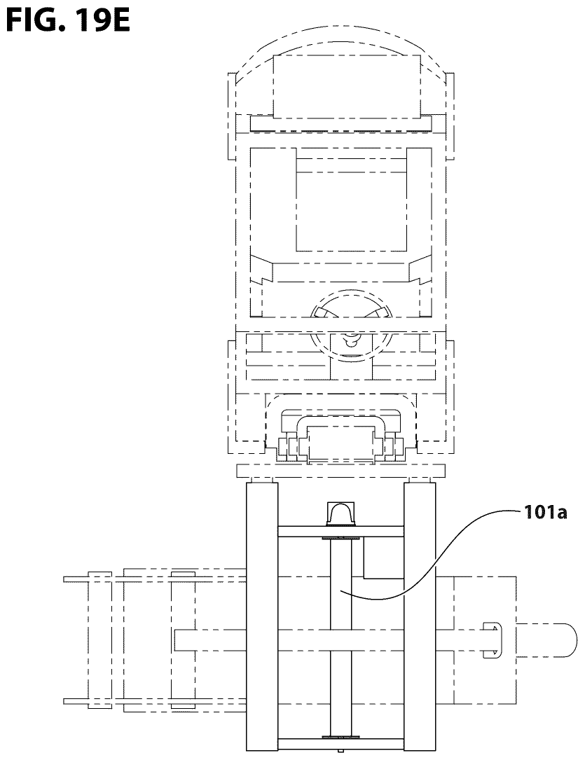

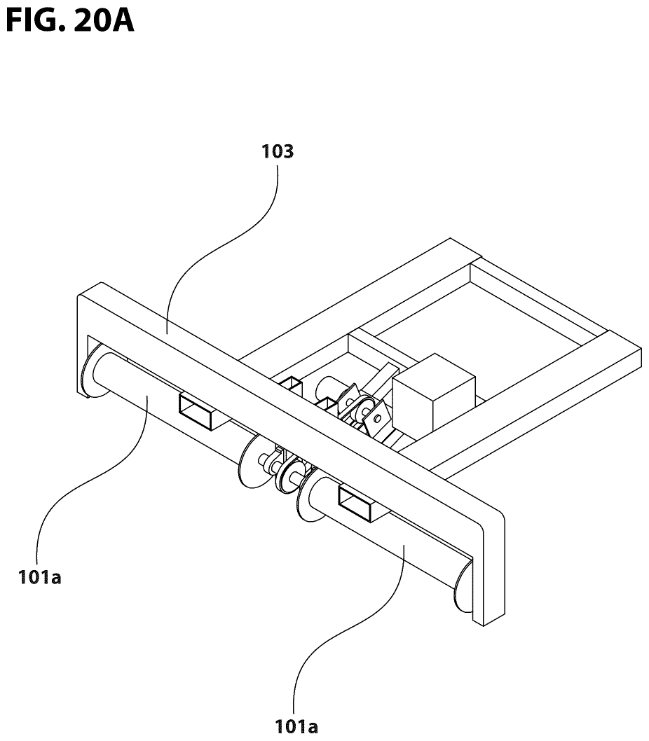

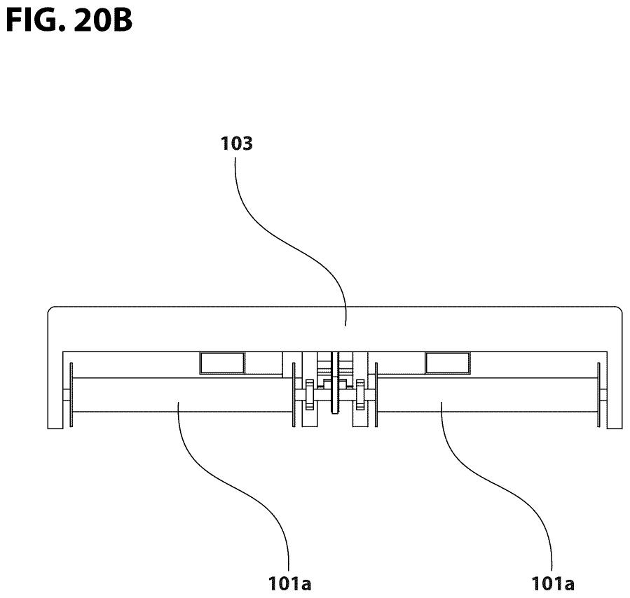

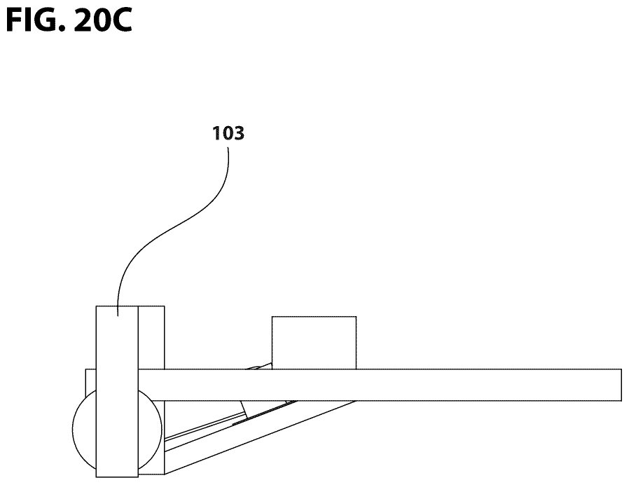

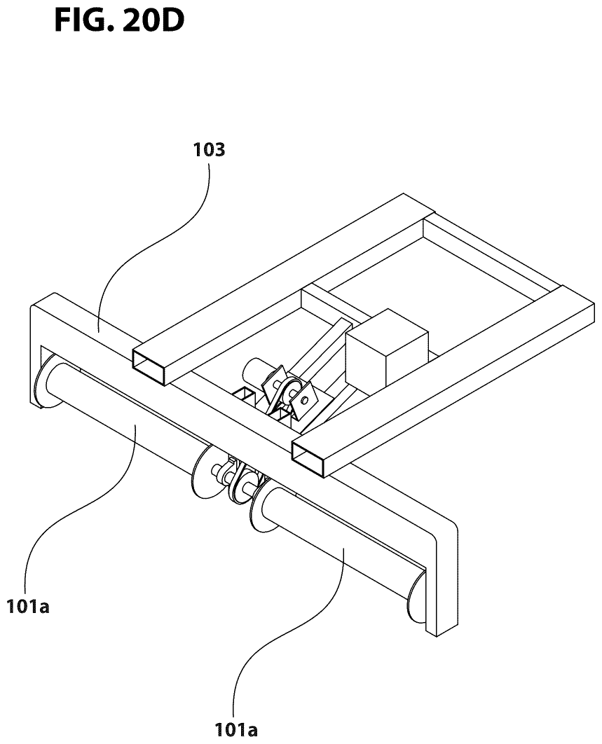

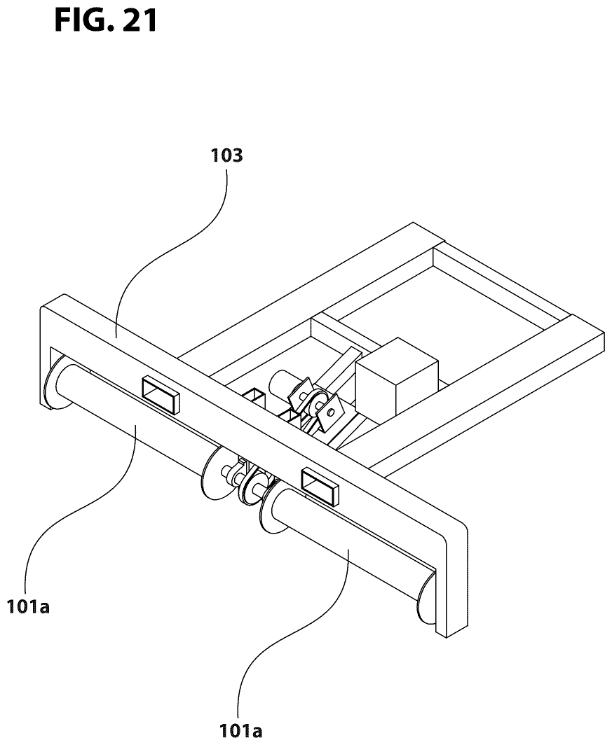

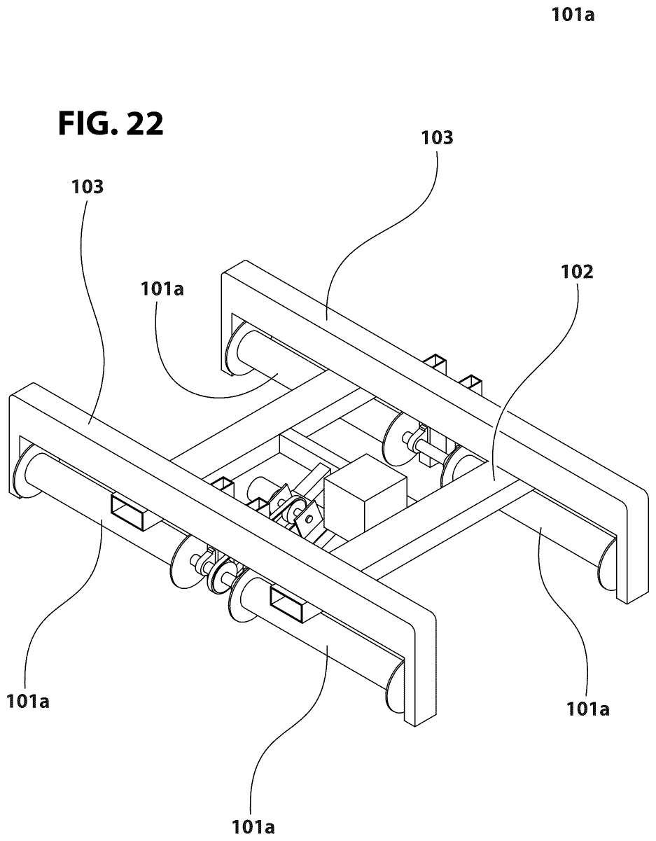

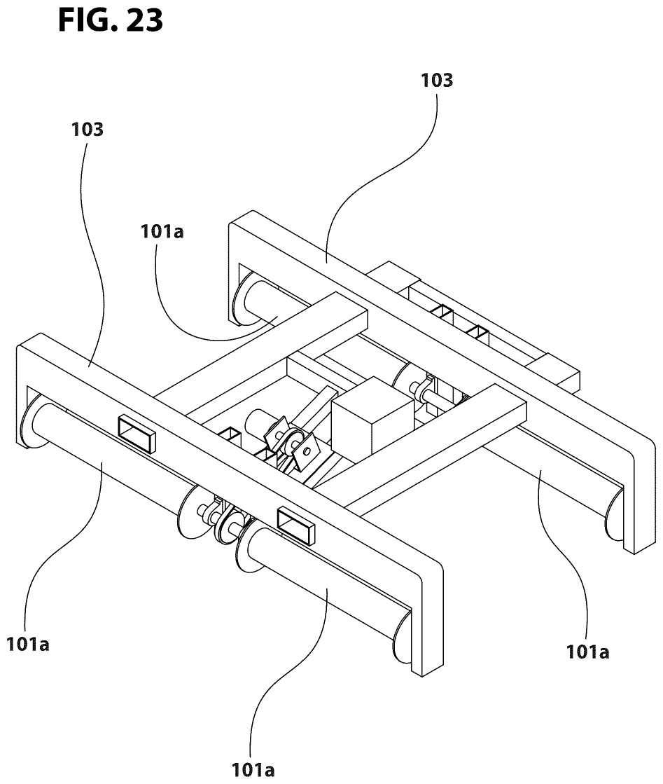

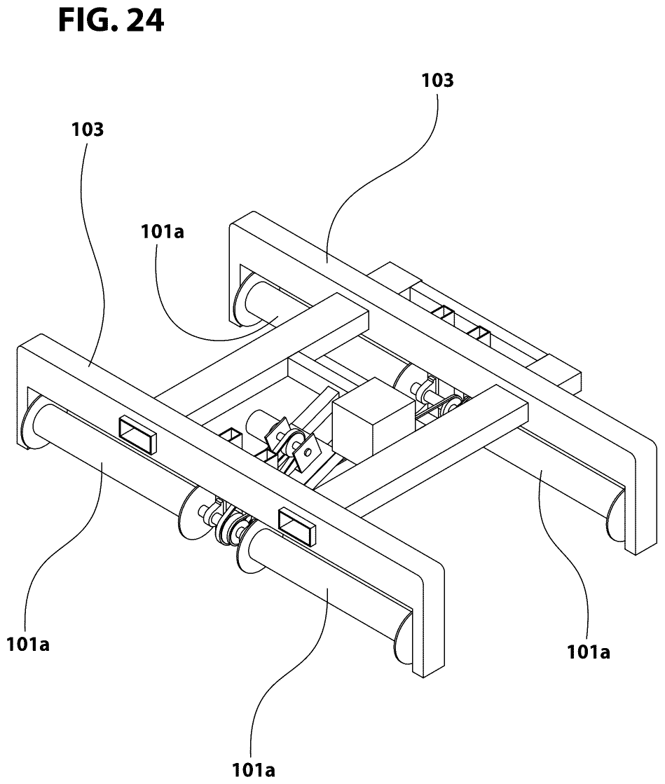

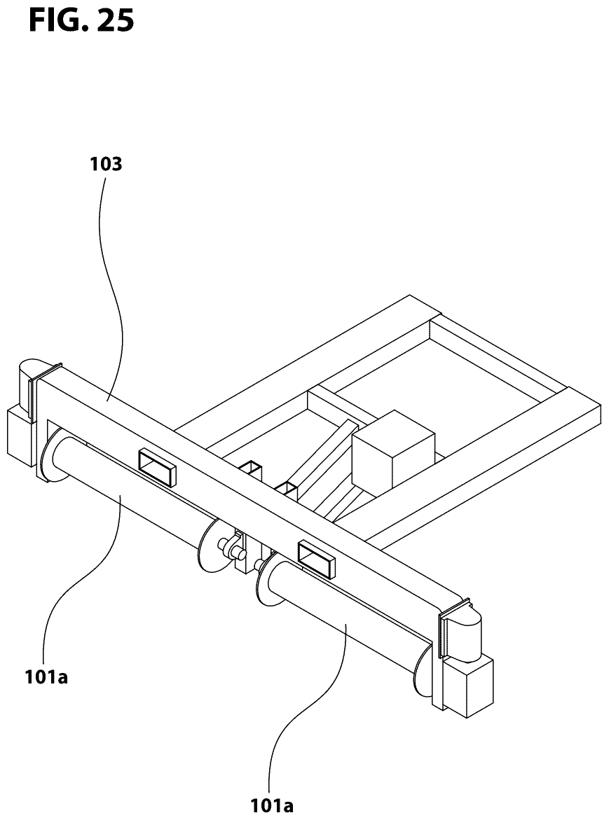

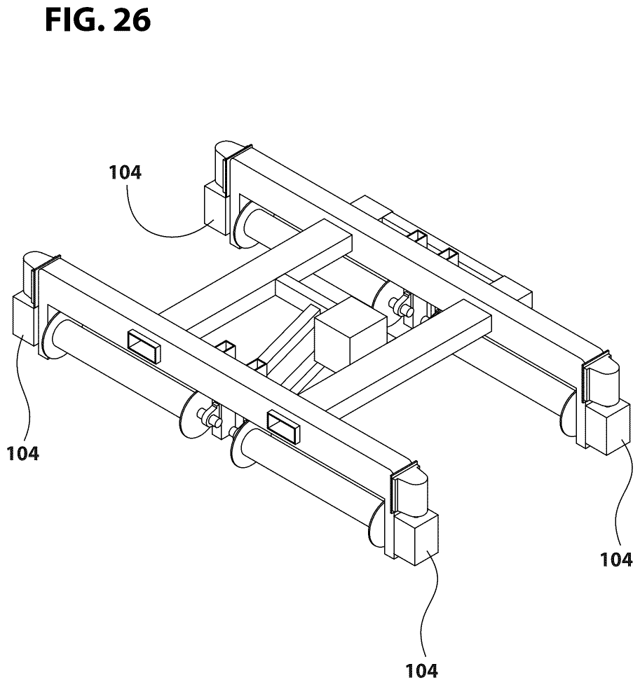

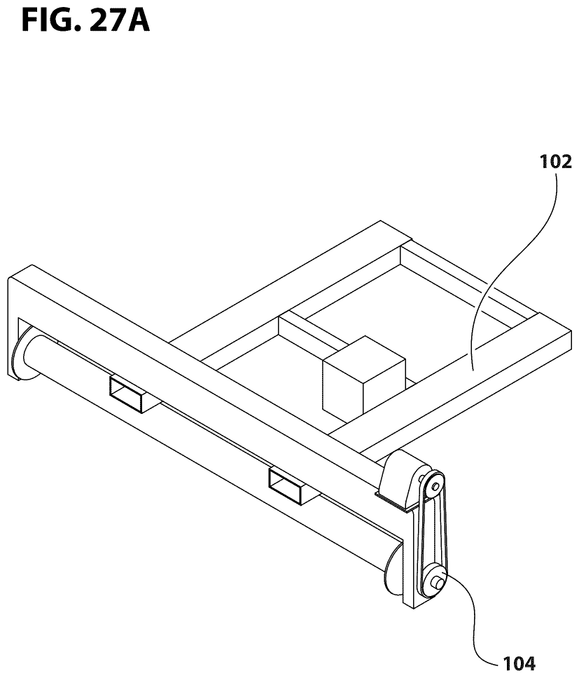

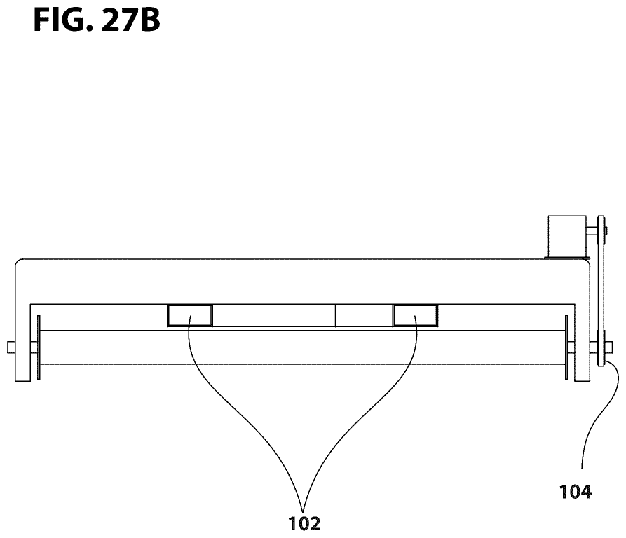

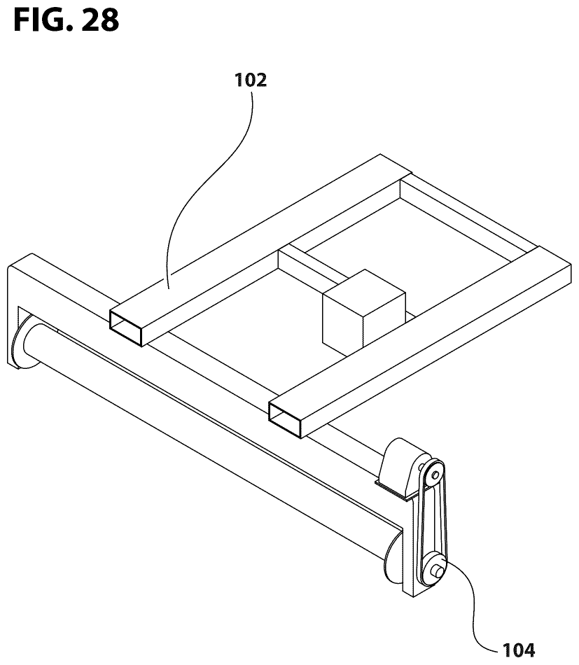

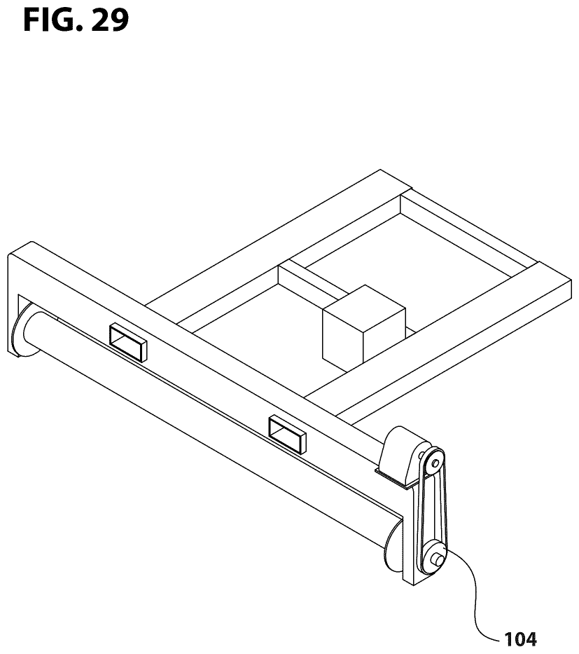

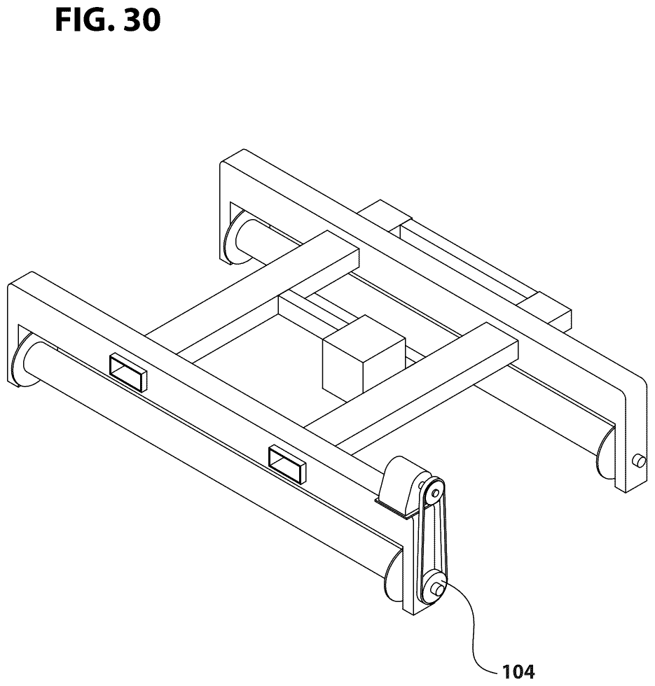

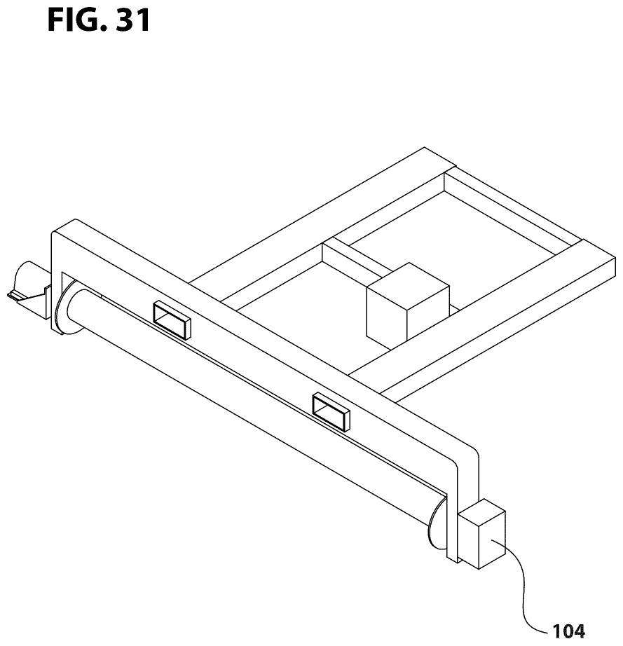

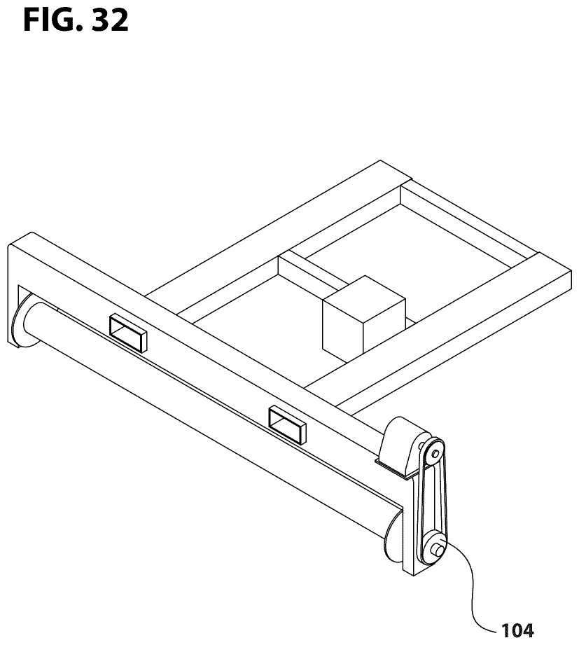

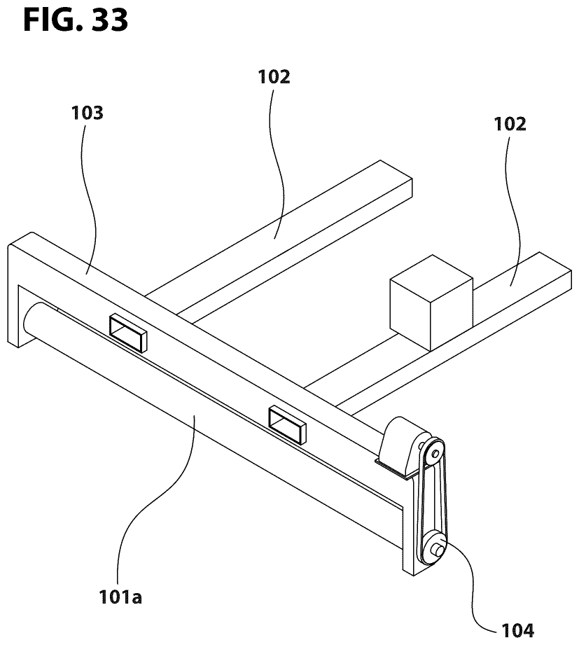

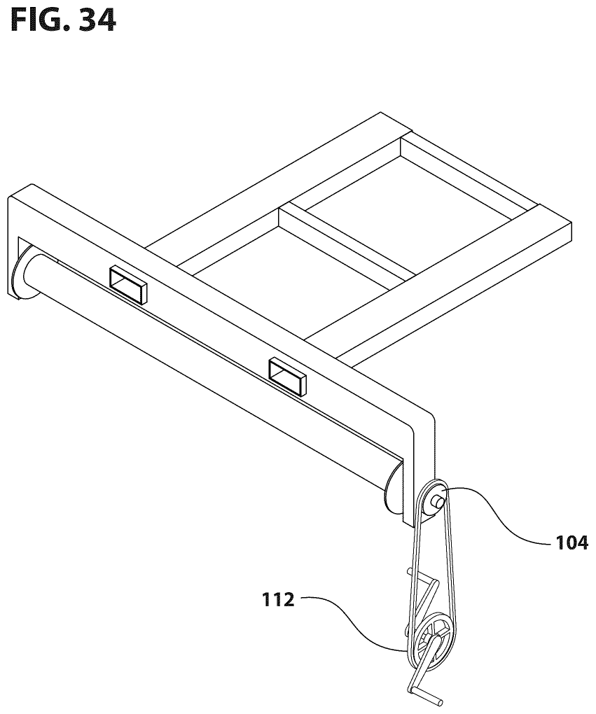

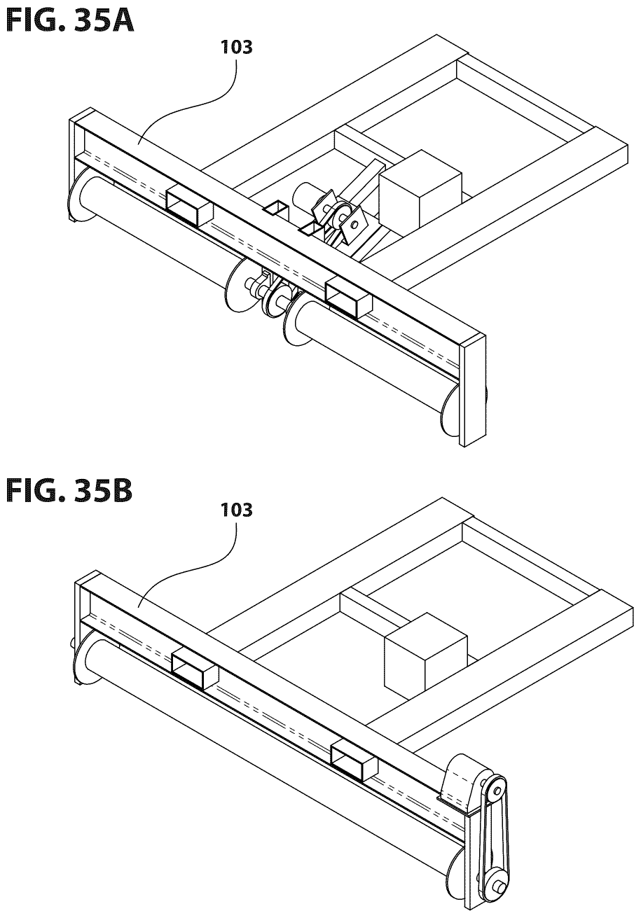

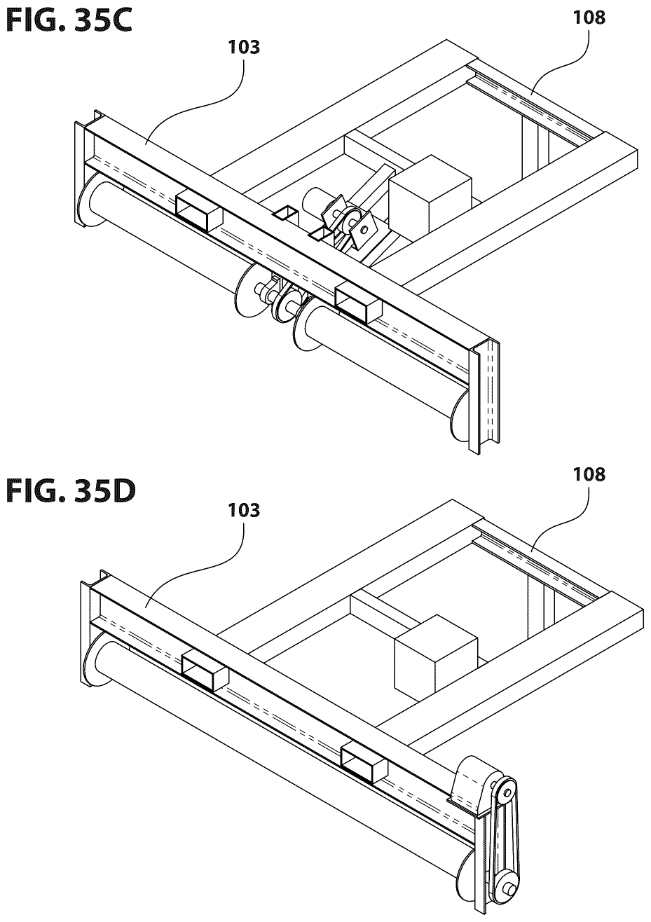

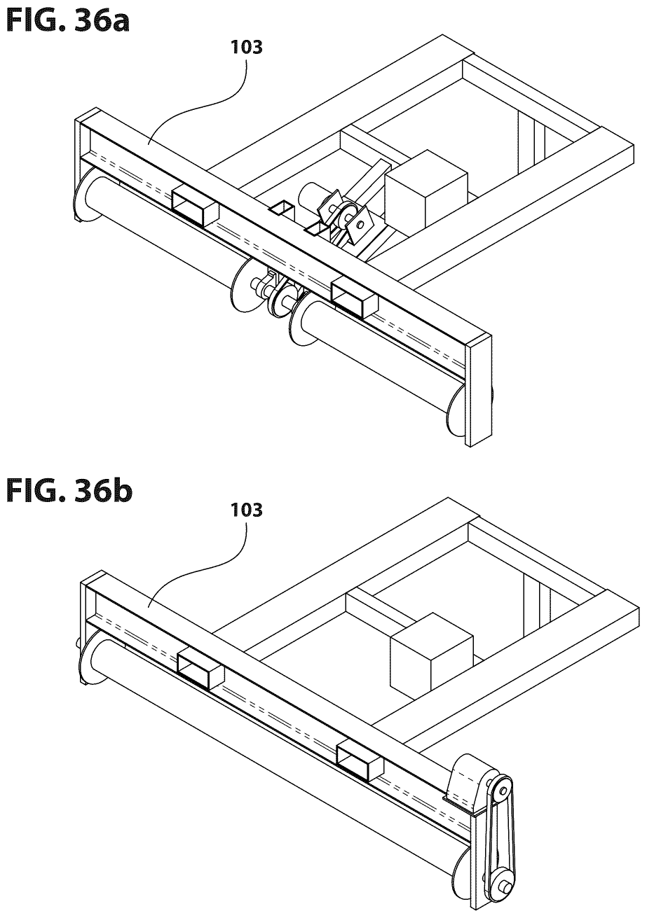

Referring to FIG. 1, FIG. 3, FIG. 4, FIG. 5, FIG. 7, FIG. 8, FIG. 9, FIG. 10, FIG. 11, FIG. 12, FIG. 13, FIG. 14A, FIG. 14B, FIG. 14C, FIG. 14D, FIG. 15A, FIG. 15B, FIG. 16A, FIG. 16B, FIG. 16C, FIG. 16D, FIG. 16E, FIG. 16F, FIG. 16G, FIG. 16H, FIG. 17A, FIG. 17B, FIG. 18A, FIG. 18B, FIG. 18C, FIG. 18D, FIG. 18E, FIG. 19A, FIG. 19B, FIG. 19C, FIG. 19D, FIG. 19E, FIG. 20A, FIG. 20B, FIG. 20C, FIG. 20D, FIG. 21, FIG. 22, FIG. 23, FIG. 24, FIG. 25, FIG. 26, FIG. 27A, FIG. 27B, FIG. 28, FIG. 29, FIG. 30, FIG. 31, FIG. 32, FIG. 33, FIG. 34, FIG. 35A, FIG. 35B, FIG. 35C, FIG. 35D, FIG. 36A, and FIG. 36B:
1) Roller drum 101a
   is (or are respectively) for:
a) Providing a rotatable cylinder on a variation of forklifts 92
   in the directions of arrows 100
   (see FIG. 5, FIG. 17A and FIG. 17B);
b) Providing structural support for roller-straps or a sling 93
   (see FIG. 1, FIG. 3, FIG. 13, FIG. 14A, FIG. 14B, FIG. 14C, FIG. 14D, FIG. 15A, FIG. 15B, and FIG. 16B);
c) Providing a rotatable cylinder on which roller-straps or a sling 93 can rotate a suspended part 94 in the directions of arrows 95
   (see FIG. 1, FIG. 3, FIG. 13, FIG. 14A, FIG. 14B, FIG. 14C, FIG. 15A, FIG. 15B, FIG. 16A, FIG. 16B, and FIG. 16F);
d) Providing a reversibly rotatable cylinder on which roller-straps or a sling 93 can rotate in opposite directions of rotation
   in the directions of arrows 96
   (see FIG. 13, FIG. 14A, FIG. 14B, and FIG. 14C);
e) Providing a cylinder with precision, controllable rotation for items being rotated within roller-straps or a sling 93, such as is demonstrated with a jet engine 97,
   to rotatably support various mechanical parts, thereby increasing part-handling efficiency during many types of assembly processes
   in the directions of arrows 95
   (see FIG. 14A, FIG. 14B, and FIG. 14C);
f) Providing a reversibly rotatable roller drum 101a which can be any diameter
   (see FIG. 12);
g) Providing a reversibly rotatable cylinder which can be any length;
h) Providing a reversibly rotatable cylinder which can accommodate roller-straps or a sling 93 of any length
   (see FIG. 14B, FIG. 15A, FIG. 15B, and FIG. 16C);
i) Providing a reversibly rotatable cylinder which can accommodate roller-straps or a sling 93 of any width
   (see FIG. 14A, FIG. 14B, and FIG. 14C);
j) Providing a reversibly rotatable cylinder which can accommodate any number of roller-straps or a sling 93
   (see FIG. 14A, FIG. 14B, and FIG. 14C);
k) Providing a reversibly rotatable cylinder which can accommodate roller-straps or a sling 93
   to rotatably support various mechanical parts, thereby increasing part-handling efficiency during many types of assembly processes
   in the directions of arrows 95 and 96
   (see FIG. 13, FIG. 14D, FIG. 15A, and FIG. 15B);
l) Providing a cylinder for rotating items hanging within roller-straps or a sling 93
   to perform operations in both indoor and outdoor environments
   (see FIG. 13, FIG. 16C, FIG. 16E, FIG. 16G, and FIG. 16H);
m) Providing a reversibly rotatable cylinder which can accommodate roller-straps or a sling 93
   to support various mechanical parts, providing quick and efficient mobility and transport to required workstations
   (see FIG. 13, FIG. 14D, FIG. 16B, FIG. 16C, FIG. 16G, and FIG. 16H);
n) Providing a reversibly rotatable cylinder which can accommodate roller-straps or a sling 93
   to efficiently, portably, and controllably rotate, and/or transport various objects such as:
      mechanical parts,
      items being painted,
      items being assembled,
      items being inspected,
      items being tested,
      items being powder coated,
      items being crated,
      items being prepared for shipping,
      large parts,
      heavy parts,
      large and/or sick animals, whether conscience or unconscious (such as a dolphin 98, see FIG. 4, and FIG. 15A),
      large, human patients, whether conscience or unconscious (see example of a human medical patient 110, see FIG. 15B),
      large fragile parts,
      heavy fragile parts,
      engine blocks and automotive parts,
      aeronautic parts (such as a jet engine 97, see FIG. 3, FIG. 14A, FIG. 14B, FIG. 14C, and FIG. 14D),
      air conditioners and HVAC units,
      furniture,
      items required to being moved to multiple locations or workstations during an assembly process,
      items required to being moved to multiple locations or during an inspection process, and
      items required to being moved from different heights during a process
   (see FIG. 13, 14A, FIG. 14B, FIG. 14C, FIG. 14D, FIG. 15A, FIG. 15B, FIG. 16A, and FIG. 16HC); and
o) Providing a reversibly rotatable cylinder which quickly and efficiently attaches to many types of common forklifts 92
   to provide a unique method which is accessible to any locality such as a:
      warehouse,
      factory,
      assembly plant,
      manufacturer,
      yard,
      marine dock,
      loading dock,
      field,
      farm,
      laboratory,
      convention center,
      air base or airport,
      aircraft assembly plants,
      casting or molding facility,
      storage facility,
      painting facility,
      machining facility,
      lumber mill,
      refractory,
      museum,
      3-D printing facility,
      zoo,
      stage or performing arts facility,
      veterinarian, and
      construction zone
   (see FIG. 13, 14A, FIG. 14B, FIG. 14C, FIG. 14D, FIG. 15A, FIG. 15B, FIG. 16A, and FIG. 16HC).
Roller-drum axle 101b
   is (or are respectively) for:
a. Providing structural support for roller drum 101a
   (see FIG. 11 and FIG. 12); and
b. Providing structural and rotatable connection between roller drum 101a and roller-drum bearing assemblies 101c
   (see FIG. 11 and FIG. 12).
Roller-drum bearing assemblies 101c
   is (or are respectively) for:
a. Providing means for a low-friction rotating connection between roller drum 101a and roller-drum axle 101b
   (see FIG. 11 and FIG. 12); and
b. Providing structural and rotatable connection between roller drum 101a and roller-drum bearing assemblies 101c
   (see FIG. 11 and FIG. 12).
Roller-drum-bearing seats 101d
   is (or are respectively) for:
   Providing means for securing roller-drum bearing assemblies 101c within roller-drum support beam 103
   (see FIG. 11 and FIG. 12).
2) Forklift-attachable load-distributing frames 102
   is (or are respectively) for:
a) Providing means to attach the forklift part flipper attachment to a variety of types of forklifts
   (see FIG. 5, FIG. 6, FIG. 17A, and FIG. 17B);
b) Providing means to attach the forklift part flipper attachment to a variety of types of forklift systems such as, but not limited to:
   three-wheeled,
   stand-up rider,
   outdoor pneumatic,
   high capacity,
   electric narrow aisle,
   order pickers,
   reach trucks,
   articulated,
   pivoting mast,
   electric motor hand,
   hand rider trucks,
   walkie stackers,
   walkie reach trucks,
   counter-balanced stackers,
   yard trucks,
   marina forklifts,
   telehandlers,
   off-road forklifts,
   wheel loaders,
   skid steers,
   swing-reach order pickers,
   multi-directional,
   side-loaders, and
   autonomous,
   (see FIG. 5, FIG. 6, FIG. 17A, and FIG. 17B); and
c) Providing structural support for roller-drum support beam 103
   (see FIG. 5, FIG. 6, FIG. 17A, and FIG. 17B).
3) Roller-drum support beam 103
   is (or are respectively) for:
a) Providing means to rigidly and cantileverly support roller drum 101a in conjunction with roller-drum bearing assemblies 101c and roller-drum-bearing seats 101d
   (see FIG. 8, FIG. 9, FIG. 11, FIG. 12, and FIG. 15A); and
b) Providing means for a free-span of space for accommodating operations of roller-straps or a sling 93
   (see FIG. 8, FIG. 9, FIG. 12, and FIG. 15A).
4) Roller-drum turning device 104
   is (or are respectively) for:
c) Providing means to bi-directionally rotate roller drum 101a in conjunction with roller-drum bearing assemblies 101c and roller-drum-bearing seats 101d
   (see FIG. 8, FIG. 9, FIG. 10, and FIG. 12); and
d) Providing means to precisely and controllably rotate roller drum 101a in conjunction with roller-drum bearing assemblies 101c and roller-drum-bearing seats 101d
   (see FIG. 8, FIG. 9, FIG. 10, and FIG. 12).
5) Control box 105a
   is (or are respectively) for:
a) Providing means to power, or provide a driving force, for roller-drum turning device 104 and other associated devices or implements
   (see FIG. 7, FIG. 8, FIG. 9, FIG. 10, and FIG. 12); and
b) Providing mechanical, fluid, or electrical means, or other means of power, to, or through control lines 105b
   (see FIG. 8, FIG. 9, FIG. 10, and FIG. 12).
Control lines 105b
   is (or are respectively) for:
a. Providing means to convey power to roller-drum turning device 104
   (see FIG. 7, FIG. 8, FIG. 9, FIG. 10, and FIG. 12).
6) Battery 106
   is (or are respectively) for:
   Providing electric energy to control box 105a.
7) Roller-drum strap stops 107
   is (or are respectively) for:
   Preventing roller-straps or a sling 93 from rolling beyond the ends of the full width of roller drum 101a during active operation.
8) Forklift-attachable load-distributing frame cross-members 108
   is (or are respectively) for:
   attaching to and structurally stabilizing forklift-attachable load-distributing frames 102, providing structural support for battery 106 and control box 105a
   (see FIG. 7, FIG. 9, FIG. 10, and FIG. 12).

### Variation

Any component of the forklift part flipper attachment can have any size or shape. For example the roller-drum axle 101b can be solid or hollow

Any component of the forklift part flipper attachment can be made of any material. For example the roller drum 101a can be made of fiberglass, composite, carbon fiber, aluminum, steel, or any other material.

The forklift part flipper attachment can have one or more roller drums 101a,

The forklift part flipper attachment can have one or more roller-drum axles 101b,

The forklift part flipper attachment can have one or more sets of roller-drum bearing assemblies 101c,

The forklift part flipper attachment can have one or more roller-drum-bearing seats 101d,

The forklift part flipper attachment can have one or more forklift-attachable load-distributing frames 102,

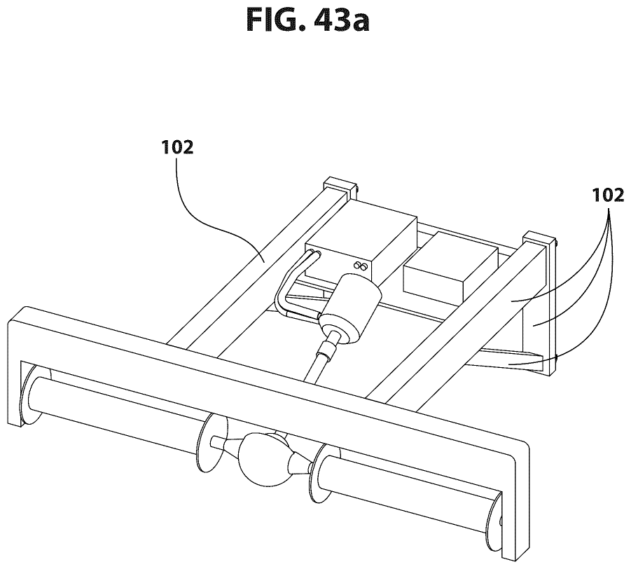

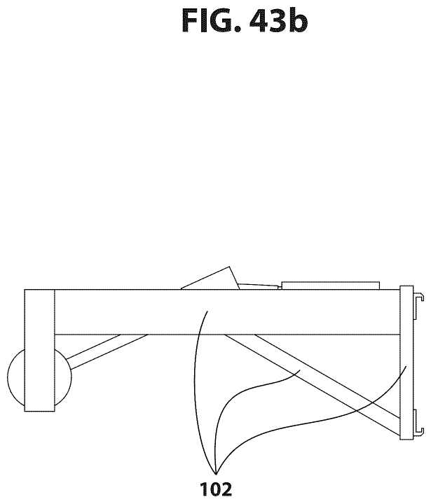

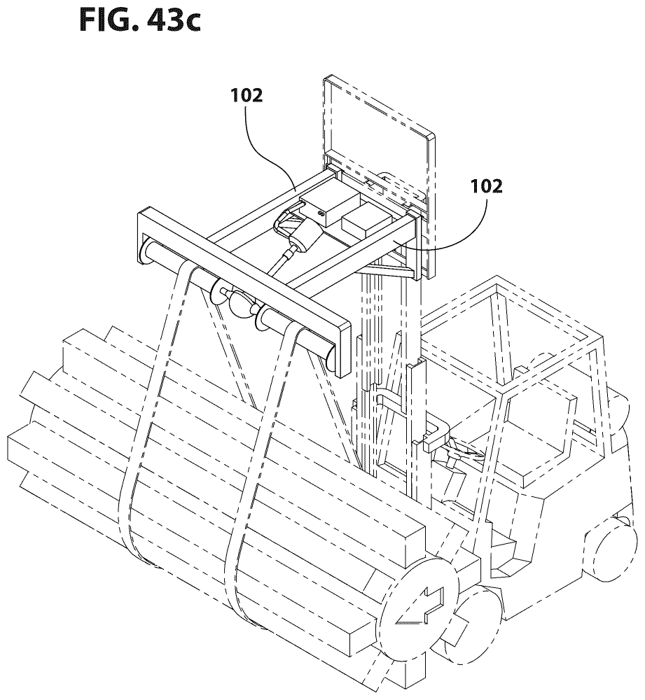

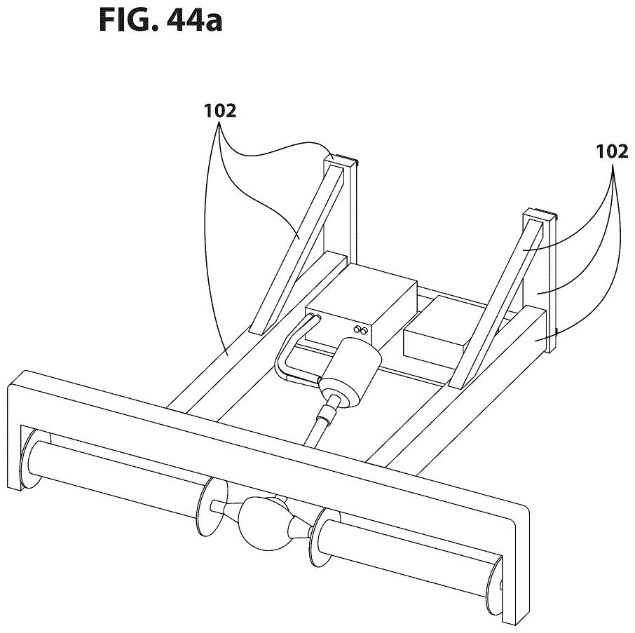

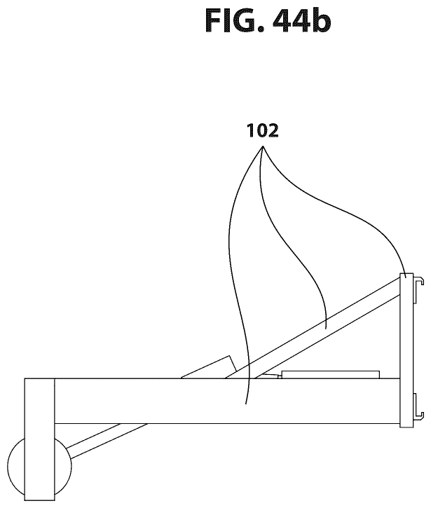

An equivalent variation of the forklift-attachable load-distributing frames 102, of the forklift part flipper attachment can be attached to a forklift without forks (see FIG. 43a, FIG. 43b, FIG. 43c, FIG. 44a, and FIG. 44b)

The forklift part flipper attachment can have one or more roller-drum support beams 103,

The forklift part flipper attachment can have one or more roller-drum turning device 104,

The forklift part flipper attachment can have one or more control box 105a,

The forklift part flipper attachment can have one or more control lines 105b,

The forklift part flipper attachment can have one or more battery 106,

The forklift part flipper attachment can have one or more roller-drum strap stops 107,

The forklift part flipper attachment can have one or more forklift-attachable load-distributing frame cross-members 108

The forklift part flipper attachment can be configured using no roller-drum turning device 104.

The forklift part flipper attachment can be configured using no control box 105a.

The forklift part flipper attachment can be configured using no control lines 105b.

The roller-drum turning device 104 of the forklift part flipper attachment can utilize any source of power. For example it may be powered or driven by an electric source, or a human-powered hand-crank, or human-powered foot-pedals 112 (see FIG. 34), or some other source of power or driving force.

The forklift part flipper attachment can be constructed using no battery 106, but can utilize power from another source, such as a forklift.

The forklift part flipper attachment can be constructed using no forklift-attachable load-distributing frame cross-members 108 (see FIG. 19A, FIG. 19B, FIG. 19C, and FIG. 1D).

The forklift part flipper attachment can have an electric roller-drum turning device(s) 104 or a hydraulic roller-drum turning device 104, or a roller-drum turning device 104 controlled by another power or driving source, respectively.

The forklift part flipper attachment can have electric pump(s) or (a) hydraulic control box(es) 105a, respectively.

The forklift part flipper attachment can have electric lines or (a) hydraulic control line(s) 105b, respectively.

The forklift part flipper attachment can have electric control box(es) or a hydraulic control box 105a, respectively. The electric control box(es) can have wireless capability and/or be capable of speed adjustment, respectively (see FIG. 19A).

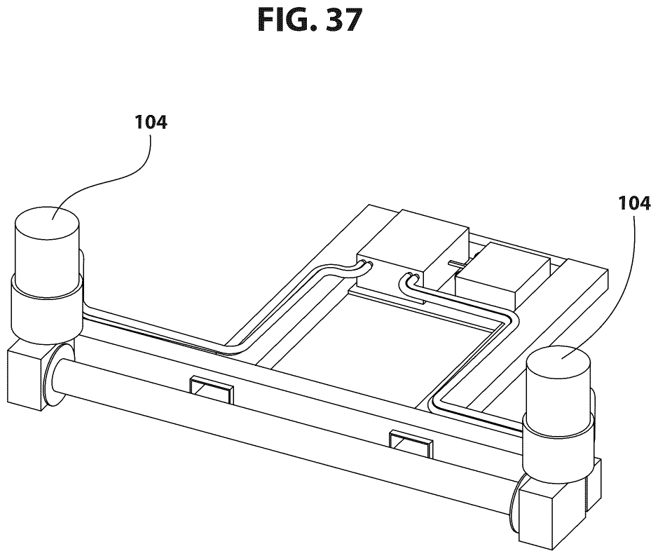

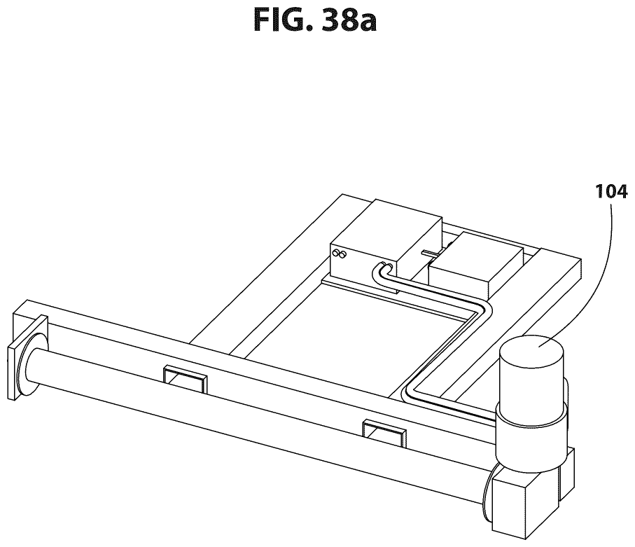

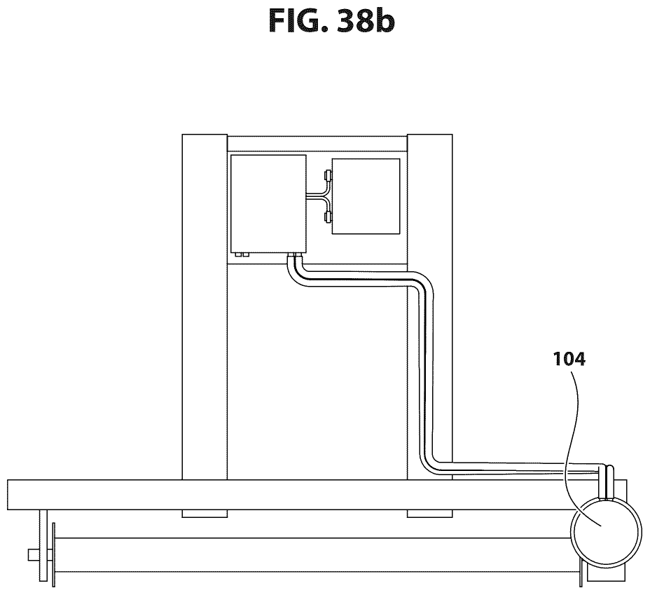

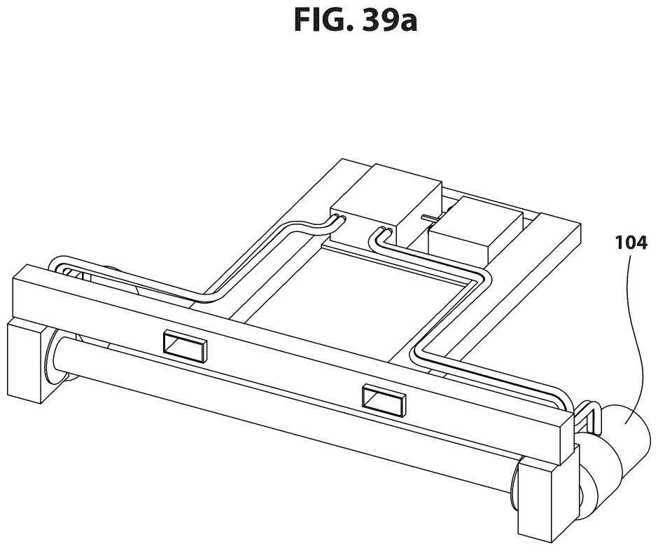

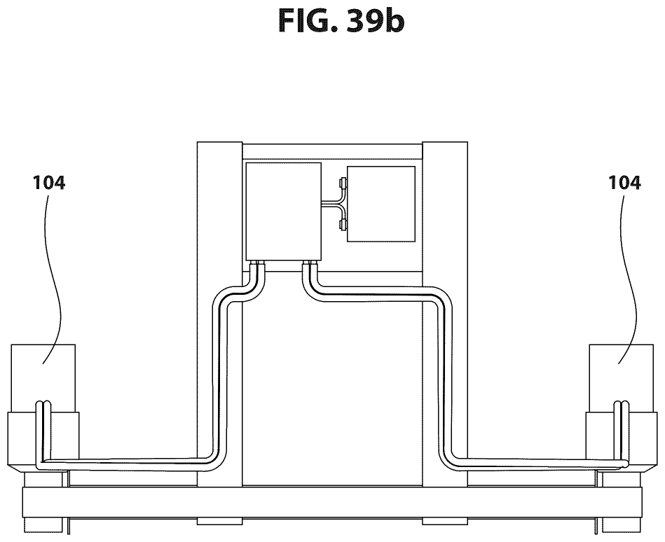

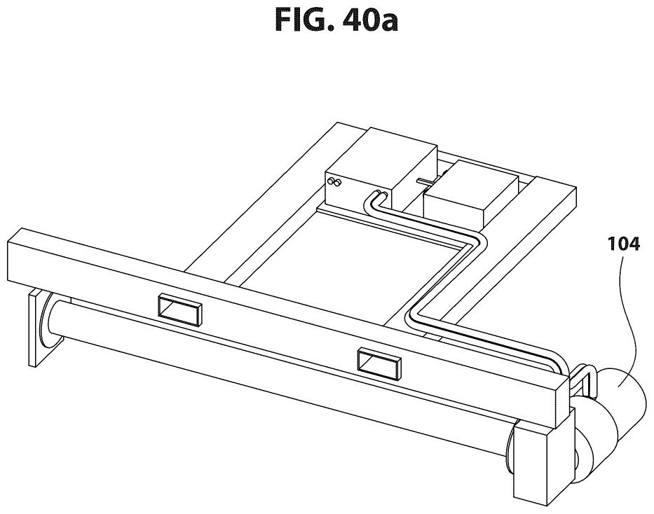

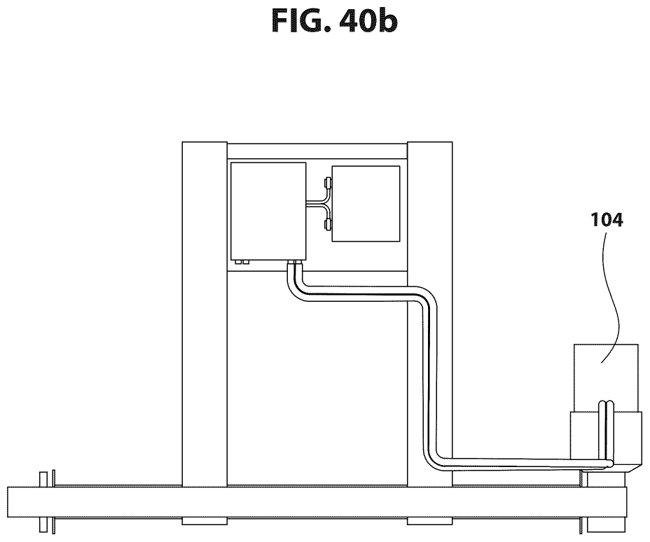

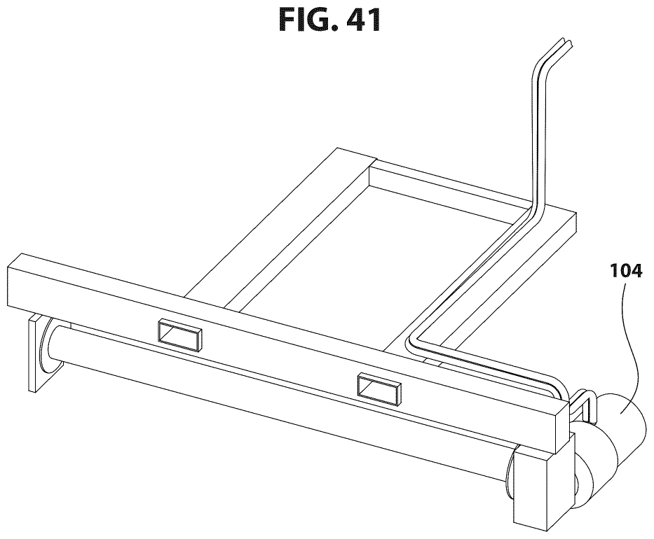

The forklift part flipper attachment can have roller-drum turning device(s) 104 can be mounted above, below, or to any side, or any angle, relative to its connection to a respective roller drum 101a (see FIG. 37, FIG. 38a, FIG. 38b, FIG. 39a, FIG. 39b, FIG. 40a, FIG. 40b, and FIG. 41).

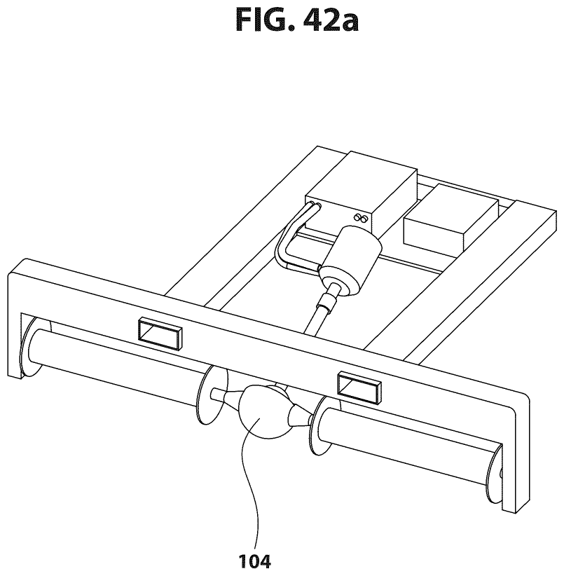

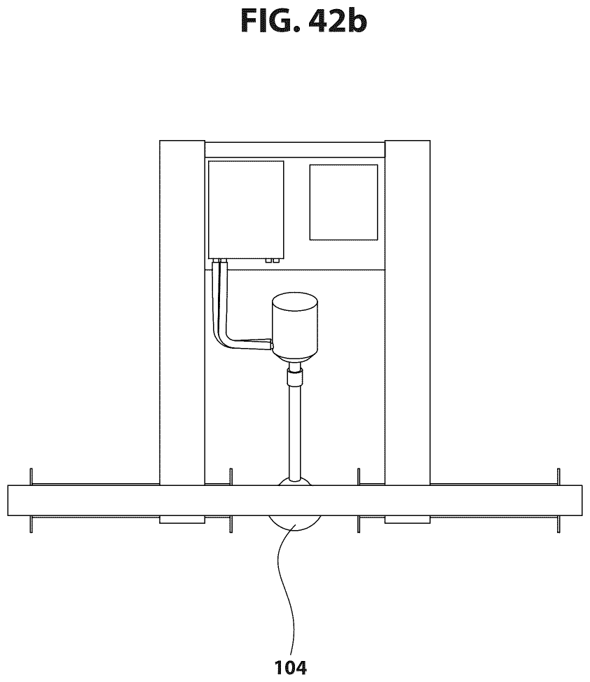

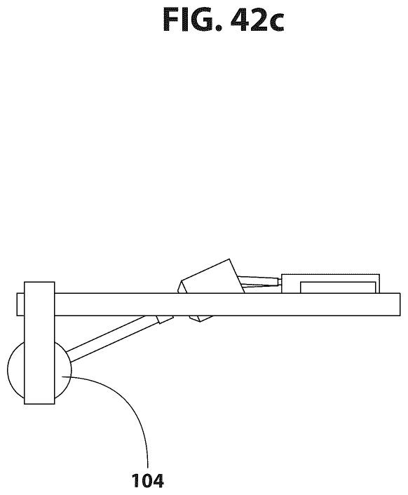

The forklift part flipper attachment can have roller-drum turning device(s) 104 configured on either end of roller drums 101a and/or between multiple roller drums 101a (see FIG. 42a, FIG. 42b, and FIG. 42c).

The forklift part flipper attachment can have an equivalent variation of (a) roller-drum turning device(s) 104 which functions as a differential, providing means to rotate two or more roller drums 101a at different speeds from one another simultaneously (see FIG. 42a, FIG. 42b, and FIG. 42c).

FIG. 43a, FIG. 43b, and FIG. 43c illustrate a perspective, top, and side view of an equivalent variation of the forklift-attachable load-distributing frames 102, demonstrating the means to attach to a forklift carriage.

FIG. 44a and FIG. 44b illustrate a perspective and side view of an equivalent variations of the forklift-attachable load-distributing frames 102, demonstrating the means to attach to or detach from a forklift carriage.

The forklift part flipper attachment can be attached directly to a forklift carriage, without forks, or detachable means. For example, the forklift part flipper attachment can be welded onto the forklift carriage.

What is claimed:

1) A forklift part flipper attachment comprising
one or more roller drums,
one or more roller-drum axles,
a plurality of roller-drum bearing assemblies,
a plurality of forklift-attachable load-distributing frame,
at least one roller-drum support beam, and
at least one roller-drum turning device,
wherein:
said roller drum
is molded securely to said roller-drum axle
for providing a rotatable cylinder on a variety of forklifts,
for providing structural support for roller-straps or a sling,
for providing a rotatable cylinder on which roller-straps or a sling can rotate a suspended part,
for providing a reversibly rotatable cylinder on which roller-straps or a sling can rotate in opposite directions of rotation,
for providing a cylinder with precision, controllable rotation for items being rotated within roller-straps or a sling, such as is demonstrated with a jet engine, to rotatably support various mechanical parts, thereby increasing part-handling efficiency during many types of assembly processes,
for providing a reversibly rotatable roller drum which can be any diameter,
for providing a reversibly rotatable cylinder which can be any length,
for providing a reversibly rotatable cylinder which can accommodate roller-straps or a sling of any length,
for providing a reversibly rotatable cylinder which can accommodate roller-straps or a sling of any width,
for providing a reversibly rotatable cylinder which can accommodate any number of roller-straps or a sling,
for providing a reversibly rotatable cylinder which can accommodate roller-straps or a sling to rotatably support various mechanical parts, thereby increasing part-handling efficiency during many types of assembly processes,
for providing a cylinder for rotating items hanging within roller-straps or a sling to perform operations in both indoor and outdoor environments,
for providing a reversibly rotatable cylinder which can accommodate roller-straps or a sling to support various mechanical parts, providing quick and efficient mobility and transport to required workstations,
for providing a reversibly rotatable cylinder which can accommodate roller-straps or a sling
to efficiently, portably, and controllably rotate, and/or transport various objects such as:
mechanical parts,
items being painted,
items being assembled,
items being fabricated,
items being welded,
items being powder coated,
items being crated,
items being prepared for shipping,
large parts,
heavy parts,
large and/or sick animals, whether conscious or unconscious,
large, human patients, whether conscious or unconscious),
large fragile parts,
heavy fragile parts,
engine blocks and automotive parts,
aeronautic parts,
air conditioners and HVAC units,
furniture,
items required to being moved to multiple locations or workstations during an assembly process,
items required to being moved to multiple locations or workstations during an inspection process, and
items required to being moved from different heights during a process, and
for providing a reversibly rotatable cylinder which quickly and efficiently attaches to many types of common forklifts
to provide a unique method which is accessible to any locality such as a:
warehouse,
factory,
assembly plant,
manufacturer,
yard,
marine dock,
loading dock,
field,
farm,
laboratory,
convention center,
air base or airport,
aircraft assembly plants,
casting or molding facility,
storage facility,
painting facility,
machining facility,
lumber mill,
refractory,
museum,
3-D printing facility,
zoo,
stage or performing arts facility,
veterinarian, and
construction zone;
said roller-drum axle
is rotatably attached to said roller-drum bearing assemblies
for providing structural support for roller drum, and
for providing structural and rotatable connection between roller drum;
said roller-drum bearing assemblies
are respectively rotatably attached to said roller-drum bearing assemblies
for providing means for a low-friction rotating connection between roller drum and roller-drum axle, and
for providing structural and rotatable connection between roller drum;
said forklift-attachable load-distributing frame
are respectively molded securely to said roller-drum support beam
for providing means to attach the forklift part flipper attachment to a variety of types of forklift forks,
for providing means to attach the forklift part flipper attachment to a variety of types of forklift systems such as, but not limited to:
three-wheeled,
stand-up rider,
outdoor pneumatic,
high capacity,
electric narrow aisle,
order pickers,
reach trucks,
articulated,
pivoting mast,
electric motor hand,
hand rider trucks,
walkie stackers,
walkie reach trucks,
counter-balanced stackers,
yard trucks,
marina forklifts,
telehandlers,
off-road forklifts,
wheel loaders,
skid steers,
swing-reach order pickers,
multi-directional,
side-loaders, and
autonomous, and
for providing structural support for roller-drum support beam;
said roller-drum support beam
is attached to said forklift-attachable load-distributing frame
for providing means to rigidly and cantileverly support roller drum in conjunction with roller-drum bearing assemblies, and
for providing means for a free-span of space for accommodating operations of roller-straps or a sling;
said roller-drum turning device
is attached to said roller-drum support beam
for providing means to bi-directionally rotate roller drum in conjunction with roller-drum bearing assemblies, and
for providing means to precisely and controllably rotate roller drum in conjunction with roller-drum bearing assemblies.

2) The forklift part flipper attachment comprising of claim 1,
further comprising:
a plurality of control lines
respectively connected to said roller-drum turning device and said control box,
wherein:
said control lines
are each for providing means to convey power to roller-drum turning device.

3) The forklift part flipper attachment comprising of claim 1,
further comprising:
at least one control box
removably attached to said forklift-attachable load-distributing frame, and at least one battery,
removably attached to said forklift-attachable load-distributing frame, and a plurality of roller-drum strap stops
respectively attached to said roller drum and/or said roller-drum axle,
wherein:
said control box
for providing mechanical, fluid, or electrical means, or other means of power, to, or through control lines, and
said battery
for providing electric energy to control box, and
said roller-drum strap stops
are each for preventing roller-straps or a sling from rolling beyond the ends of the full width of roller drum during active operation.

4) The forklift part flipper attachment comprising of claim 1,
further comprising:
one or more fork-pocket cross-members
respectively attached to said forklift-attachable load-distributing frame,
wherein:
said fork-pocket cross-members
are each for attaching to and structurally stabilizing forklift-attachable load-distributing frame, providing structural support for battery and control box.

5) A forklift part flipper attachment comprising
one or more roller drums,
one or more roller-drum axles,
a plurality of roller-drum bearing assemblies,
a plurality of forklift-attachable load-distributing frame,
a roller-drum support beam, and
a roller-drum turning device,
a plurality of control lines,
at least one control box,
at least one battery,
a plurality of roller-drum strap stops, and
one or more fork-pocket cross-members
wherein:
said roller drum
is molded securely to said roller-drum axle
for providing a rotatable cylinder on a variety of forklifts,
for providing structural support for roller-straps or a sling,
for providing a rotatable cylinder on which roller-straps or a sling can rotate a suspended part in the directions of arrows,
for providing a reversibly rotatable cylinder on which roller-straps or a sling can rotate in opposite directions of rotation,
for providing a cylinder with precision, controllable rotation for items being rotated within roller-straps or a sling, such as is demonstrated with a jet engine, to rotatably support various mechanical parts, thereby increasing part-handling efficiency during many types of assembly processes,
for providing a reversibly rotatable roller drum which can be any diameter,
for providing a reversibly rotatable cylinder which can be any length,
for providing a reversibly rotatable cylinder which can accommodate roller-straps or a sling of any length,
for providing a reversibly rotatable cylinder which can accommodate roller-straps or a sling of any width,
for providing a reversibly rotatable cylinder which can accommodate any number of roller-straps or a sling,
for providing a reversibly rotatable cylinder which can accommodate roller-straps or a sling to rotatably support various mechanical parts, thereby increasing part-handling efficiency during many types of assembly processes,
for providing a cylinder for rotating items hanging within roller-straps or a sling to perform operations in both indoor and outdoor environments,
for providing a reversibly rotatable cylinder which can accommodate roller-straps or a sling to support various mechanical parts, providing quick and efficient mobility and transport to required workstations,
for providing a reversibly rotatable cylinder which can accommodate roller-straps or a sling
to efficiently, portably, and controllably rotate, and/or transport various objects such as:
mechanical parts,
items being painted,
items being assembled,
items being fabricated,
items being welded,
items being powder coated,
items being crated,
items being prepared for shipping,
large parts,
heavy parts,
large and/or sick animals, whether conscious or unconscious,
large, human patients, whether conscious or unconscious),
large fragile parts,
heavy fragile parts,
engine blocks and automotive parts,
aeronautic parts,
air conditioners and HVAC units,
furniture,
items required to being moved to multiple locations or workstations during an assembly process,
items required to being moved to multiple locations or workstations during an inspection process, and
items required to being moved from different heights during a process, and
for providing a reversibly rotatable cylinder which quickly and efficiently attaches to many types of common forklifts
to provide a unique method which is accessible to any locality such as a:
warehouse,
factory,
assembly plant,
manufacturer,
yard,
marine dock,
loading dock,
field,
farm,
laboratory,
convention center,
air base or airport,
aircraft assembly plants,
casting or molding facility,
storage facility,
painting facility,
machining facility,
lumber mill,
refractory,
museum,
3-D printing facility,
zoo,
stage or performing arts facility,
veterinarian, and
construction zone;
said roller-drum axle
is rotatably attached to said roller-drum bearing assemblies
for providing structural support for roller drum, and
for providing structural and rotatable connection between roller drum;
said roller-drum bearing assemblies
are respectively rotatably attached to said roller-drum bearing assemblies
for providing means for a low-friction rotating connection between roller drum and roller-drum axle, and
are respectively inserted within said roller-drum support beam
for providing means for securing roller-drum bearing assemblies within roller-drum support beam;
said forklift-attachable load-distributing frame
are respectively molded securely to said roller-drum support beam
for providing means to attach the forklift part flipper attachment to a variety of types of forklift forks,
for providing means to attach the forklift part flipper attachment to a variety of types of forklift systems such as, but not limited to:
three-wheeled,
stand-up rider,
outdoor pneumatic,
high capacity,
electric narrow aisle,
order pickers,
reach trucks,
articulated,
pivoting mast,
electric motor hand,
hand rider trucks,
walkie stackers,
walkie reach trucks,
counter-balanced stackers,
yard trucks,
marina forklifts,
telehandlers,
off-road forklifts,
wheel loaders,
skid steers,
swing-reach order pickers,
multi-directional,
side-loaders, and
autonomous, and
for providing structural support for roller-drum support beam;
said roller-drum support beam
is attached to said forklift-attachable load-distributing frame
for providing means to rigidly and cantileverly support roller drum in conjunction with roller-drum bearing assemblies, and
for providing means for a free-span of space for accommodating operations of roller-straps or a sling;
said roller-drum turning device
is attached to said roller-drum support beam
for providing means to bi-directionally rotate roller drum in conjunction with roller-drum bearing assemblies, and
for providing means to precisely and controllably rotate roller drum in conjunction with roller-drum bearing assemblies;
said control lines
respectively connected to said roller-drum turning device and said control box, and
are each for providing means to convey power to roller-drum turning device. said control box
removably attached to said forklift-attachable load-distributing frame,
for providing mechanical, fluid, or electrical means, or other means of power,
to, or through control lines, and
said battery
removably attached to said forklift-attachable load-distributing frame, and
for providing electric energy to control box, and
said roller-drum strap stops
respectively attached to said roller drum and/or said roller-drum axle, and are each for preventing roller-straps or a sling from rolling beyond the ends of the full width of roller drum during active operation,
said fork-pocket cross-members
respectively attached to said forklift-attachable load-distributing frame, and are each for attaching to and structurally stabilizing forklift-attachable load-distributing frame, providing structural support for battery and control box.

6) A forklift part flipper attachment comprising
one or more roller drums,
one or more roller-drum axles,
a plurality of roller-drum bearing assemblies,
a plurality of forklift-attachable load-distributing frame,
at least one roller-drum support beam, and
at least one roller-drum turning device,
wherein:
said roller drum
is molded securely to said roller-drum axle
for providing a rotatable cylinder on a variety of forklifts,
for providing structural support for roller-straps or a sling,
for providing a rotatable cylinder on which roller-straps or a sling can rotate a suspended part,
for providing a reversibly rotatable cylinder on which roller-straps or a sling can rotate in opposite directions of rotation,
for providing a cylinder with precision, controllable rotation for items being rotated within roller-straps or a sling, such as is demonstrated with a jet engine, to rotatably support various mechanical parts, thereby increasing part-handling efficiency during many types of assembly processes,
for providing a reversibly rotatable roller drum which can be any diameter,
for providing a reversibly rotatable cylinder which can be any length,
for providing a reversibly rotatable cylinder which can accommodate roller-straps or a sling of any length,
for providing a reversibly rotatable cylinder which can accommodate roller-straps or a sling of any width,
for providing a reversibly rotatable cylinder which can accommodate any number of roller-straps or a sling,
for providing a reversibly rotatable cylinder which can accommodate roller-straps or a sling to rotatably support various mechanical parts, thereby increasing part-handling efficiency during many types of assembly processes,
for providing a cylinder for rotating items hanging within roller-straps or a sling to perform operations in both indoor and outdoor environments,
for providing a reversibly rotatable cylinder which can accommodate roller-straps or a sling to support various mechanical parts, providing quick and efficient mobility and transport to required workstations,
for providing a reversibly rotatable cylinder which can accommodate roller-straps or a sling
to efficiently, portably, and controllably rotate, and/or transport various objects such as:
mechanical parts,
items being painted,
items being assembled,
items being fabricated,
items being welded,
items being powder coated,
items being crated,
items being prepared for shipping,
large parts,
heavy parts,
large and/or sick animals, whether conscious or unconscious,
large, human patients, whether conscious or unconscious),
large fragile parts,
heavy fragile parts,
engine blocks and automotive parts,
aeronautic parts,
air conditioners and HVAC units,
furniture,
items required to being moved to multiple locations or workstations during an assembly process,
items required to being moved to multiple locations or workstations during an inspection process, and
items required to being moved from different heights during a process, and
for providing a reversibly rotatable cylinder which quickly and efficiently attaches to many types of common forklifts
to provide a unique method which is accessible to any locality such as a:
warehouse,
factory,
assembly plant,
manufacturer,
yard,
marine dock,
loading dock,
field,
farm,
laboratory,
convention center,
air base or airport,
aircraft assembly plants,
casting or molding facility,
storage facility,
painting facility,
machining facility,
lumber mill,
refractory,
museum,
3-D printing facility,
zoo,
stage or performing arts facility,
veterinarian, and
construction zone;
said roller-drum axle
is rotatably attached to said roller-drum bearing assemblies
for providing structural support for roller drum, and
for providing structural and rotatable connection between roller drum;
said roller-drum bearing assemblies
are respectively rotatably attached to said roller-drum bearing assemblies
for providing means for a low-friction rotating connection between roller drum and roller-drum axle, and
for providing structural and rotatable connection between roller drum;
said forklift-attachable load-distributing frame
are respectively molded securely to said roller-drum support beam
for providing means to attach the forklift part flipper attachment to a variety of types of forklift forks,
for providing means to attach the forklift part flipper attachment to a variety of types of forklift systems such as, but not limited to:
three-wheeled,
stand-up rider,
outdoor pneumatic,
high capacity,
electric narrow aisle,
order pickers,
reach trucks,
articulated,
pivoting mast,
electric motor hand,
hand rider trucks,
walkie stackers,
walkie reach trucks,
counter-balanced stackers,
yard trucks,
marina forklifts,
telehandlers,
off-road forklifts,
wheel loaders,
skid steers,
swing-reach order pickers,
multi-directional,
side-loaders, and
autonomous, and
for providing structural support for roller-drum support beam;
said roller-drum support beam
is attached to said forklift-attachable load-distributing frame
for providing means to rigidly and cantileverly support roller drum in conjunction with roller-drum bearing assemblies, and
for providing means for a free-span of space for accommodating operations of roller-straps or a sling;
said roller-drum turning device
is attached to said roller-drum support beam
for providing means to bi-directionally rotate roller drum in conjunction with roller-drum bearing assemblies, and
for providing means to precisely and controllably rotate roller drum in conjunction with roller-drum bearing assemblies.

7) The forklift part flipper attachment comprising of claim 6,
further comprising:
a plurality of control lines
respectively connected to said roller-drum turning device and said control box,
wherein:
said control lines
are each for providing means to convey power to roller-drum turning device.

8) The forklift part flipper attachment comprising of claim 6,
further comprising:
at least one control box
removably attached to said forklift-attachable load-distributing frame,
wherein:
said control box
for providing mechanical, fluid, or electrical means, or other means of power, to, or through control lines.

9) The forklift part flipper attachment comprising of claim 6,
further comprising:
at least one battery,
removably attached to said forklift-attachable load-distributing frame,
wherein:
said battery
for providing electric energy to control box.

10) The forklift part flipper attachment comprising of claim 6,
further comprising:
a plurality of roller-drum strap stops
respectively attached to said roller drum and/or said roller-drum axle,
wherein:
said roller-drum strap stops
are each for preventing roller-straps or a sling from rolling beyond the ends of the full width of roller drum during active operation.

11) The forklift part flipper attachment comprising of claim 6,
further comprising:
one or more fork-pocket cross-members
respectively attached to said forklift-attachable load-distributing frame,
wherein:
said fork-pocket cross-members
are each for attaching to and structurally stabilizing forklift-attachable load-distributing frame, providing structural support for battery and control box.
